(19) United States
(12) Patent Application Publication
(10) Pub. No.: US 2020/0366474 A1
(43) Pub. Date: Nov. 19, 2020

(54) PRIVATE KEY GENERATION METHOD AND DEVICE

(71) Applicant: Huawei Technologies Co., Ltd., Shenzhen (CN)

(72) Inventors: Donghui WANG, Beijing (CN); Bin DA, Nanjing (CN); Hongpei LI, Beijing (CN)

(21) Appl. No.: 16/947,497

(22) Filed: Aug. 4, 2020

Related U.S. Application Data
(63) Continuation of application No. PCT/CN2018/103503, filed on Aug. 31, 2018.

(30) Foreign Application Priority Data
Feb. 5, 2018 (CN) 201810112754.4

(51) Int. Cl. H04L 9/08; H04L 9/32

(52) U.S. Cl. CPC H04L 9/0841; H04L 9/0852; H04L 9/083; H04L 9/3242; H04L 9/0866

(57) ABSTRACT

Embodiments of the disclosure provide a private key generation method and a device. The method includes: receiving, by a first terminal from a second terminal, a first half session key parameter corresponding to the second terminal and an identifier of the second terminal; sending, by the first terminal, the first half session key parameter corresponding to the second terminal and the identifier of the second terminal to an IKMS entity; sending, by the first terminal to the second terminal, the second half session key parameter corresponding to the second terminal and the encrypted private key corresponding to the second terminal that are sent by the IKMS entity, where the second half session key parameter corresponding to the second terminal is used to decrypt the encrypted private key corresponding to the second terminal. This can prevent a private key from being stolen, and prevent communication information between groups from being stolen.

### CROSS-REFERENCE TO RELATED APPLICATIONS

This application is a continuation of International Application No. PCT/CN2018/103503, filed on Aug. 31, 2018, which claims priority to Chinese Patent Application No. 201810112754.4, filed on Feb. 5, 2018, the disclosures of which are incorporated herein by reference in their entireties.

### TECHNICAL FIELD

This application relates to communications technologies, and in particular, to a private key generation method and a device.

### BACKGROUND

With continuous development of communications technologies, as a novel future network-oriented network architecture, an ID (identity) oriented network (ION) has gradually been applied to network technologies. In the ION network architecture, a social relationship may be established between network elements. A network element is a device such as a terminal. For example, the network element is a personal computer or a smart refrigerator. In addition, a group needs to be created for the network elements, that is, a plurality of gateways are classified into one group.

In the prior art, in the ION network architecture, during group creation for network elements, an access gateway classifies the network elements into a group based on network signal strengths of the network elements.

However, in the prior art, how terminals in a group obtain a private key required for subsequent communication in the ION network architecture is an issue to be urgently resolved.

### SUMMARY

This application provides a private key generation method and a device, to resolve a prior-art issue on how terminals in a group obtain a private key required for subsequent communication in an ION network architecture.

According to a first aspect, this application provides a private key generation method, including:

receiving, by a first terminal from a second terminal, a first half session key parameter corresponding to the second terminal and an identifier of the second terminal, where the first half session key parameter corresponding to the second terminal and the identifier of the second terminal are used to generate an encrypted private key corresponding to the second terminal;

sending, by the first terminal, the first half session key parameter corresponding to the second terminal and the identifier of the second terminal to an IKMS entity;

receiving, by the first terminal from the IKMS entity, a second half session key parameter corresponding to the second terminal, the identifier of the second terminal, and the encrypted private key corresponding to the second terminal, where the second half session key parameter corresponding to the second terminal is used to decrypt the encrypted private key corresponding to the second terminal; and sending, by the first terminal, the second half session key parameter corresponding to the second terminal and the encrypted private key corresponding to the second terminal to the second terminal based on the identifier of the second terminal.

In one embodiment, before the sending, by the first terminal, the first half session key parameter corresponding to the second terminal and the identifier of the second terminal to an IKMS entity, the method further includes:

generating, by the first terminal, a first message authentication code based on a first shared key, where the first shared key is a key negotiated between the first terminal and the IKMS entity; and correspondingly, the sending, by the first terminal, the first half session key parameter corresponding to the second terminal and the identifier of the second terminal to an IKMS entity includes:

sending, by the first terminal, a first message to the IKMS entity, where the first message includes the first half session key parameter corresponding to the second terminal, the identifier of the second terminal, and the first message authentication code, and the first message authentication code is used to authenticate that the first message is sent by the first terminal and perform authentication on integrity of the first message.

In one embodiment, the first shared key includes a first key for generating the message authentication code and a second key for data encryption.

In one embodiment, the sending, by the first terminal, a first message to the IKMS entity includes:

encrypting, by the first terminal, the first message based on the first shared key, to obtain an encrypted first message; and

sending, by the first terminal, the encrypted first message to the IKMS entity.

In one embodiment, the receiving, by the first terminal from the IKMS entity, a second half session key parameter corresponding to the second terminal, the identifier of the second terminal, and the encrypted private key corresponding to the second terminal includes:

receiving, by the first terminal, a second message sent by the IKMS entity, where the second message includes the second half session key parameter corresponding to the second terminal, the identifier of the second terminal, the encrypted private key corresponding to the second terminal, and a second message authentication code, and the second message authentication code is used to authenticate that the second message is sent by the IKMS entity and perform authentication on integrity of the second message; and correspondingly, the sending, by the first terminal, the second half session key parameter corresponding to the second terminal and the encrypted private key corresponding to the second terminal to the second terminal based on the identifier of the second terminal includes:

performing, by the first terminal, authentication on the second message authentication code based on the first shared key, where the first shared key is the key negotiated between the first terminal and the IKMS entity; and after determining that authentication on the second message authentication code succeeds, sending, by the first terminal, the second half session key parameter corresponding to the second terminal and the encrypted private key corresponding to the second terminal to the second terminal based on the identifier of the second terminal.

In one embodiment, the receiving, by the first terminal, a second message sent by the IKMS entity includes:

receiving, by the first terminal, an encrypted second message sent by the IKMS entity; and

correspondingly, before the performing, by the first terminal, authentication on the second message authentication code based on the first shared key, the method further includes:

decrypting, by the first terminal, the encrypted second message based on the first shared key, to obtain the second message.

In one embodiment, the receiving, by the first terminal from the IKMS entity, a second half session key parameter corresponding to the second terminal, the identifier of the second terminal, and the encrypted private key corresponding to the second terminal includes:

receiving, by the first terminal, a third message sent by the IKMS entity, where the third message includes the second half session key parameter corresponding to the second terminal, the identifier of the second terminal, the encrypted private key corresponding to the second terminal, and signature information corresponding to the second terminal, and the signature information corresponding to the second terminal is used to authenticate that the encrypted private key corresponding to the second terminal is generated by the IKMS entity; and correspondingly, the sending, by the first terminal, the second half session key parameter corresponding to the second terminal and the encrypted private key corresponding to the second terminal to the second terminal based on the identifier of the second terminal includes:

performing, by the first terminal, authentication on the signature information corresponding to the second terminal based on a public key of the IKMS entity; and

after determining that authentication on the signature information corresponding to the second terminal succeeds, sending, by the first terminal, the second half session key parameter corresponding to the second terminal, the encrypted private key corresponding to the second terminal, and the signature information corresponding to the second terminal to the second terminal based on the identifier of the second terminal.

In one embodiment, the receiving, by the first terminal, a third message sent by the IKMS entity includes:

receiving, by the first terminal, an encrypted third message sent by the IKMS entity; and

correspondingly, before the performing, by the first terminal, authentication on the signature information corresponding to the second terminal based on a public key of the IKMS entity, the method further includes:

decrypting, by the first terminal, the encrypted third message based on the first shared key, to obtain the third message, where the first shared key is the key negotiated between the first terminal and the IKMS entity.

In one embodiment, there are one or at least two second terminals.

In one embodiment, the first terminal is a master node, and the second terminal is a slave node.

In one embodiment, before the receiving, by a first terminal from a second terminal, a first half session key parameter corresponding to the second terminal and an identifier of the second terminal, the method further includes:

receiving, by the first terminal, a group joining request sent by the second terminal, where the group joining request includes a group flag field and the identifier of the second terminal, and the group flag field represents a relationship between the first terminal and the second terminal;

sending, by the first terminal, the group flag field, an identifier of the first terminal, and the identifier of the second terminal to an IDM entity, where the group flag field, the identifier of the first terminal, and the identifier of the second terminal are used to determine a group identifier;

receiving, by the first terminal, the group identifier and the identifier of the second terminal that are sent by the IDM entity; and

sending, by the first terminal, a group joining response message to the second terminal based on the identifier of the second terminal, where the group joining response message includes the group identifier.

In one embodiment, before the sending, by the first terminal, the group flag field, an identifier of the first terminal, and the identifier of the second terminal to an IDM entity, the method further includes:

generating, by the first terminal, a third message authentication code based on a second shared key, where the second shared key is a key negotiated between the first terminal and the IDM entity; and correspondingly, the sending, by the first terminal, the group flag field, an identifier of the first terminal, and the identifier of the second terminal to an IDM entity includes:

sending, by the first terminal, a fourth message to the IDM entity, where the fourth message includes the group flag field, the identifier of the first terminal, the identifier of the second terminal, and the third message authentication code, and the third message authentication code is used to authenticate that the fourth message is sent by the first terminal and perform authentication on integrity of the fourth message.

In one embodiment, the second shared key includes a third key for generating the message authentication code and a fourth key for data encryption.

In one embodiment, the sending, by the first terminal, a fourth message to the IDM entity includes:

encrypting, by the first terminal, the fourth message based on the second shared key, to obtain an encrypted fourth message; and

sending, by the first terminal, the encrypted fourth message to the IDM entity.

In one embodiment, the receiving, by the first terminal, the group identifier and the identifier of the second terminal that are sent by the IDM entity includes:

receiving, by the first terminal, a fifth message sent by the IDM entity, where the fifth message includes the group identifier, the identifier of the second terminal, and a fourth message authentication code, and the fourth message authentication code is used to authenticate that the fifth message is sent by the IDM entity and perform authentication on integrity of the fifth message; and correspondingly, after the receiving, by the first terminal, a fifth message sent by the IDM entity, the method further includes:

performing, by the first terminal, authentication on the fourth message authentication code based on the second shared key, where the second shared key is the key negotiated between the first terminal and the IDM entity; and after determining that authentication on the fourth message authentication code succeeds, storing, by the first terminal, group information, where the group information includes the group identifier, the identifier of the first terminal, and the identifier of the second terminal.

In one embodiment, the receiving, by the first terminal, a fifth message sent by the IDM entity includes:

receiving, by the first terminal, an encrypted fifth message sent by the IDM entity; and

correspondingly, before the performing, by the first terminal, authentication on the fourth message authentication code based on the second shared key, the method further includes:

decrypting, by the first terminal, the encrypted fifth message based on the second shared key, to obtain the fifth message.

According to a second aspect, this application provides a private key generation method, including:

sending, by a second terminal, a first half session key parameter corresponding to the second terminal and an identifier of the second terminal to a first terminal, where the first half session key parameter corresponding to the second terminal and the identifier of the second terminal are used to generate an encrypted private key corresponding to the second terminal;

receiving, by the second terminal from the first terminal, a second half session key parameter corresponding to the second terminal and the encrypted private key corresponding to the second terminal, where the second half session key parameter corresponding to the second terminal is used to decrypt the encrypted private key corresponding to the second terminal;

generating, by the second terminal, a symmetric key based on the first half session key parameter corresponding to the second terminal and the second half session key parameter corresponding to the second terminal; and decrypting, by the second terminal, the encrypted private key corresponding to the second terminal based on the symmetric key, to obtain a private key corresponding to the second terminal.

In one embodiment, the receiving, by the second terminal from the first terminal, a second half session key parameter corresponding to the second terminal and the encrypted private key corresponding to the second terminal includes:

receiving, by the second terminal from the first terminal, the second half session key parameter corresponding to the second terminal, the encrypted private key corresponding to the second terminal, and signature information corresponding to the second terminal, where the signature information corresponding to the second terminal is used to authenticate that the encrypted private key corresponding to the second terminal is generated by an IKMS entity; and correspondingly, the generating, by the second terminal, a symmetric key based on the first half session key parameter corresponding to the second terminal and the second half session key parameter corresponding to the second terminal includes:

performing, by the second terminal, authentication on the signature information corresponding to the second terminal; and

after determining that authentication on the signature information corresponding to the second terminal succeeds, generating, by the second terminal, the symmetric key based on the first half session key parameter corresponding to the second terminal and the second half session key parameter corresponding to the second terminal.

In one embodiment, the first terminal is a master node, and the second terminal is a slave node.

In one embodiment, before the sending, by a second terminal, a first half session key parameter corresponding to the second terminal and an identifier of the second terminal to a first terminal, the method further includes:

sending, by the second terminal, a group joining request to the first terminal, where the group joining request includes a group flag field and the identifier of the second terminal, and the group flag field represents a relationship between the first terminal and the second terminal; and receiving, by the second terminal, a group joining response message sent by the first terminal, where the group joining response message includes the group identifier.

According to a third aspect, this application provides a group creation method, including:

receiving, by an IDM entity from a first terminal, a group flag field, an identifier of the first terminal, and an identifier of a second terminal, where the group flag field represents a relationship between the first terminal and the second terminal, and the group flag field, the identifier of the first terminal, and the identifier of the second terminal are used to determine a group identifier;

generating, by the IDM entity, the group identifier; and

sending, by the IDM entity, the group identifier and the identifier of the second terminal to the first terminal.

In one embodiment, the receiving, by an IDM entity from a first terminal, a group flag field and an identifier of a second terminal includes:

receiving, by the IDM entity, a fourth message sent by the first terminal, where the fourth message includes the group flag field, the identifier of the first terminal, the identifier of the second terminal, and a third message authentication code, and the third message authentication code is used to authenticate that the fourth message is sent by the first terminal and perform authentication on integrity of the fourth message; and correspondingly, the generating, by the IDM entity, the group identifier includes:

performing, by the IDM entity, authentication on the third message authentication code based on a second shared key, where the second shared key is a key negotiated between the first terminal and the IDM entity; and after determining that authentication on the third message authentication code succeeds, generating, by the IDM entity, the group identifier.

In one embodiment, the second shared key includes a third key for generating the message authentication code and a fourth key for data encryption.

In one embodiment, the receiving, by the IDM entity, a fourth message sent by the first terminal includes:

receiving, by the IDM entity, an encrypted fourth message sent by the first terminal; and

correspondingly, before the performing, by the IDM entity, authentication on the third message authentication code based on a second shared key, the method further includes:

decrypting, by the IDM entity, the encrypted fourth message based on the second shared key, to obtain the fourth message.

In one embodiment, the sending, by the IDM entity, the group identifier and the identifier of the second terminal to the first terminal includes:

generating, by the IDM entity, a fourth message authentication code based on the second shared key, where the second shared key is the key negotiated between the first terminal and the IDM entity; and sending, by the IDM entity, a fifth message to the first terminal, where the fifth message includes the group identifier, the identifier of the second terminal, and the fourth message authentication code; and sending, by the IDM entity, group information to an IKMS entity, where the group information includes the group identifier, the identifier of the first terminal, and the identifier of the second terminal, and the fourth message authentication code is used to authenticate that the fifth message is sent by the IDM entity and perform authentication on integrity of the fifth message.

In one embodiment, the sending, by the IDM entity, a fifth message to the first terminal includes:

encrypting, by the IDM entity, the fifth message based on the second shared key, to generate an encrypted second message; and

sending, by the IDM entity, the encrypted fifth message to the first terminal.

In one embodiment, the group flag field represents that the first terminal is a master node, and the second terminal is a master node; or the group flag field represents that the first terminal is a master node, and the second terminal is a slave node.

In one embodiment, there are one or at least two second terminals.

According to a fourth aspect, this application provides a private key generation method, including:

receiving, by an IKMS entity from a first terminal, a first half session key parameter corresponding to a second terminal and an identifier of the second terminal, where the first half session key parameter corresponding to the second terminal and the identifier of the second terminal are used to generate an encrypted private key corresponding to the second terminal;

generating, by the IKMS entity, a second half session key parameter corresponding to the second terminal, and generating the encrypted private key corresponding to the second terminal based on the identifier of the second terminal, the first half session key parameter corresponding to the second terminal, and the second half session key parameter corresponding to the second terminal, where the second half session key parameter corresponding to the second terminal is used to decrypt the encrypted private key corresponding to the second terminal; and sending, by the IKMS entity, the second half session key parameter corresponding to the second terminal, the identifier of the second terminal, and the encrypted private key corresponding to the second terminal to the first terminal.

In one embodiment, the generating, by the IKMS entity, a second half session key parameter corresponding to the second terminal, and generating the encrypted private key corresponding to the second terminal based on the identifier of the second terminal, the first half session key parameter corresponding to the second terminal, and the second half session key parameter corresponding to the second terminal includes:

generating, by the IKMS entity, a private key corresponding to the second terminal based on the identifier of the second terminal;

generating, by the IKMS entity, the second half session key parameter corresponding to the second terminal, and generating a symmetric key corresponding to the second terminal based on the first half session key parameter corresponding to the second terminal and the second half session key parameter corresponding to the second terminal; and encrypting, by the IKMS entity, the private key corresponding to the second terminal based on the symmetric key corresponding to the second terminal, to generate the encrypted private key corresponding to the second terminal.

In one embodiment, the receiving, by an IKMS entity from a first terminal, a first half session key parameter corresponding to a second terminal and an identifier of the second terminal includes:

receiving, by the IKMS entity, a first message sent by the first terminal, where the first message includes the first half session key parameter corresponding to the second terminal, the identifier of the second terminal, and a first message authentication code, and the first message authentication code is used to authenticate that the first message is sent by the first terminal and perform authentication on integrity of the first message; and correspondingly, the generating, by the IKMS entity, a private key corresponding to the second terminal based on the identifier of the second terminal includes:

performing, by the IKMS entity, authentication on the first message authentication code based on a first shared key, where the first shared key is a key negotiated between the first terminal and the IKMS entity; and after determining that authentication on the first message authentication code succeeds, generating, by the IKMS entity, the private key corresponding to the second terminal based on the identifier of the second terminal.

In one embodiment, the first shared key includes a third key for generating the message authentication code and a fourth key for data encryption.

In one embodiment, the receiving, by the IKMS entity, a first message sent by the first terminal includes:

receiving, by the IKMS entity, an encrypted first message sent by the first terminal; and

correspondingly, before the performing, by the IKMS entity, authentication on the first message authentication code based on a first shared key, the method further includes:

decrypting, by the IKMS entity, the encrypted first message based on the first shared key, to obtain the first message.

In one embodiment, the sending, by the IKMS entity, the second half session key parameter corresponding to the second terminal, the identifier of the second terminal, and the encrypted private key corresponding to the second terminal to the first terminal includes:

generating, by the IKMS entity, a second message authentication code based on the first shared key, where the first shared key is the key negotiated between the first terminal and the IKMS entity; and sending, by the IKMS entity, a second message to the first terminal, where the second message includes the second half session key parameter corresponding to the second terminal, the identifier of the second terminal, the encrypted private key corresponding to the second terminal, and the second message authentication code, and the second message authentication code is used to authenticate that the second message is sent by the IKMS entity and perform authentication on integrity of the second message.

With reference to the fifth implementation of the fourth aspect, in a sixth implementation of the fourth aspect, the sending, by the IKMS entity, a second message to the first terminal includes:

encrypting, by the IKMS entity, the second message based on the first shared key, to generate an encrypted second message; and

sending, by the IKMS entity, the encrypted second message to the first terminal.

In one embodiment, the sending, by the IKMS entity, the second half session key parameter corresponding to the second terminal, the identifier of the second terminal, and the encrypted private key corresponding to the second terminal to the first terminal includes:

generating, by the IKMS entity, signature information corresponding to the second terminal based on a private key of the IKMS entity, where the signature information corresponding to the second terminal is used to authenticate that the encrypted private key corresponding to the second terminal is generated by the IKMS entity; and sending, by the IKMS entity, a third message to the first terminal, where the third message includes the second half session key parameter corresponding to the second terminal, the identifier of the second terminal, the encrypted private key corresponding to the second terminal, and the signature information corresponding to the second terminal.

In one embodiment, the sending, by the IKMS entity, a third message to the first terminal includes:

encrypting, by the IKMS entity, the third message based on the first shared key, to generate an encrypted third message, where the first shared key is the key negotiated between the first terminal and the IKMS entity; and sending, by the IKMS entity, the encrypted third message to the first terminal.

In one embodiment, the first terminal is a master node, and the second terminal is a slave node.

In one embodiment, there are one or at least two second terminals.

According to a fifth aspect, this application provides a first terminal, including:

a first receiving unit, configured to receive, from a second terminal, a first half session key parameter corresponding to the second terminal and an identifier of the second terminal, where the first half session key parameter corresponding to the second terminal and the identifier of the second terminal are used to generate an encrypted private key corresponding to the second terminal;

a first sending unit, configured to send the first half session key parameter corresponding to the second terminal and the identifier of the second terminal to an IKMS entity;

a second receiving unit, configured to receive, from the IKMS entity, a second half session key parameter corresponding to the second terminal, the identifier of the second terminal, and the encrypted private key corresponding to the second terminal, where the second half session key parameter corresponding to the second terminal is used to decrypt the encrypted private key corresponding to the second terminal; and a second sending unit, configured to send the second half session key parameter corresponding to the second terminal and the encrypted private key corresponding to the second terminal to the second terminal based on the identifier of the second terminal.

In one embodiment, the first terminal further includes:

a first generation unit, configured to: before the first sending unit sends the first half session key parameter corresponding to the second terminal and the identifier of the second terminal to the IKMS entity, generate a first message authentication code based on a first shared key, where the first shared key is a key negotiated between the first terminal and the IKMS entity; and correspondingly, the first sending unit is configured to:
send a first message to the IKMS entity, where the first message includes the first half session key parameter corresponding to the second terminal, the identifier of the second terminal, and the first message authentication code, and the first message authentication code is used to authenticate that the first message is sent by the first terminal and perform authentication on integrity of the first message.

In one embodiment, the first shared key includes a first key for generating the message authentication code and a second key for data encryption.

In one embodiment, the first sending unit includes:

a first encryption module, configured to encrypt the first message based on the first shared key, to obtain an encrypted first message; and

a first sending module, configured to send the encrypted first message to the IKMS entity.

In one embodiment, the second receiving unit is configured to:

receive a second message sent by the IKMS entity, where the second message includes the second half session key parameter corresponding to the second terminal, the identifier of the second terminal, the encrypted private key corresponding to the second terminal, and a second message authentication code, and the second message authentication code is used to authenticate that the second message is sent by the IKMS entity and perform authentication on integrity of the second message; and

correspondingly, the second sending unit includes:

a first authentication module, configured to perform authentication on the second message authentication code based on the first shared key, where the first shared key is the key negotiated between the first terminal and the IKMS entity; and

a second sending module, configured to: after it is determined that authentication on the second message authentication code succeeds, send the second half session key parameter corresponding to the second terminal and the encrypted private key corresponding to the second terminal to the second terminal based on the identifier of the second terminal.

In one embodiment, the second receiving unit is configured to:

receive an encrypted second message sent by the IKMS entity; and

correspondingly, the second sending unit further includes:

a first decryption module, configured to: before the authentication module performs authentication on the second message authentication code based on the first shared key, decrypt the encrypted second message based on the first shared key, to obtain the second message.

In one embodiment, the second receiving unit is configured to:

receive a third message sent by the IKMS entity, where the third message includes the second half session key parameter corresponding to the second terminal, the identifier of the second terminal, the encrypted private key corresponding to the second terminal, and signature information corresponding to the second terminal, and the signature information corresponding to the second terminal is used to authenticate that the encrypted private key corresponding to the second terminal is generated by the IKMS entity; and

correspondingly, the second sending unit includes:

a second authentication module, configured to perform authentication on the signature information corresponding to the second terminal based on a public key of the IKMS entity; and

a third sending module, configured to: after it is determined that authentication on the signature information corresponding to the second terminal succeeds, send the second half session key parameter corresponding to the second terminal, the encrypted private key corresponding to the second terminal, and the signature information corresponding to the second terminal to the second terminal based on the identifier of the second terminal.

In one embodiment, the second receiving unit is configured to:

receive an encrypted third message sent by the IKMS entity; and

correspondingly, the second sending unit further includes:

a second decryption module, configured to: before the second authentication module performs authentication on the signature information corresponding to the second terminal based on the public key of the IKMS entity, decrypt the encrypted third message based on the first shared key, to obtain the third message, where the first shared key is the key negotiated between the first terminal and the IKMS entity.

In one embodiment, there are one or at least two second terminals.

In one embodiment, the first terminal is a master node, and the second terminal is a slave node.

In one embodiment, the first terminal further includes:

a third receiving unit, configured to: before the first receiving unit receives, from the second terminal, the first half session key parameter corresponding to the second terminal and the identifier of the second terminal, receive a group joining request sent by the second terminal, where the group joining request includes a group flag field and the identifier of the second terminal, and the group flag field represents a relationship between the first terminal and the second terminal;

a third sending unit, configured to send the group flag field, an identifier of the first terminal, and the identifier of the second terminal to an IDM entity, where the group flag field, the identifier of the first terminal, and the identifier of the second terminal are used to determine a group identifier;

a fourth receiving unit, configured to receive the group identifier and the identifier of the second terminal that are sent by the IDM entity; and

a fourth sending unit, configured to send a group joining response message to the second terminal based on the identifier of the second terminal, where the group joining response message includes the group identifier.

In one embodiment, the first terminal further includes:

the first generation unit, configured to: before the third sending unit sends the group flag field, the identifier of the first terminal, and the identifier of the second terminal to the IDM entity, generate a third message authentication code based on a second shared key, where the second shared key is a key negotiated between the first terminal and the IDM entity; and

correspondingly, the third sending unit is configured to:

send a fourth message to the IDM entity, where the fourth message includes the group flag field, the identifier of the first terminal, the identifier of the second terminal, and the third message authentication code, and the third message authentication code is used to authenticate that the fourth message is sent by the first terminal and perform authentication on integrity of the fourth message.

In one embodiment, the second shared key includes a third key for generating the message authentication code and a fourth key for data encryption.

In one embodiment, the third sending unit includes:

a second encryption module, configured to encrypt the fourth message based on the second shared key, to obtain an encrypted fourth message; and

a fourth sending module, configured to send the encrypted fourth message to the IDM entity.

In one embodiment, the fourth receiving unit is configured to:

receive a fifth message sent by the IDM entity, where the fifth message includes the group identifier, the identifier of the second terminal, and a fourth message authentication code, and the fourth message authentication code is used to authenticate that the fifth message is sent by the IDM entity and perform authentication on integrity of the fifth message; and

correspondingly, the first terminal further includes:

an authentication unit, configured to: after the fourth receiving unit receives the fifth message sent by the IDM entity, perform authentication on the fourth message authentication code based on the second shared key, where the second shared key is the key negotiated between the first terminal and the IDM entity; and

a storage unit, configured to: after it is determined that authentication on the fourth message authentication code succeeds, store group information, where the group information includes the group identifier, the identifier of the first terminal, and the identifier of the second terminal.

In one embodiment, the fourth receiving unit is configured to:

receive an encrypted fifth message sent by the IDM entity; and

correspondingly, the first terminal further includes:

a decryption unit, configured to: before the authentication unit performs authentication on the fourth message authentication code based on the second shared key, decrypt the encrypted fifth message based on the second shared key, to obtain the fifth message.

According to a sixth aspect, a second terminal is provided, including:

a first sending unit, configured to send a first half session key parameter corresponding to the second terminal and an identifier of the second terminal to a first terminal, where the first half session key parameter corresponding to the second terminal and the identifier of the second terminal are used to generate an encrypted private key corresponding to the second terminal;

a first receiving unit, configured to receive, from the first terminal, a second half session key parameter corresponding to the second terminal and the encrypted private key corresponding to the second terminal, where the second half session key parameter corresponding to the second terminal is used to decrypt the encrypted private key corresponding to the second terminal;

a generation unit, configured to generate a symmetric key based on the first half session key parameter corresponding to the second terminal and the second half session key parameter corresponding to the second terminal; and

a decryption unit, configured to decrypt the encrypted private key corresponding to the second terminal based on the symmetric key, to obtain a private key corresponding to the second terminal.

In one embodiment, the first receiving unit is configured to:

receive, from the first terminal, the second half session key parameter corresponding to the second terminal, the encrypted private key corresponding to the second terminal, and signature information corresponding to the second terminal, where the signature information corresponding to the second terminal is used to authenticate that the encrypted private key corresponding to the second terminal is generated by an IKMS entity; and

correspondingly, the generation unit includes:

an authentication module, configured to perform authentication on the signature information corresponding to the second terminal; and

a generation module, configured to: after it is determined that authentication on the signature information corresponding to the second terminal succeeds, generate the symmetric key based on the first half session key parameter corresponding to the second terminal and the second half session key parameter corresponding to the second terminal.

In one embodiment, the first terminal is a master node, and the second terminal is a slave node.

In one embodiment, the second terminal further includes:

a second sending unit, configured to: before the first sending unit sends the first half session key parameter corresponding to the second terminal and the identifier of the second terminal to the first terminal, send a group joining request to the first terminal, where the group joining request includes a group flag field and the identifier of the second terminal, and the group flag field represents a relationship between the first terminal and the second terminal; and

a second receiving unit, configured to receive a group joining response message sent by the first terminal, where the group joining response message includes the group identifier.

According to a seventh aspect, an IDM entity is provided, including:

a receiving unit, configured to receive, from a first terminal, a group flag field, an identifier of the first terminal, and an identifier of a second terminal, where the group flag field represents a relationship between the first terminal and the second terminal, and the group flag field, the identifier of the first terminal, and the identifier of the second terminal are used to determine a group identifier;

a generation unit, configured to generate the group identifier; and

a sending unit, configured to send the group identifier and the identifier of the second terminal to the first terminal.

In one embodiment, the receiving unit is configured to:

receive a fourth message sent by the first terminal, where the fourth message includes the group flag field, the identifier of the first terminal, the identifier of the second terminal, and a third message authentication code, and the third message authentication code is used to authenticate that the fourth message is sent by the first terminal and perform authentication on integrity of the fourth message; and

correspondingly, the generation unit includes:

an authentication module, configured to perform authentication on the third message authentication code based on a second shared key, where the second shared key is a key negotiated between the first terminal and the IDM entity; and

a first generation module, configured to: after it is determined that authentication on the third message authentication code succeeds, generate the group identifier.

In one embodiment, the second shared key includes a third key for generating the message authentication code and a fourth key for data encryption.

In one embodiment, the receiving unit is configured to:

receive an encrypted fourth message sent by the first terminal; and

correspondingly, the generation unit further includes:

a decryption module, configured to: before the authentication module performs authentication on the third message authentication code based on the second shared key, decrypt the encrypted fourth message based on the second shared key, to obtain the fourth message.

In one embodiment, the sending unit includes:

a second generation module, configured to generate a fourth message authentication code based on the second shared key, where the second shared key is the key negotiated between the first terminal and the IDM entity; and

a sending module, configured to: send a fifth message to the first terminal, where the fifth message includes the group identifier, the identifier of the second terminal, and the fourth message authentication code; and send, for the IDM entity, group information to an IKMS entity, where the group information includes the group identifier, the identifier of the first terminal, and the identifier of the second terminal, and the fourth message authentication code is used to authenticate that the fifth message is sent by the IDM entity and perform authentication on integrity of the fifth message.

With reference to the fourth implementation of the third aspect, in a fifth implementation of the third aspect, the sending module is configured to:

encrypt the fifth message based on the second shared key, to generate an encrypted second message; and

send the encrypted fifth message to the first terminal.

In one embodiment, the group flag field represents that the first terminal is a master node, and the second terminal is a master node; or

the group flag field represents that the first terminal is a master node, and the second terminal is a slave node.

In one embodiment, there are one or at least two second terminals.

According to an eighth aspect, an IKMS entity is provided, including:

a receiving unit, configured to receive, from a first terminal, a first half session key parameter corresponding to a second terminal and an identifier of the second terminal, where the first half session key parameter corresponding to the second terminal and the identifier of the second terminal are used to generate an encrypted private key corresponding to the second terminal;

a generation unit, configured to: generate a second half session key parameter corresponding to the second terminal, and generate the encrypted private key corresponding to the second terminal based on the identifier of the second terminal, the first half session key parameter corresponding to the second terminal, and the second half session key parameter corresponding to the second terminal, where the second half session key parameter corresponding to the second terminal is used to decrypt the encrypted private key corresponding to the second terminal; and

a sending unit, configured to send the second half session key parameter corresponding to the second terminal, the identifier of the second terminal, and the encrypted private key corresponding to the second terminal to the first terminal.

In one embodiment, the generation unit includes:

a first generation module, configured to generate a private key corresponding to the second terminal based on the identifier of the second terminal;

a second generation module, configured to: generate the second half session key parameter corresponding to the second terminal, and generate a symmetric key corresponding to the second terminal based on the first half session key parameter corresponding to the second terminal and the second half session key parameter corresponding to the second terminal; and

a third generation module, configured to encrypt the private key corresponding to the second terminal based on the symmetric key corresponding to the second terminal, to generate the encrypted private key corresponding to the second terminal.

In one embodiment, the receiving unit is configured to:

receive a first message sent by the first terminal, where the first message includes the first half session key parameter corresponding to the second terminal, the identifier of the second terminal, and a first message authentication code, and the first message authentication code is used to authenticate that the first message is sent by the first terminal and perform authentication on integrity of the first message; and

correspondingly, the first generation module includes:

an authentication submodule, configured to perform authentication on the first message authentication code based on a first shared key, where the first shared key is a key negotiated between the first terminal and the IKMS entity; and

a first generation submodule, configured to: after it is determined that authentication on the first message authentication code succeeds, generate the private key corresponding to the second terminal based on the identifier of the second terminal.

In one embodiment, the first shared key includes a third key for generating the message authentication code and a fourth key for data encryption.

In one embodiment, the receiving unit is configured to:

receive an encrypted first message sent by the first terminal; and

correspondingly, the first generation module further includes:

a decryption submodule, configured to: before the authentication submodule performs authentication on the first message authentication code based on the first shared key, decrypt the encrypted first message based on the first shared key, to obtain the first message.

In one embodiment, the sending unit includes:

a fourth generation module, configured to generate a second message authentication code based on the first shared key, where the first shared key is the key negotiated between the first terminal and the IKMS entity; and

a first sending module, configured to send a second message to the first terminal, where the second message includes the second half session key parameter corresponding to the second terminal, the identifier of the second terminal, the encrypted private key corresponding to the second terminal, and the second message authentication code, and the second message authentication code is used to authenticate that the second message is sent by the IKMS entity and perform authentication on integrity of the second message.

In one embodiment, the first sending module includes:

a first encryption submodule, configured to encrypt the second message based on the first shared key, to generate an encrypted second message; and

a first sending submodule, configured to send the encrypted second message to the first terminal.

In one embodiment, the sending unit includes:

a fifth generation module, configured to generate signature information corresponding to the second terminal based on a private key of the IKMS entity, where the signature information corresponding to the second terminal is used to authenticate that the encrypted private key corresponding to the second terminal is generated by the IKMS entity; and

a second sending module, configured to send a third message to the first terminal, where the third message includes the second half session key parameter corresponding to the second terminal, the identifier of the second terminal, the encrypted private key corresponding to the second terminal, and the signature information corresponding to the second terminal.

In one embodiment, the second sending module includes:

a second encryption submodule, configured to encrypt the third message based on the first shared key, to generate an encrypted third message, where the first shared key is the key negotiated between the first terminal and the IKMS entity; and

a second sending submodule, configured to send the encrypted third message to the first terminal.

In one embodiment, the first terminal is a master node, and the second terminal is a slave node.

In one embodiment, there are one or at least two second terminals.

According to a ninth aspect, a terminal device is provided, including a unit or means configured to perform steps of any method according to the first aspect.

According to a tenth aspect, a terminal device is provided, including a processor, a memory, and a transmitter. The transmitter is coupled to the processor, and the processor controls a sending action of the transmitter;

the memory is configured to store computer executable program code, and the program code includes an instruction; and when the processor executes the instruction, the instruction enables the terminal device to perform any method according to the first aspect.

According to an eleventh aspect, a terminal device is provided, including at least one processing element or chip configured to perform any method according to the first aspect.

According to a twelfth aspect, a program is provided. When being executed by a processor, the program is used to perform any method according to the first aspect.

According to a thirteenth aspect, a computer-readable storage medium is provided, including the program according to the twelfth aspect.

According to a fourteenth aspect, a terminal device is provided, including a unit or means configured to perform steps of any method according to the second aspect.

According to a fifteenth aspect, a terminal device is provided, including a processor, a memory, and a transmitter. The transmitter is coupled to the processor, and the processor controls a sending action of the transmitter;

the memory is configured to store computer executable program code, and the program code includes an instruction; and when the processor executes the instruction, the instruction enables the terminal device to perform any method according to the second aspect.

According to a sixteenth aspect, a terminal device is provided, including at least one processing element or chip configured to perform any method according to the second aspect.

According to a seventeenth aspect, a program is provided. When being executed by a processor, the program is used to perform any method according to the second aspect.

According to an eighteenth aspect, a computer-readable storage medium is provided, including the program according to the seventeenth aspect.

According to a nineteenth aspect, an IDM entity is provided, including a unit or means configured to perform steps of any method according to the third aspect.

According to a twentieth aspect, an IDM entity is provided, including a processor, a memory, and a communications interface. The communications interface is coupled to the processor;

the memory is configured to store computer executable program code, and the program code includes an instruction; and when the processor executes the instruction, the instruction enables the IDM entity to perform any method according to the third aspect.

According to a twenty-first aspect, an IDM entity is provided, including at least one processing element or chip configured to perform any method according to the third aspect.

According to a twenty-second aspect, a program is provided. When being executed by a processor, the program is used to perform any method according to the third aspect.

According to a twenty-third aspect, a computer-readable storage medium is provided, including the program according to the twenty-second aspect.

According to a twenty-fourth aspect, an IKMS entity is provided, including a unit or means configured to perform steps of any method according to the fourth aspect.

According to a twenty-fifth aspect, an IKMS entity is provided, including a processor, a memory, and a communications interface. The communications interface is coupled to the processor;

the memory is configured to store computer executable program code, and the program code includes an instruction; and when the processor executes the instruction, the instruction enables the IDM entity to perform any method according to the fourth aspect.

According to a twenty-sixth aspect, an IKMS entity is provided, including at least one processing element or chip configured to perform any method according to the fourth aspect.

According to a twenty-seventh aspect, a program is provided. When being executed by a processor, the program is used to perform any method according to the fourth aspect.

According to a twenty-eighth aspect, a computer-readable storage medium is provided, including the program according to the twenty-seventh aspect.

It can be learnt that in the foregoing aspects, the first terminal receives, from the second terminal, the first half session key parameter corresponding to the second terminal and the identifier of the second terminal, where the first half session key parameter corresponding to the second terminal and the identifier of the second terminal are used to generate the encrypted private key corresponding to the second terminal; the first terminal sends the first half session key parameter corresponding to the second terminal and the identifier of the second terminal to the IKMS entity; the first terminal receives, from the IKMS entity, the second half session key parameter corresponding to the second terminal, the identifier of the second terminal, and the encrypted private key corresponding to the second terminal, where the second half session key parameter corresponding to the second terminal is used to decrypt the encrypted private key corresponding to the second terminal; and the first terminal sends the second half session key parameter corresponding to the second terminal and the encrypted private key corresponding to the second terminal to the second terminal based on the identifier of the second terminal. In this way, a private key obtaining method is provided. After a group is created for terminals, the second terminal initiates a private key obtaining request, the IKMS entity generates the encrypted private key corresponding to the second terminal, and the second terminal receives, by using the first terminal, the encrypted private key corresponding to the second terminal sent by the IKMS entity. Therefore, the second terminal can relatively quickly obtain the encrypted private key corresponding to the second terminal. This can prevent the private key from being stolen, and prevent communication information between groups from being stolen.

### BRIEF DESCRIPTION OF DRAWINGS

FIG. 1 is a schematic diagram of a network architecture of an IP network;

FIG. 2 is a schematic diagram of a network architecture of an ION network;

FIG. 3 is a schematic scenario diagram of a mobile communications network based on an ION network architecture according to an embodiment;

FIG. 4 is a schematic flowchart of a private key generation method according to an embodiment;

FIG. 5 is a schematic communication diagram 1 of a private key generation method according to an embodiment;

FIG. 6 is a schematic communication diagram 2 of a private key generation method according to an embodiment;

FIG. 7 is a schematic flowchart of a group creation method according to an embodiment;

FIG. 8 is a schematic communication diagram 1 of a group creation method according to an embodiment;

FIG. 9 is a schematic communication diagram 2 of a group creation method according to an embodiment;

FIG. 10 is a schematic communication diagram 3 of a group creation method according to an embodiment;

FIG. 11 is a schematic communication diagram 4 of a group creation method according to an embodiment;

FIG. 12 is a schematic flowchart of another private key generation method according to an embodiment;

FIG. 13 is a schematic communication diagram 1 of another private key generation method according to an embodiment;

FIG. 14A and FIG. 14B are a schematic communication diagram 2 of another private key generation method according to an embodiment;

FIG. 15A and FIG. 15B are a schematic flowchart of still another private key generation method according to an embodiment;

FIG. 16A and FIG. 16B are a schematic communication diagram of still another private key generation method according to an embodiment;

FIG. 17A to FIG. 17C are a schematic communication diagram 2 of still another private key generation method according to an embodiment;

FIG. 18A and FIG. 18B are a schematic flowchart of yet another private key generation method according to an embodiment;

FIG. 19A and FIG. 19B are a schematic communication diagram of yet another private key generation method according to an embodiment;

FIG. 20A to FIG. 20C are a schematic communication diagram 2 of yet another private key generation method according to an embodiment;

FIG. 21A and FIG. 21B are a schematic flowchart of still yet another private key generation method according to an embodiment;

FIG. 22A and FIG. 22B are a schematic communication diagram of still yet another private key generation method according to an embodiment;

FIG. 23A to FIG. 23C are a schematic communication diagram 2 of still yet another private key generation method according to an embodiment;

FIG. 24A and FIG. 24B are a schematic flowchart of a further private key generation method according to an embodiment;

FIG. 25A to FIG. 25C are a schematic communication diagram of a further private key generation method according to an embodiment;

FIG. 26A to FIG. 26C are a schematic communication diagram 2 of a further private key generation method according to an embodiment;

FIG. 27 is a schematic flowchart of a still further private key generation method according to an embodiment;

FIG. 28 is a schematic flowchart of another group creation method according to an embodiment;

FIG. 29 is a schematic flowchart of still another group creation method according to an embodiment;

FIG. 30 is a schematic flowchart of a yet further private key generation method according to an embodiment;

FIG. 31 is a schematic flowchart of a still yet further private key generation method according to an embodiment;

FIG. 32 is a schematic structural diagram of a first terminal according to an embodiment;

FIG. 33 is a schematic structural diagram of another first terminal according to an embodiment;

FIG. 34 is a schematic structural diagram of still another first terminal according to an embodiment;

FIG. 35 is a schematic structural diagram of yet another first terminal according to an embodiment;

FIG. 36 is a schematic structural diagram of still yet another first terminal according to an embodiment;

FIG. 37 is a schematic structural diagram of a second terminal according to an embodiment;

FIG. 38 is a schematic structural diagram of another second terminal according to an embodiment.

FIG. 39 is a schematic structural diagram of still another second terminal according to an embodiment;

FIG. 40 is a schematic structural diagram of an IDM entity according to an embodiment;

FIG. 41 is a schematic structural diagram of another IDM entity according to an embodiment;

FIG. 42 is a schematic structural diagram of still another IDM entity according to an embodiment;

FIG. 43 is a schematic structural diagram of an IKMS entity according to an embodiment;

FIG. 44 is a schematic structural diagram of another IKMS entity according to an embodiment; and

FIG. 45 is a schematic structural diagram of still another IKMS entity according to an embodiment.

### DESCRIPTION OF EMBODIMENTS

The embodiments of this application are applied to a 4G or 5G communications system or another system that may emerge in the future. The following describes some terms used in this application, to facilitate understanding of a person skilled in the art. It should be noted that, when solutions in the embodiments of this application are applied to the 5G communications system or the another system that may emerge in the future, names of a network device and a terminal may change, but this does not affect implementation of the solutions in the embodiments of this application.

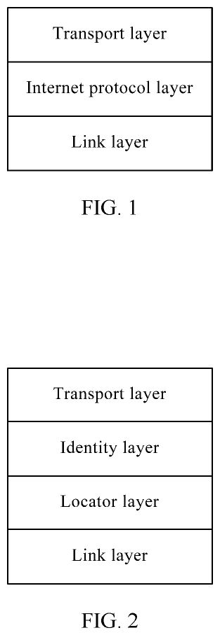

FIG. 1 is a schematic diagram of a network architecture of an IP network. As shown in FIG. 1, a conventional internet protocol (IP) network architecture includes a transport layer, an IP layer, and a link layer. The IP layer is used to record information such as an identity and a location of a terminal.

FIG. 2 is a schematic diagram of a network architecture of an ION network. As shown in FIG. 2, the ION network architecture includes a transport layer, an ID layer, a locator layer, and a link layer. The ION network architecture shown in FIG. 2 is an ION network architecture characterized by ID/locator separation. The ION network is a novel future network-oriented network architecture. A main difference between the ION network architecture and the conventional IP network architecture lies in a change of an IP layer. As shown in FIG. 1, in the conventional IP network architecture, when a host A establishes communication to a host B, for the host A, an IP address indicates a specific host with which the host A communicates, and the IP address also indicates routing information of a data packet on a network, where the routing information is also referred to as location information. Therefore, the IP address at the IP layer has dual attributes: an identity attribute and a location attribute. As shown in FIG. 2, the ID layer and the locator layer are provided in the ION network architecture. The ID layer is used to record an identity of a host, and the locator layer is used to record routing information of the host, so that the dual attributes of the IP address are separated in the ION network architecture. The ID layer is added in the ION network architecture. For the ION network architecture, an ID at a layer 3.5 represents a user identity, and an IP at a layer 3 represents a user location. For subsequent differentiation between the layer 3 in the ION network architecture, namely, the IP layer, and an IP layer in a conventional transmission control protocol/internet protocol (TCP/IP) protocol stack, the layer 3, namely, the IP layer in the ION network architecture is referred to as the locator layer in this application.

Based on the foregoing analysis, in the ION network architecture, the identity attribute and the location attribute of the host are separated, and a unified control management layer is established. The control management layer is used to manage a related service, and the control management layer is deployed on the ION network in a distributed manner. The control management layer can manage information such as the identity and the location of the host together. The control management layer mainly includes the following several functions: an identity management service (or identity service), a management service for mapping between an identity and a location (or mapping/location service), an ID relationship management service (or grouping service), and a metadata management service (or metadata service).

The ION network architecture can be applied to a plurality of scenarios. For example, such an architecture can be applied to an internet of things (IoT). Each IoT terminal has a unique invariable ID on the internet of things, and a relationship between IDs of IoT terminals may be established on the internet of things.

With development of the internet of things, a social internet of things (SIoT) is evolved on the internet of things. On the social internet of things, a social relationship may be established between terminals. The social relationship includes the following three relationships. A first relationship is an object ownership relationship (or ownership object relationship). In this relationship, a group (or cluster) may be created based on a terminal ownership. For example, on a smart home network, a personal notebook computer, a refrigerator, a television, an electricity meter, and another terminal belong to terminals disposed inside a house, and these terminals may be classified into one group. A second relationship is a co-location object relationship. In this relationship, a group may be created based on a terminal location relationship. For example, on a smart warehouse network, smart terminals that belong to one warehouse location may be classified into one group. A third relationship is a co-work object relationship. In this relationship, a group may be created based on work carried out by terminals. For example, in a smart irrigation system, perceptrons and an irrigation terminal work in one irrigation system, and the perceptrons and the irrigation terminal may be classified into one group. The control management layer in the ION network architecture needs to perform group creation and management.

On the internet of things, a group needs to be created for terminals. Herein, the terminals may also be referred to as nodes. Based on service types, various terminals on the internet of things may be categorized as a data collection and control-type terminal, a wearable terminal, a smart home terminal, a video surveillance terminal, a smart medical terminal, and the like. A large quantity of smart terminals in internet of things terminals are terminals with low power consumption and wide coverage. Such terminals are characterized by relatively low computing, storage, and network transmission capabilities, and are sensitive to battery consumption. After the smart terminals are classified into a plurality of groups, a distance from a terminal A with low power consumption to another terminal with a relatively high computing capability in a group is usually less than a distance from the terminal A to an access gateway. Therefore, the terminal A can forward a data packet to the terminal, in the group, that is closer to the terminal A. This can reduce power consumption, thereby saving energy. Based on the foregoing analysis, terminal power consumption can be reduced by creating a group for terminals.

In an existing group classification solution, the access gateway classifies network elements into a group based on network signal strengths of the network elements. For example, when the access gateway determines that a difference between network signal strengths of two network elements during accessing to the gateway falls within a specific range in a given time period, the access gateway classifies the two network elements into one group. The network elements herein refer to the foregoing terminals. In addition, one group may include at least one master node, or one group may include at least one master node and at least one slave node. In this way, through group classification, an IoT terminal with low power consumption can send a data packet to a nearby device during communication, instead of sending the data packet to a network element device that is relatively far from the IoT terminal. This reduces terminal power consumption. However, during group creation in the prior art, a group is created based on network signal strengths of terminals, and the network signal strengths of the terminals are based on locations or areas of the terminals. In this case, in an existing group creation manner, group classification can be performed based only on the locations or the areas of the terminals, and social attributes of the terminals are not considered. Consequently, the created group has a single characteristic, the terminals in the created group may be untrustworthy to each other, and trustworthiness of the terminals cannot be demonstrated. Moreover, during group creation in the prior art, group classification and creation is performed by the access gateway. Consequently, the terminals in the created group may be untrustworthy to each other, and a trust degree and security of the terminals in the group are relatively low.

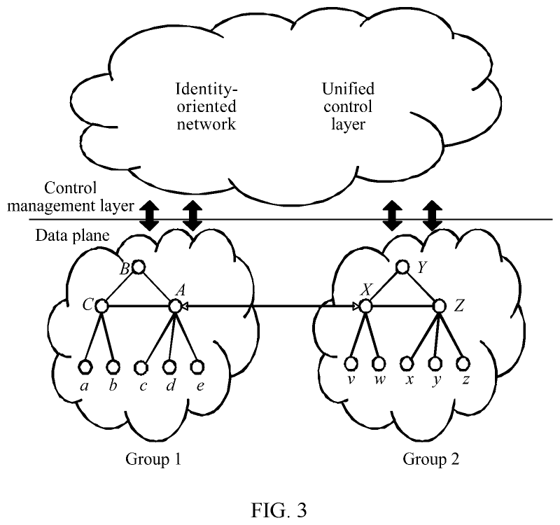

To resolve the foregoing prior-art problems, based on an ION network architecture, this application provides methods and devices for creating a group for IoT terminals and obtaining an initial key. FIG. 3 is a schematic scenario diagram of a mobile communications network based on an ION network architecture according to one embodiment. As shown in FIG. 3, a control management layer in the ION network architecture uses a unified ION control plane, and a data plane presents an example of group classification for terminals on an internet of things. Devices on the internet of things may be classified into two groups: Group 1 and Group 2. Each group includes at least one terminal. Using Group 1 as an example, a terminal A, a terminal B, and a terminal C are nodes with relatively high capabilities, and the terminal A, the terminal B, and the terminal C may be used as master nodes in Group 1; a terminal a, a terminal b, a terminal c, a terminal d, and a terminal e are nodes with relatively low capabilities, and the terminal a, the terminal b, the terminal c, the terminal d, and the terminal e may be used as slave nodes in Group 1. In this case, relationships in Group 1 are a master-slave relationship and a peer-to-peer relationship. For example, the terminal C and the terminal a are in a master-slave relationship, and the terminal a and the terminal e are in a peer-to-peer relationship. In Group 2, a terminal X, a terminal Y, and a terminal Z are used as master nodes in Group 2, and a terminal v, a terminal w, a terminal x, a terminal y, and a terminal z are used as slave nodes in Group 2.

The following interprets nouns in this application.

A terminal may include various handheld devices, vehicle-mounted devices, wearable devices, smart home devices, or computing devices that have communication functions, or another processing device connected to a wireless modem, and terminals in various forms such as mobile stations (MS), terminals, user equipment (UE), and software terminals, for example, a water meter, an electricity meter, and a sensor. In this application, the terminal may be a terminal on an internet of things or a terminal on another network.

A master node (master UE, M_UE) is also referred to as a master terminal.

A slave node (slave UE, SUE) is also referred to as a slave terminal.

A home subscriber server/AAA (authentication, authorization, and accounting) server (Home Subscriber Server/Authentication, Authorization, and Accounting, HSS/AAA) is a conventional access authentication server, and is also referred to as an HSS/AAA entity.

An identity management (IDM) entity means an identity service at an ION management control layer, and provides node ID management and ID group relationship management.

An identity-based key management system (identity and key management system, IKMS) entity is an identity-based key management center, that is, a private key generation center. By using an identity-based signature (IBS) technology, the IKMS entity may generate, for each node, a private key corresponding to an ID of the node used as a public key.

For the IBS, each terminal has its own public/private key pair. A public key is a meaningful character string, for example, an email address or a telephone number. A private key of the terminal is generated by a private key generation center (KGC) based on a user ID and a master private key of the key generation center. No package configuration file (PKG) needs to be used during signature, and only a signature, a message, an identity, and a master public key are required for signature authentication.

An algorithm in this application is interpreted as follows.

The IBS technology is an identity-based signature technology, and is a specific public-key cryptosystem. The IBS technology includes the following two features. A first feature is that a terminal ID is directly used as a public key, and no digital certificate needs to be used to bind the public key and a username. A second feature is that a trustworthy private key generation center needs to generate a private key corresponding to a Terminal ID for each terminal. For example, a terminal uses an email address Alice@123.com as a terminal ID to apply to the KGC for a private key corresponding to the terminal ID. To be specific, the terminal sends the email address Alice@123.com to the KGC, and then the KGC generates the private key corresponding to the email address for the terminal, according to a key generation algorithm by using a parameter such as a public key.

IBS-based identity authentication: A function of the IBS is the same as that of conventional digital signature. Therefore, for the IBS-based authentication, refer to a principle and a procedure of conventional digital signature-based authentication. However, a difference between the IBS-based authentication and the conventional digital signature-based authentication lies in: During use of the IBS, an authenticator needs to perform authentication on authenticity of a signature by using an identity of a party to be authenticated, and therefore no complex certificate system is required. For example, after a terminal A obtains a private key and signature information, the terminal performs authentication on the signature information directly by using parameters such as a signature and a public key.

A Diffie-Hellman key exchange (D-H) protocol is a security protocol. The protocol allows two devices to create a key through an insecure channel without knowing any advance information from each other. This key may be used as a symmetric key to encrypt communication content in subsequent communication. There are two global public parameters in the D-H protocol: a prime number q and an integer a, where a is a primitive root of q.

Specifically, it is assumed that a terminal A and a terminal B need to exchange a key. The terminal A selects a random number YA as a private key, where YA is less than the prime number q; and calculates a half session key parameter XA=a\hat{ }YA mod q. The terminal A confidentially stores a YA value, but the terminal A enables the half session key parameter XA to be publicly obtained by the terminal B. Correspondingly, the terminal B selects a private random number YB, where YB is less than the prime number q; and calculates a half session key parameter XB=a\hat{ }YB mod q. The terminal B confidentially stores a YB value, but the terminal B enables the half session key parameter XB to be publicly obtained by the terminal A. Then, a calculation manner of calculating a shared key by the terminal A is: the shared key K=(XB)\hat{ }YA mod q, and correspondingly, a calculation manner of calculating a shared key by the terminal B is: the shared key K=(XA)\hat{ }YB mod q. Results of the shared key K calculated by the terminal A and the terminal B are the same. The half session key parameter XB is equal to a\hat{ }YB mod q, so that the terminal A can calculate the shared key K=(XB)\hat{ }YA mod q=(a\hat{ }YB mod q)\hat{ }YA mod q=(a\hat{ }YB)\hat{ }YA mod q=a\hat{ }(YBYA) mod q=(a\hat{ }YA) YB mod q=(a\hat{ }YA mod q) YB mod q=(XA)\hat{ }YB mod q according to a series of calculations. The terminal B has learnt the shared key K=(XA)\hat{ }YB mod q. In this way, a same key is exchanged between the terminal A and the terminal B. In addition, in the foregoing process, the parameter YA and the parameter YB are confidential, so that the shared key for the terminal A and the terminal B cannot be calculated by another terminal or device.

For example, because the parameter YA and the parameter YB are confidential, and another terminal can use only parameters q, a, XA, and XB, the another terminal has to use a discrete logarithm to determine the key. However, the another terminal has difficulty in calculating the discrete logarithm. For example, in case of the prime number q=97 and the parameter a=5, the terminal A uses the random number YA=36, and the terminal B uses the random number YB=58. Then, the terminal A calculates the half session key parameter XA=5\hat{ }36=50 mod 97, and the terminal B calculates the half session key parameter XB=5\hat{ }58=44 mod 97. Next, the terminal A calculates the shared key K=(XB)\hat{ }YA mod 97=44\hat{ }36=75 mod 97, and the terminal A calculates the shared key K=(XA)\hat{ }YB mod 97=50\hat{ }58=75 mod 97. However, the another terminal has difficulty in calculating the shared key.

In this embodiment, a first half session key parameter is the key parameter XA in the D-H protocol, and a second half session key parameter is the key parameter XB in the D-H protocol. The two parties in communication need to exchange the half session key parameters to generate the shared key.

It should be noted that the nouns or terms used in the embodiments of this application may be mutually referenced. Details are not described again.

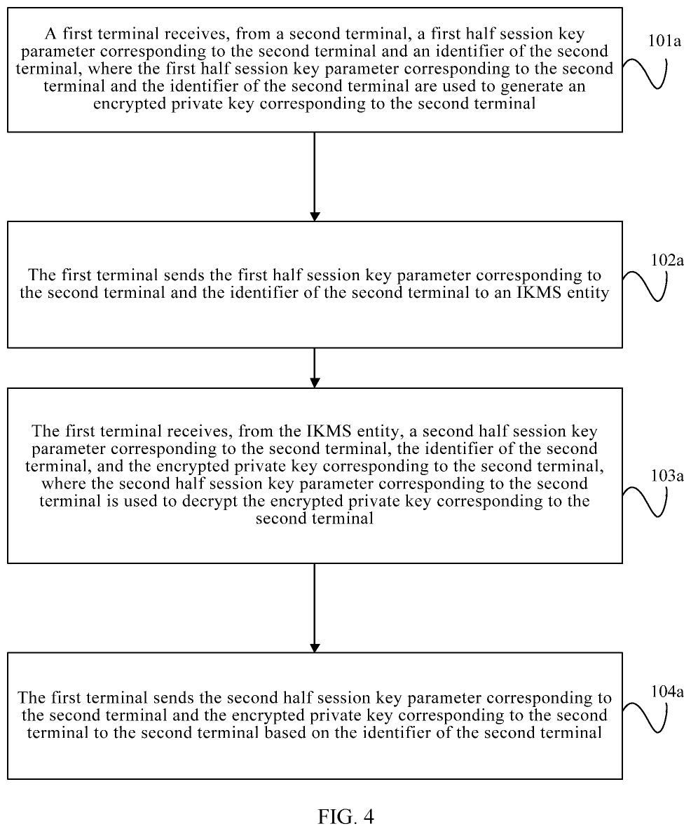

FIG. 4 is a schematic flowchart of a private key generation method according to an embodiment. As shown in FIG. 4, the method is as follows.

101a. A first terminal receives, from a second terminal, a first half session key parameter corresponding to the second terminal and an identifier of the second terminal, where the first half session key parameter corresponding to the second terminal and the identifier of the second terminal are used to generate an encrypted private key corresponding to the second terminal.

In one embodiment, the first terminal is a master node, and the second terminal is a slave node.

In this embodiment, after a group is created for the first terminal and the second terminal, the second terminal sends parameters for obtaining a private key to the first terminal. Specifically, the second terminal sends the first half session key parameter XA corresponding to the second terminal and the identifier of the second terminal to the first terminal, where the first half session key parameter XA is used for session key negotiation.

102a. The first terminal sends the first half session key parameter corresponding to the second terminal and the identifier of the second terminal to an IKMS entity.

In this embodiment, the first terminal sends the first half session key parameter XA corresponding to the second terminal and the identifier of the second terminal to the IKMS entity.

According to an IBS technology and by using the identifier of the second terminal as a public key, the IKMS entity generates a private key SK corresponding to the identifier of the second terminal, where the private key SK is the private key corresponding to the second terminal. Then, the IKMS entity generates a second half session key parameter XB, and the IKMS entity generates a symmetric key key corresponding to the second terminal based on the received first half session key parameter XA corresponding to the second terminal and the second half session key parameter XB, where the symmetric key key is a symmetric key for the IKMS entity and the second terminal. Next, the IKMS entity encrypts the private key SK corresponding to the second terminal by using the symmetric key key corresponding to the second terminal, to generate the encrypted private key (SK)_{key} corresponding to the second terminal. The second half session key parameter corresponding to the second terminal is used to decrypt the encrypted private key (SK)_{key} corresponding to the second terminal.

103a. The first terminal receives, from the IKMS entity, the second half session key parameter corresponding to the second terminal, the identifier of the second terminal, and the encrypted private key corresponding to the second terminal, where the second half session key parameter corresponding to the second terminal is used to decrypt the encrypted private key corresponding to the second terminal.

In this embodiment, the first terminal receives, from the IKMS entity, the second half session key parameter XB corresponding to the second terminal, the identifier of the second terminal, and the encrypted private key (SK)_{key} corresponding to the second terminal.

104a. The first terminal sends the second half session key parameter corresponding to the second terminal and the encrypted private key corresponding to the second terminal to the second terminal based on the identifier of the second terminal.

In this embodiment, the first terminal sends the second half session key parameter XB corresponding to the second terminal, the identifier of the second terminal, and the encrypted private key (SK)_{key} corresponding to the second terminal to the second terminal. Then, the second terminal may decrypt the encrypted private key (SK)_{key} corresponding to the second terminal, to obtain the private key SK corresponding to the second terminal.

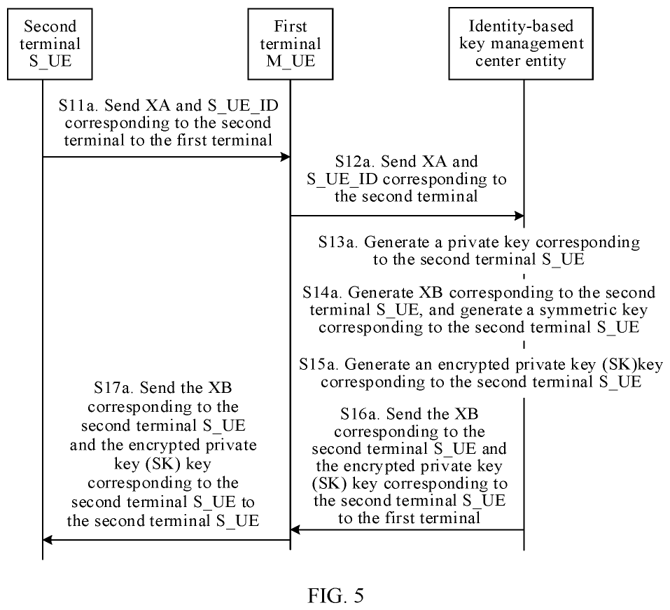

FIG. 5 is a schematic communication diagram 1 of a private key generation method according to an embodiment. FIG. 5 is a schematic communication diagram of a private key obtaining method performed between one second terminal and one first terminal. The method is as follows.

S11a. The second terminal sends a first half session key parameter corresponding to the second terminal and an identifier of the second terminal to the first terminal, where the first half session key parameter corresponding to the second terminal and the identifier of the second terminal are used to generate an encrypted private key corresponding to the second terminal.

In this embodiment, after a group is created for the first terminal M_UE and the second terminal S_UE, the second terminal S_UE sends the first half session key parameter XA corresponding to the second terminal S_UE and the identifier S_UE_ID of the second terminal to the first terminal M_UE, where the first half session key parameter XA is used for session key negotiation.

S12a. The first terminal sends the first half session key parameter corresponding to the second terminal and the identifier of the second terminal to an IKMS entity.

In this embodiment, the first terminal M_UE sends the first half session key parameter XA corresponding to the second terminal S_UE and the identifier S_UE_ID of the second terminal to the IKMS entity.

S13a. The IKMS entity generates a private key corresponding to the second terminal based on the identifier of the second terminal.

In this embodiment, according to an IBS technology and by using the identifier S_UE_ID of the second terminal as a public key, the IKMS entity generates a private key SK corresponding to the identifier S_UE_ID of the second terminal, where the private key SK is the private key corresponding to the second terminal S_UE.

S14a. The IKMS entity generates a second half session key parameter corresponding to the second terminal, and generates a symmetric key corresponding to the second terminal based on the first half session key parameter corresponding to the second terminal and the second half session key parameter corresponding to the second terminal.

In this embodiment, the IKMS entity generates the second half session key parameter XB corresponding to the second terminal S_UE, and the IKMS entity generates the symmetric key key corresponding to the second terminal S_UE based on the received first half session key parameter XA corresponding to the second terminal S_UE and the second half session key parameter XB corresponding to the second terminal S_UE, where the symmetric key key is a symmetric key for the IKMS entity and the second terminal SUE.

S15a. The IKMS entity encrypts the private key corresponding to the second terminal based on the symmetric key corresponding to the second terminal, to generate the encrypted private key corresponding to the second terminal, where the second half session key parameter corresponding to the second terminal is used to decrypt the encrypted private key corresponding to the second terminal.

In this embodiment, the IKMS entity encrypts the private key SK corresponding to the second terminal S_UE based on the symmetric key key corresponding to the second terminal S_UE, to generate the encrypted private key (SK)_{key} corresponding to the second terminal SUE.

S16a. The IKMS entity sends the second half session key parameter corresponding to the second terminal, the identifier of the second terminal, and the encrypted private key corresponding to the second terminal to the first terminal, where the second half session key parameter corresponding to the second terminal is used to decrypt the encrypted private key corresponding to the second terminal.

Specifically, after step 208, the first terminal M_UE receives, from the IKMS entity, the second half session key parameter XB corresponding to the second terminal S_UE, the identifier S_UE_ID of the second terminal, and the encrypted private key (SK)_{key} corresponding to the second terminal S_UE.

S17a. The first terminal sends the second half session key parameter corresponding to the second terminal and the encrypted private key corresponding to the second terminal to the second terminal.

In this embodiment, the first terminal M_UE sends the second half session key parameter XB corresponding to the second terminal S_UE and the encrypted private key (SK)_{key} corresponding to the second terminal S_UE to the second terminal S_UE. Then, the second terminal S_UE decrypts the encrypted private key (SK)_{key} corresponding to the second terminal S_UE, to obtain the private key SK corresponding to the second terminal SUE.

After a group is created for one second terminal and at least two first terminals, private key obtaining can be completed according to step S11a to step S17a.

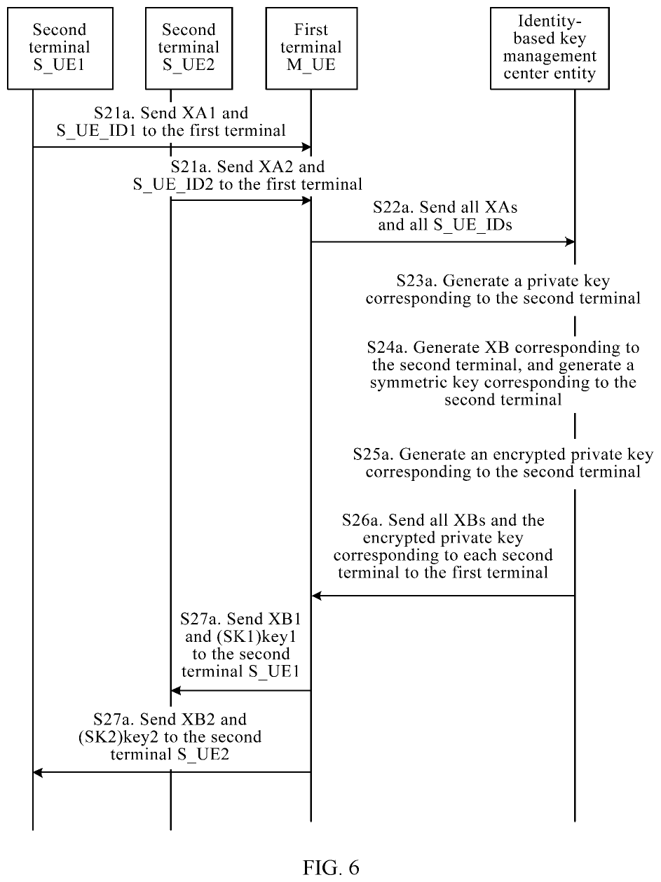

FIG. 6 is a schematic communication diagram 2 of a private key generation method according to an embodiment. FIG. 6 is a schematic communication diagram of private key obtaining performed between at least two second terminals and one first terminal. The method is as follows.

S21a. Each second terminal sends a first half session key parameter corresponding to the second terminal and an identifier of the second terminal to the first terminal.

In this embodiment, after a group is created, each second terminal SUE sends the first half session key parameter XA corresponding to the second terminal S_UE and the identifier S_UE_ID of the second terminal to the first terminal M_UE, where the first half session key parameter XA is used for session key negotiation.

For example, a second terminal S_UE1 sends a first half session key parameter XA1 corresponding to the second terminal S_UE1 and an identifier S_UE_ID1 of the second terminal S_UE1 to the first terminal M_UE; and a second terminal S_UE2 sends a first half session key parameter XA2 corresponding to the second terminal S_UE2 and an identifier S_UE_ID2 of the second terminal S_UE2 to the first terminal M_UE.

S22a. The first terminal sends the first half session key parameter corresponding to each second terminal and the identifier of the second terminal to an IKMS entity.

In this embodiment, the first terminal M_UE adds first half session key parameters and identifiers of all second terminals S_UE to one message, and then the first terminal M_UE sends the first half session key parameter XA corresponding to each second terminal and the identifier S_UE_ID of the second terminal to the IKMS entity.

For example, the first terminal M_UE adds, to one message, the first half session key parameter XA1 corresponding to the second terminal S_UE1, the identifier S_UE_ID1 of the second terminal S_UE1, the first half session key parameter XA2 corresponding to the second terminal S_UE2, and the identifier S_UE_ID2 of the second terminal S_UE2; and then sends the message to the IKMS entity.

S23a. The IKMS entity generates a private key corresponding to each second terminal based on the identifier of the second terminal.

S24a. The IKMS entity generates a second half session key parameter corresponding to each second terminal, and generates a symmetric key corresponding to the second terminal based on the first half session key parameter corresponding to the second terminal and the second half session key parameter corresponding to the second terminal.

S25a. The IKMS entity encrypts the private key corresponding to each second terminal based on the symmetric key corresponding to the second terminal, to generate an encrypted private key corresponding to the second terminal.

In this embodiment, for each second terminal S_UE, the IKMS entity performs S69, S691, and S692 to obtain the encrypted private key (SK)_{key} corresponding to the second terminal.

For example, according to an IBS technology, the IKMS entity generates a private key SK1 corresponding to the second terminal S_UE1 based on the identifier S_UE_ID1 of the second terminal S_UE1, and generates a private key SK2 corresponding to the second terminal S_UE2 based on the identifier S_UE_ID2 of the second terminal S_UE2. Then, the IKMS entity generates a second half session key parameter XB1 corresponding to the second terminal S_UE1, and generates a symmetric key key1 corresponding to the second terminal S_UE1 based on the received first half session key parameter XA1 corresponding to the second terminal S_UE1 and XB1. Next, the IKMS entity encrypts the private key SK2 corresponding to the second terminal S_UE1 based on the symmetric key key1 corresponding to the second terminal S_UE1, to generate an encrypted private key (SK1)_{key1} corresponding to the second terminal S_UE1. In addition, the IKMS entity generates a second half session key parameter XB2 corresponding to the second terminal S_UE2, and generates a symmetric key key2 corresponding to the second terminal S_UE2 based on the received first half session key parameter XA2 corresponding to the second terminal S_UE2 and XB2. Next, the IKMS entity encrypts the private key SK2 corresponding to the second terminal S_UE2 based on the symmetric key key2 corresponding to the second terminal S_UE2, to generate an encrypted private key (SK2)_{key2} corresponding to the second terminal S_UE2.

S26a. The IKMS entity sends the second half session key parameter corresponding to each second terminal, the identifier of the second terminal, and the encrypted private key corresponding to the second terminal to the first terminal.

In one embodiment, the IKMS entity adds, to one message, the second half session key parameter XB corresponding to each second terminal S_UE, the identifier S_UE_ID of the second terminal, and the encrypted private key SK corresponding to the second terminal S_UE, and then sends the message to the first terminal. The first terminal M_UE receives, from the IKMS entity, the second half session key parameter XB corresponding to each second terminal S_UE, the identifier S_UE_ID of the second terminal, and the encrypted private key (SK)_{key} corresponding to the second terminal SUE.

For example, the IKMS entity sends XB1, S_UE_ID1, (SK1)_{key1}, XB2, S_UE_ID2, and (SK2)_{key2} to the first terminal M_UE.

S27a. The first terminal sends the second half session key parameter corresponding to the second terminal and the encrypted private key corresponding to the second terminal to the second terminal.

In this embodiment, the first terminal M_UE sends the second half session key parameter XB corresponding to the second terminal S_UE and the encrypted private key SK corresponding to the second terminal S_UE to the second terminal S_UE. In other words, the first terminal M_UE sends the second half session key parameter and the private key to the corresponding second terminal SUE.

For example, the first terminal M_UE sends XB1 and (SK1)_{key1} to the corresponding second terminal S_UE1 based on S_UE_ID1, and the first terminal M_UE sends XB2 and (SK2)_{key2} to the corresponding second terminal S_UE2 based on S_UE_ID2.

Then, each second terminal S_UE decrypts the encrypted private key SK corresponding to the second terminal S_UE, to obtain the private key SK corresponding to the second terminal S_UE. For example, the second terminal S_UE1 decrypts (SK1)_{key1}, to obtain the private key SK1 corresponding to the second terminal S_UE1; and the second terminal S_UE2 decrypts (SK2)_{key2}, to obtain the private key SK2 corresponding to the second terminal S_UE2.

In this embodiment, the first terminal receives, from the second terminal, the first half session key parameter corresponding to the second terminal and the identifier of the second terminal, where the first half session key parameter corresponding to the second terminal and the identifier of the second terminal are used to generate the encrypted private key corresponding to the second terminal; the first terminal sends the first half session key parameter corresponding to the second terminal and the identifier of the second terminal to the IKMS entity; the first terminal receives, from the IKMS entity, the second half session key parameter corresponding to the second terminal, the identifier of the second terminal, and the encrypted private key corresponding to the second terminal, where the second half session key parameter corresponding to the second terminal is used to decrypt the encrypted private key corresponding to the second terminal; and the first terminal sends the second half session key parameter corresponding to the second terminal and the encrypted private key corresponding to the second terminal to the second terminal based on the identifier of the second terminal. In this way, a private key obtaining method is provided. After a group is created for terminals, the second terminal initiates a private key obtaining request, the IKMS entity generates the encrypted private key corresponding to the second terminal, and the second terminal receives, by using the first terminal, the encrypted private key corresponding to the second terminal sent by the IKMS entity. Therefore, the second terminal can relatively quickly obtain the encrypted private key corresponding to the second terminal. This can prevent the private key from being stolen, and prevent communication information between groups from being stolen.

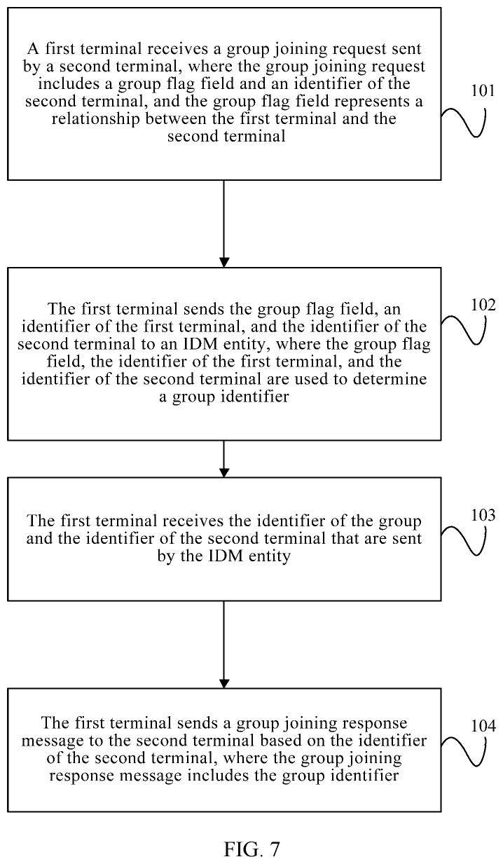

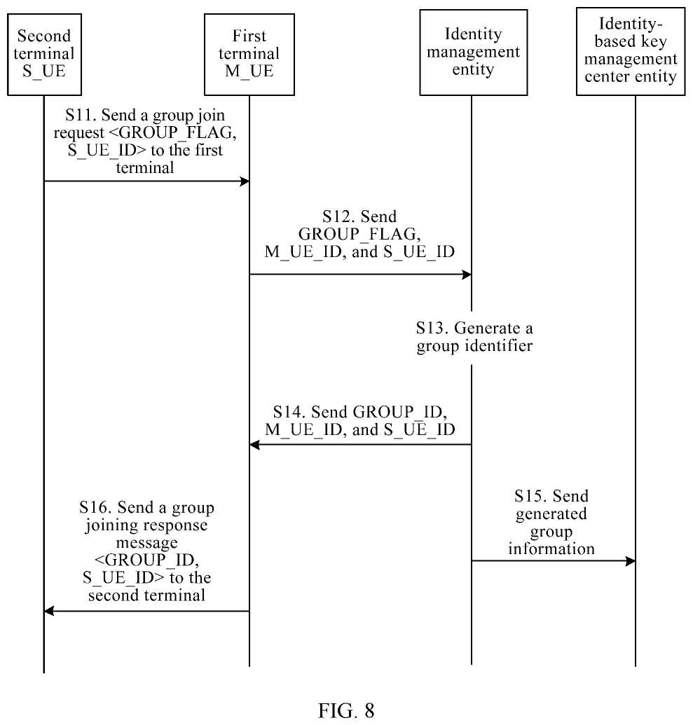

FIG. 7 is a schematic flowchart of a group creation method according to an embodiment. As shown in FIG. 7, the method is as follows.

101. A first terminal receives a group joining request sent by a second terminal, where the group joining request includes a group flag field and an identifier of the second terminal, and the group flag field represents a relationship between the first terminal and the second terminal.

In one embodiment, the group flag field represents that the first terminal is a master node, and the second terminal is a master node; or the group flag field represents that the first terminal is a master node, and the second terminal is a slave node.

In one embodiment, there are one or at least two second terminals.

In this embodiment, before step 101, through initiation, the first terminal and the second terminal can access a control plane, and the first terminal has negotiated a second shared key K_{IDM_M} and a first shared key K_{IKMS_M} with network elements such as an IDM entity and an IKMS entity, respectively. Specifically, the first terminal has negotiated the second shared key K_{IDM_M} with the IDM entity by using an HSS/AAA entity, and the first terminal has negotiated the first shared key K_{IKMS_M} with the IKMS entity by using the HSS/AAA entity.

In step 101, the second terminal and the first terminal establish a secure channel, and the second terminal sends a group joining request bonding_request to the first terminal through the secure channel. The group joining request bonding_request includes the group flag field GROUP FLAG and the identifier of the second terminal, and the group flag field GROUP FLAG represents the relationship between the first terminal and the second terminal. The secure channel may be based on a layer-2 link layer technology, and the second terminal and the first terminal establish a connection by using a pre-shared key. For example, the group flag field GROUP_FLAG represents that the relationship between the first terminal and the second terminal is a master-slave relationship, or the group flag field GROUP_FLAG represents that the relationship between the first terminal and the second terminal is a peer-to-peer relationship. The group flag field GROUP_FLAG can be represented as a group joining request.

When there are at least two second terminals, each second terminal sends a group joining request bonding_request to the first terminal through its own secure channel. The group joining request bonding_request sent by each second terminal includes a group flag field GROUP_FLAG and an identifier of the second terminal.

102. The first terminal sends the group flag field, an identifier of the first terminal, and the identifier of the second terminal to the IDM entity, where the group flag field, the identifier of the first terminal, and the identifier of the second terminal are used to determine a group identifier.

In this embodiment, the first terminal updates information required for group creation, and the first terminal sends the group flag field GROUP_FLAG, the identifier of the first terminal, and the identifier of the second terminal to the IDM entity.

Then, the IDM entity generates the group identifier GROUP_ID, and then sends the group identifier GROUP_ID, the identifier of the first terminal, and the identifier of the second terminal to the first terminal.

When there are at least two second terminals, the first terminal sends the group flag field GROUP_FLAG, the identifier of the first terminal, and the identifier of each second terminal to the IDM entity. Then, the IDM entity sends the generated group identifier GROUP_ID, the identifier of the first terminal, and the identifier of the second terminal to the first terminal.

103. The first terminal receives the group identifier and the identifier of the second terminal that are sent by the IDM entity.

104. The first terminal sends a group joining response message to the second terminal based on the identifier of the second terminal, where the group joining response message includes the group identifier.

In this embodiment, after step 103, the first terminal sends, through the secure channel based on the identifier of the second terminal, the group joining response message to the second terminal corresponding to the identifier of the second terminal, where the group joining response message includes the group identifier GROUP_ID and the identifier of the second terminal; and then notifies the second terminal that group creation succeeds.

When there are at least two second terminals, the first terminal sends a group joining response message to each second terminal. The group joining response message received by the second terminal includes the group identifier GROUP_ID and the identifier of the second terminal.

FIG. 8 is a schematic communication diagram 1 of a group creation method according to an embodiment. FIG. 8 is a schematic communication diagram of a group creation method performed between one second terminal and one first terminal. The method is as follows.

S11. The second terminal sends a group joining request to the first terminal, where the group joining request includes a group flag field and an identifier of the second terminal, and the group flag field represents a relationship between the first terminal and the second terminal.

In this embodiment, before step S11, through initiation, the first terminal and the second terminal can access a control plane, and the first terminal has negotiated a second shared key K_{IDM_M} and a first shared key K_{IKMS_M} with network elements such as an IDM entity and an IKMS entity, respectively.

The second terminal S_UE and the first terminal M_UE establish a secure channel, and the second terminal S_UE sends a group joining request bonding_request to the first terminal M_UE through the secure channel. The group joining request bonding_request includes the group flag field GROUP_FLAG and the identifier S_UE_ID of the second terminal, and the group flag field GROUP_FLAG represents that the first terminal M_UE and the second terminal S_UE are in a master-slave relationship. In other words, the first terminal M_UE is a master node, and the second terminal S_UE is a slave node. For example, message content of the group joining request bonding_request is <GROUP_FLAG, S_UE_ID>, and S_UE_ID is the ID of the second terminal SUE. The secure channel may be based on a layer-2 link layer technology, and the second terminal S_UE and the first terminal M_UE establish a connection by using a pre-shared key.

S12. The first terminal sends the group flag field, an identifier of the first terminal, and the identifier of the second terminal to the IDM entity, where the group flag field, the identifier of the first terminal, and the identifier of the second terminal are used to determine a group identifier.

In this embodiment, the first terminal M_UE updates information required for group creation, and the first terminal M_UE sends the group flag field GROUP_FLAG, the identifier M_UE_ID of the first terminal M_UE, and the identifier S_UE_ID of the second terminal S_UE to the IDM entity.

S13. The IDM entity generates the group identifier.

In this embodiment, the IDM entity confirms information such as a group, a group member, and a relationship between nodes in the group, and the IDM entity generates the group identifier GROUP_ID. Then, the IDM entity determines group information, where the group information includes the group identifier GROUP_ID, the identifier M_UE_ID of the first terminal M_UE, and the identifier S_UE_ID of the second terminal SUE.

S14. The IDM entity sends the group identifier and the identifier of the second terminal to the first terminal.

In this embodiment, the IDM entity sends the group identifier GROUP_ID, the identifier M_UE_ID of the first terminal M_UE, and the identifier S_UE_ID of the second terminal S_UE to the first terminal M_UE.

S15. The IDM entity sends the generated group information to the IKMS entity.

In this embodiment, the IDM entity sends the determined group information to the IKMS entity. A sequence of step S14 and step S15 is not limited. The first terminal M_UE may perform step S14 and step S15 simultaneously, the first terminal M_UE may perform step S15 after step S14, or the first terminal M_UE may perform step S14 after step S15.

S16. The first terminal sends a group joining response message to the second terminal based on the identifier of the second terminal, where the group joining response message includes the group identifier.

In this embodiment, the first terminal M_UE sends the group joining response message to the second terminal S_UE, where the group joining response message includes the group identifier GROUP_ID and the identifier S_UE_ID of the second terminal SUE.

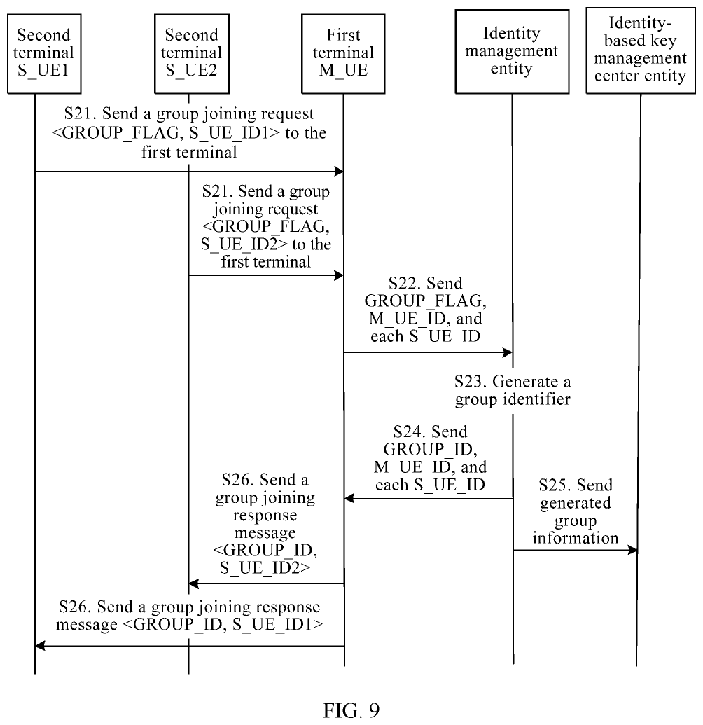

FIG. 9 is a schematic communication diagram 2 of a group creation method according to an embodiment. FIG. 9 is a schematic communication diagram of a group creation method performed between at least two second terminals and one first terminal. The method is as follows.

S21. Each second terminal sends a group joining request to the first terminal, where the group joining request includes a group flag field and an identifier of the second terminal, and the group flag field represents a relationship between the first terminal and the second terminal.

In this embodiment, before step S21, through initiation, the first terminal and the second terminal can access a control plane, and the first terminal has negotiated a second shared key K_{IDM_M} and a first shared key K_{IKMS_M} with network elements such as an IDM entity and an IKMS entity, respectively.

Each second terminal S_UE and the first terminal M_UE establish a secure channel, and the second terminal S_UE sends a group joining request bonding_request to the first terminal M_UE through the secure channel. The group joining request bonding_request includes the group flag field GROUP_FLAG and the identifier S_UE_ID of the second terminal, and the group flag field GROUP_FLAG represents that the first terminal M_UE and the second terminal S_UE are in a master-slave relationship. In other words, the first terminal M_UE is a master node, and the second terminal S_UE is a slave node. For example, message content of the group joining request bonding_request is <GROUP_FLAG, S_UE_ID>, and S_UE_ID is the ID of the second terminal SUE.

For example, a second terminal S_UE1 sends a group joining request bonding_request to the first terminal M_UE, where message content of the group joining request bonding_request is <GROUP_FLAG, S_UE_ID1>, and S_UE_ID1 is an ID of the second terminal S_UE1; and a second terminal S_UE2 sends a group joining request bonding_request to the first terminal M_UE, where message content of the group joining request bonding_request is <GROUP_FLAG, S_UE_ID2>, and S_UE_ID2 is an ID of the second terminal S_UE2.

S22. The first terminal sends the group flag field, an identifier of the first terminal, and the identifier of each second terminal to the IDM entity.

In this embodiment, the first terminal M_UE updates information required for group creation, and the first terminal M_UE sends the group flag field GROUP_FLAG, the identifier M_UE_ID of the first terminal M_UE, and the identifier S_UE_ID of each second terminal S_UE to the IDM entity.

For example, the first terminal M_UE sends GROUP_FLAG, M_UE_ID, S_UE_ID1, and S_UE_ID2 to the IDM entity.

S23. The IDM entity generates a group identifier.

In this embodiment, the IDM entity confirms information such as a group, a group member, and a relationship between nodes in the group, and the IDM entity generates the group identifier GROUP_ID. Then, the IDM entity determines group information, where the group information includes the group identifier GROUP_ID, the identifier M_UE_ID of the first terminal M_UE, and the identifier S_UE_ID of each second terminal S_UE.

S24. The IDM entity sends the group identifier and the identifier of the second terminal to the first terminal.

In this embodiment, the IDM entity sends the group identifier GROUP_ID, the identifier M_UE_ID of the first terminal M_UE, and the identifier S_UE_ID of each second terminal S_UE to the first terminal M_UE.

S25. The IDM entity sends the generated group information to the IKMS entity.

In this embodiment, the IDM entity sends the determined group information to the IKMS entity. A sequence of step S24 and step S25 is not limited.

S26. The first terminal sends a group joining response message to each second terminal, where the group joining response message includes the group identifier.

In this embodiment, the first terminal M_UE sends the group joining response message to each second terminal S_UE, where the group joining response message received by the second terminal S_UE includes the group identifier GROUP_ID and the identifier S_UE_ID of the second terminal SUE.

For example, the first terminal M_UE sends GROUP_ID and S_UE_ID1 to the second terminal S_UE1, and the first terminal M_UE sends GROUP_ID and S_UE_ID2 to the second terminal S_UE2.

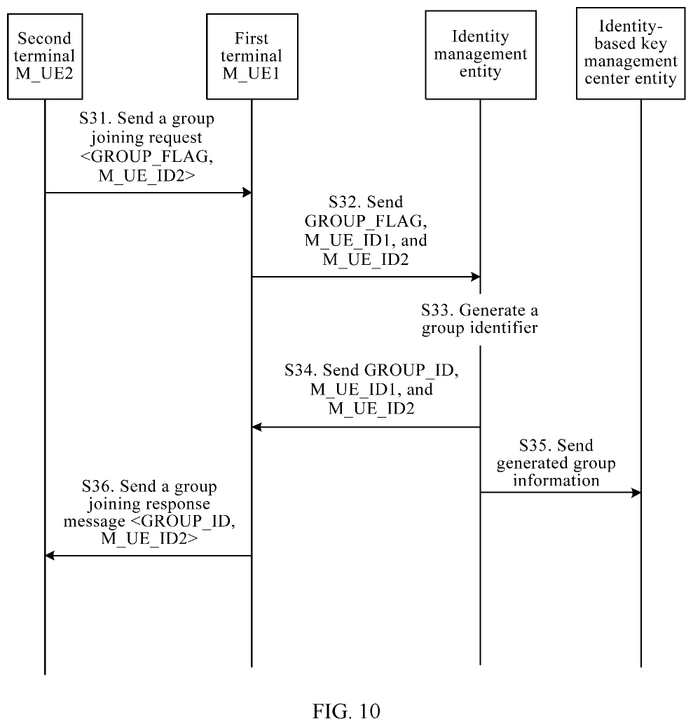

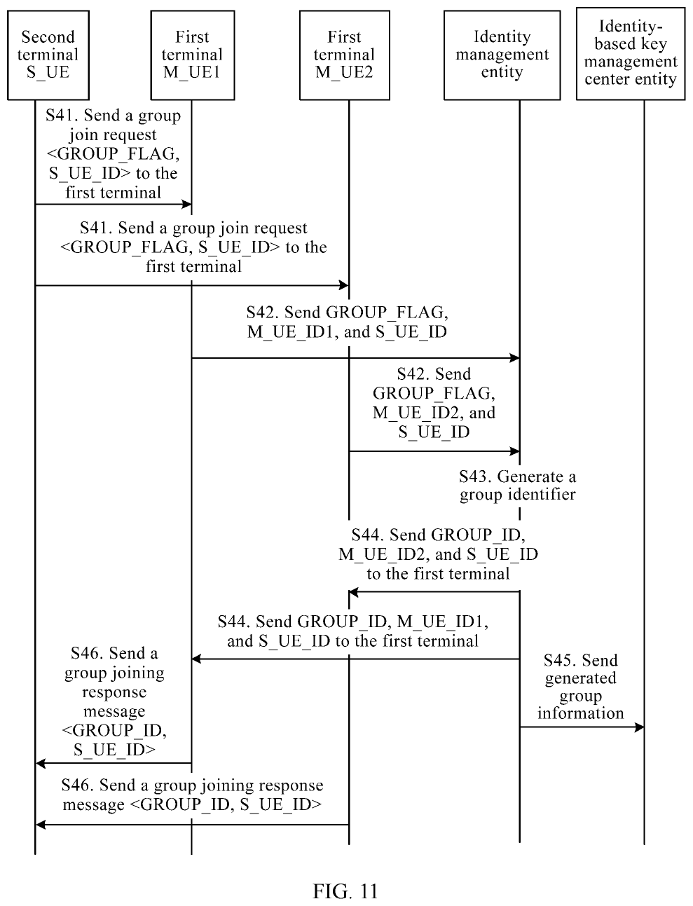

FIG. 10 is a schematic communication diagram 3 of a group creation method according to an embodiment. FIG. 10 is a schematic communication diagram of a group creation method performed between one second terminal and one first terminal. The method is as follows.

S31. The second terminal sends a group joining request to the first terminal, where the group joining request includes a group flag field and an identifier of the second terminal, and the group flag field represents a relationship between the first terminal and the second terminal.

In this embodiment, before step S31, through initiation, the first terminal M_UE1 and the second terminal M_UE2 can access a control plane, and the first terminal M_UE1 has negotiated a second shared key K_{IDM_M} and a first shared key K_{IKMS_M} with network elements such as an IDM entity and an IKMS entity, respectively.

The second terminal M_UE2 and the first terminal M_UE1 establish a secure channel, and the second terminal M_UE2 sends a group joining request bonding_request to the first terminal M_UE1 through the secure channel. The group joining request bonding_request includes the group flag field GROUP_FLAG and the identifier M_UE_ID2 of the second terminal, and the group flag field GROUP_FLAG represents that the first terminal M_UE1 and the second terminal M_UE2 are in a peer-to-peer relationship. In other words, the first terminal M_UE1 is a master node, and the second terminal M_UE2 is a master node. For example, message content of the group joining request bonding_request is <GROUP_FLAG, M_UE_ID2>, and M_UE_ID2 is the ID of the second terminal M_UE2.

S32. The first terminal sends the group flag field, an identifier of the first terminal, and the identifier of the second terminal to the IDM entity, where the group flag field, the identifier of the first terminal, and the identifier of the second terminal are used to determine a group identifier.

In this embodiment, the first terminal M_UE1 updates information required for group creation, and the first terminal M_UE1 sends the group flag field GROUP_FLAG, the identifier M_UE_ID1 of the first terminal M_UE1, and the identifier M_UE_ID2 of the second terminal M_UE2 to the IDM entity.

S33. The IDM entity generates the group identifier.

In this embodiment, the IDM entity confirms information such as a group, a group member, and a relationship between nodes in the group, and the IDM entity generates the group identifier GROUP_ID. Then, the IDM entity determines group information, where the group information includes the group identifier GROUP_ID, the identifier M_UE_ID1 of the first terminal M_UE1, and the identifier M_UE_ID2 of the second terminal M_UE2.

S34. The IDM entity sends the group identifier and the identifier of the second terminal to the first terminal.

In this embodiment, the IDM entity sends the group identifier GROUP_ID, the identifier M_UE_ID1 of the first terminal M_UE1, and the identifier M_UE_ID2 of the second terminal M_UE2 to the first terminal M_UE1.

S35. The IDM entity sends the generated group information to the IKMS entity.

In this embodiment, the IDM entity sends the determined group information to the IKMS entity. A sequence of step S34 and step S35 is not limited.

S36. The first terminal sends a group joining response message to the second terminal based on the identifier of the second terminal, where the group joining response message includes the group identifier.

In this embodiment, the first terminal M_UE1 sends the group joining response message to the second terminal M_UE2, where the group joining response message includes the group identifier GROUP_ID and the identifier M_UE_ID2 of the second terminal M_UE2.

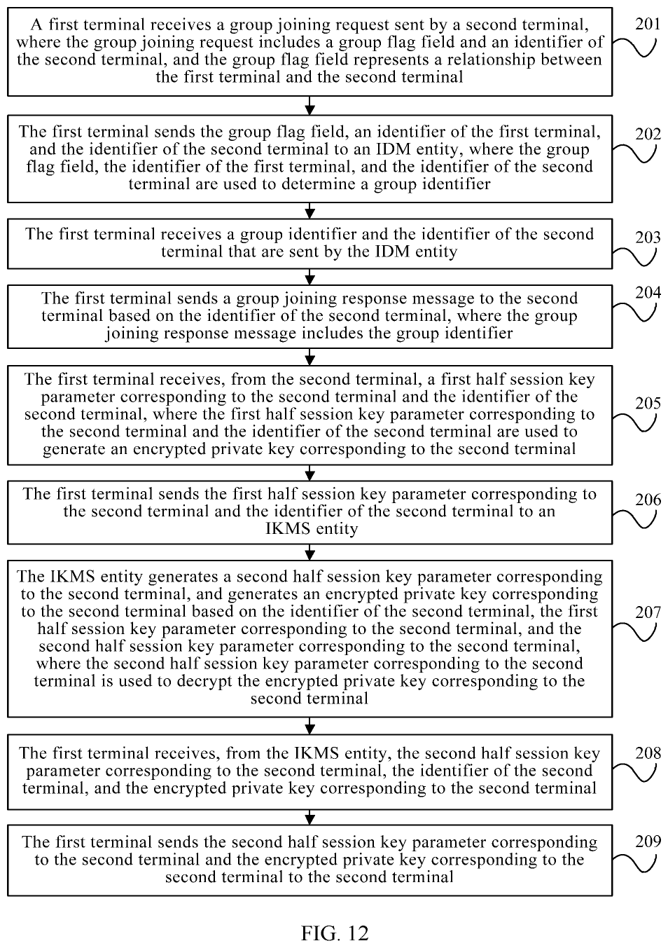

FIG. 11 is a schematic communication diagram 4 of a group creation method according to an embodiment. FIG. 11 is a schematic communication diagram of a group creation method performed between one second terminal and at least two first terminals. The method is as follows.

S41. The second terminal sends a group joining request to each first terminal, where the group joining request includes a group flag field and an identifier of the second terminal, and the group flag field represents a relationship between the first terminal and the second terminal.

In this embodiment, before step S41, through initiation, the first terminal and the second terminal can access a control plane, and the first terminal has negotiated a second shared key K_{IDM_M} and a first shared key K_{IKMS_M} with network elements such as an IDM entity and an IKMS entity, respectively.

The second terminal S_UE and each first terminal M_UE establish a secure channel, and the second terminal S_UE sends a group joining request bonding_request to the first terminal M_UE through the secure channel. The group joining request bonding_request received by the first terminal M_UE includes the group flag field GROUP_FLAG and the identifier S_UE_ID of the second terminal, and the group flag field GROUP_FLAG represents that the first terminal M_UE and the second terminal S_UE are in a master-slave relationship. In other words, the first terminal M_UE is a master node, and the second terminal S_UE is a slave node. For example, message content of the group joining request bonding_request is <GROUP_FLAG, S_UE M>, and S_UE_ID is the ID of the second terminal SUE.

S42. Each first terminal sends the group flag field, an identifier of the first terminal, and the identifier of the second terminal to the IDM entity.

In this embodiment, each first terminal M_UE updates information required for group creation, and the first terminal M_UE sends the group flag field GROUP_FLAG, the identifier M_UE_ID of the first terminal M_UE, and the identifier S_UE_ID of the second terminal S_UE to the IDM entity.

For example, a first terminal M_UE1 sends the group flag field GROUP_FLAG, an identifier M_UE_ID1 of the first terminal M_UE1, and the identifier S_UE_ID of the second terminal S_UE to the IDM entity; and a first terminal M_UE2 sends the group flag field GROUP_FLAG, an identifier M_UE_ID2 of the first terminal M_UE2, and the identifier S_UE_ID of the second terminal S_UE to the IDM entity.

S43. The IDM entity generates a group identifier.

In this embodiment, the IDM entity confirms information such as a group, a group member, and a relationship between nodes in the group, and the IDM entity generates the group identifier GROUP_ID. Then, the IDM entity determines group information, where the group information includes the group identifier GROUP_ID, the identifier M_UE_ID of each first terminal M_UE, and the identifier S_UE_ID of the second terminal SUE.

S44. The IDM entity sends the group identifier and the identifier of the second terminal to the first terminal.

In this embodiment, the IDM entity sends the group identifier GROUP_ID, the identifier M_UE_ID of the first terminal M_UE, and the identifier S_UE_ID of the second terminal S_UE to the first terminal M_UE.

For example, the IDM entity sends GROUP_ID, M_UE_ID1, and S_UE_ID to the first terminal M_UE1; and the IDM entity sends GROUP_ID, M_UE_ID2, and S_UE_ID to the first terminal M_UE2.

S45. The IDM entity sends the generated group information to the IKMS entity.

In this embodiment, the IDM entity sends the determined group information to the IKMS entity. A sequence of step S4 and step S45 is not limited.

S46. Each first terminal sends a group joining response message to the second terminal based on the identifier of the second terminal, where the group joining response message includes the group identifier.

In this embodiment, each first terminal M_UE sends the group joining response message to the second terminal S_UE, where the group joining response message includes the group identifier GROUP_ID and the identifier S_UE_ID of the second terminal S_UE. The group identifiers GROUP_ID in the group joining response messages sent by the first terminals M_UE may be the same, indicating that all the first terminals M_UE and the second terminal S_UE are in a same group. Alternatively, the group identifiers GROUP_ID in the group joining response messages sent by the first terminals M_UE may be different, indicating that different first terminals M_UE are in different groups but the second terminal S_UE may be in these groups.

In this embodiment, the first terminal receives the group joining request sent by the second terminal, where the group joining request includes the group flag field and the identifier of the second terminal, and the group flag field represents the relationship between the first terminal and the second terminal; the first terminal sends the group flag field, the identifier of the first terminal, and the identifier of the second terminal to the IDM entity, where the group flag field, the identifier of the first terminal, and the identifier of the second terminal are used to determine the group identifier; the first terminal receives the group identifier and the identifier of the second terminal that are sent by the IDM entity; and the first terminal sends the group joining response message to the second terminal based on the identifier of the second terminal, where the group joining response message includes the group identifier. Then, the second terminal triggers group creation, the first terminal sends information such as the group flag field to the IDM entity, and the first terminal determines whether a group is to be created. In this way, the first terminal and the second terminal are trustworthy to each other, thereby improving a trust degree and security of the network elements in the group. In addition, characteristics of the group that can be created based on a group creation request proactively sent by the second terminal are diversified.

FIG. 12 is a schematic flowchart of another private key generation method according to an embodiment. As shown in FIG. 12, the method is as follows.

201. A first terminal receives a group joining request sent by a second terminal, where the group joining request includes a group flag field and an identifier of the second terminal, and the group flag field represents a relationship between the first terminal and the second terminal.

In one embodiment, the group flag field represents that the first terminal is a master node, and the second terminal is a master node; or the group flag field represents that the first terminal is a master node, and the second terminal is a slave node.

In this embodiment, for this step, refer to step 101 in FIG. 7. Details are not described again.

202. The first terminal sends the group flag field, an identifier of the first terminal, and the identifier of the second terminal to an IDM entity, where the group flag field, the identifier of the first terminal, and the identifier of the second terminal are used to determine a group identifier.

In this embodiment, for this step, refer to step 102 in FIG. 7. Details are not described again.

203. The first terminal receives the group identifier and the identifier of the second terminal that are sent by the IDM entity.

In this embodiment, for this step, refer to step 103 in FIG. 7. Details are not described again.

204. The first terminal sends a group joining response message to the second terminal based on the identifier of the second terminal, where the group joining response message includes the group identifier.

In this embodiment, for this step, refer to step 104 in FIG. 7. Details are not described again.

205. The first terminal receives, from the second terminal, a first half session key parameter corresponding to the second terminal and the identifier of the second terminal, where the first half session key parameter corresponding to the second terminal and the identifier of the second terminal are used to generate an encrypted private key corresponding to the second terminal.

In this embodiment, after a group is created, the second terminal sends parameters for obtaining a private key to the first terminal. Specifically, the second terminal sends the first half session key parameter XA corresponding to the second terminal and the identifier of the second terminal to the first terminal, where the first half session key parameter XA is used for session key negotiation.

206. The first terminal sends the first half session key parameter corresponding to the second terminal and the identifier of the second terminal to an IKMS entity.

In this embodiment, the first terminal sends the first half session key parameter XA corresponding to the second terminal and the identifier of the second terminal to the IKMS entity.

207. The IKMS entity generates a second half session key parameter corresponding to the second terminal, and generates the encrypted private key corresponding to the second terminal based on the identifier of the second terminal, the first half session key parameter corresponding to the second terminal, and the second half session key parameter corresponding to the second terminal, where the second half session key parameter corresponding to the second terminal is used to decrypt the encrypted private key corresponding to the second terminal.

In one embodiment, step 207 includes: The IKMS entity generates the private key corresponding to the second terminal based on the identifier of the second terminal; the IKMS entity generates the second half session key parameter corresponding to the second terminal, and generates a symmetric key corresponding to the second terminal based on the first half session key parameter corresponding to the second terminal and the second half session key parameter corresponding to the second terminal; and the IKMS entity encrypts the private key corresponding to the second terminal based on the symmetric key corresponding to the second terminal, to generate the encrypted private key corresponding to the second terminal, where the second half session key parameter corresponding to the second terminal is used to decrypt the encrypted private key corresponding to the second terminal.

In this embodiment, according to an IBS technology and by using the identifier of the second terminal as a public key, the IKMS entity generates a private key SK corresponding to the identifier of the second terminal, where the private key SK is the private key corresponding to the second terminal. Then, the IKMS entity generates the second half session key parameter XB, and the IKMS entity generates the symmetric key key corresponding to the second terminal based on the received first half session key parameter XA corresponding to the second terminal and the second half session key parameter XB, where the symmetric key key is a symmetric key for the IKMS entity and the second terminal. Next, the IKMS entity encrypts the private key SK corresponding to the second terminal by using the symmetric key key corresponding to the second terminal, to generate the encrypted private key (SK)_{key} corresponding to the second terminal.

208. The first terminal receives, from the IKMS entity, the second half session key parameter corresponding to the second terminal, the identifier of the second terminal, and the encrypted private key corresponding to the second terminal.

In one embodiment, after step 208, the first terminal receives, from the IKMS entity, the second half session key parameter XB corresponding to the second terminal, the identifier of the second terminal, and the encrypted private key (SK)_{key} corresponding to the second terminal.

209. The first terminal sends the second half session key parameter corresponding to the second terminal and the encrypted private key corresponding to the second terminal to the second terminal.

In this embodiment, the first terminal sends the second half session key parameter XB corresponding to the second terminal, the identifier of the second terminal, and the encrypted private key (SK)_{key} corresponding to the second terminal to the second terminal. Then, the second terminal may decrypt the encrypted private key (SK)_{key} corresponding to the second terminal, to obtain the private key SK corresponding to the second terminal.

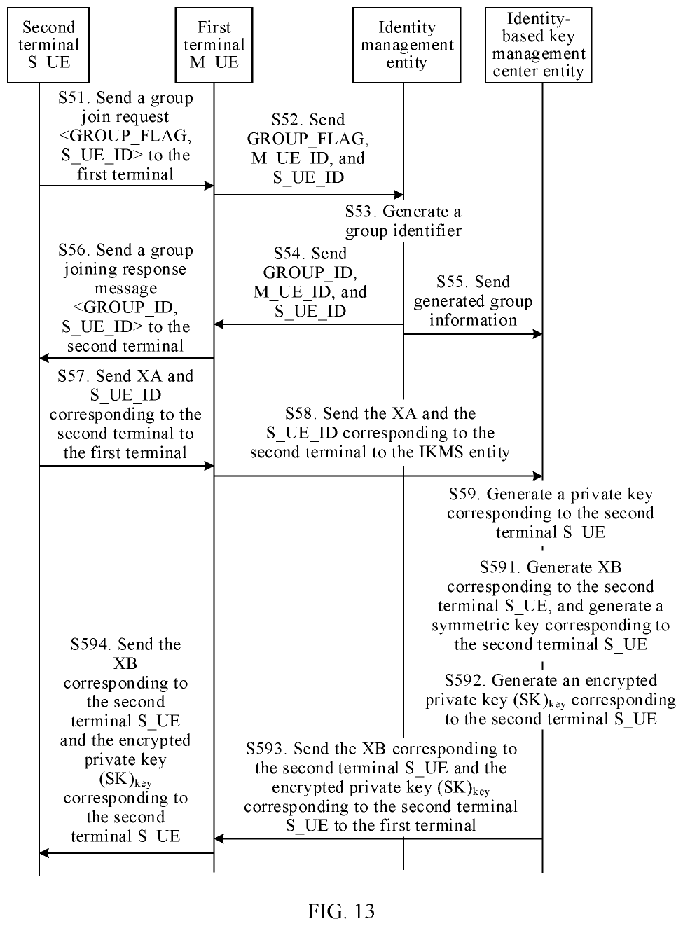

FIG. 13 is a schematic communication diagram 1 of another private key generation method according to an embodiment. FIG. 13 is a schematic communication diagram of private key generation performed between one second terminal and one first terminal. The method is as follows.

S51. The second terminal sends a group joining request to the first terminal, where the group joining request includes a group flag field and an identifier of the second terminal, and the group flag field represents a relationship between the first terminal and the second terminal.

In this embodiment, for this step, refer to step S11 in FIG. 8. Details are not described again. The first terminal M_UE is a master node, and the second terminal S_UE is a slave node.

S52. The first terminal sends the group flag field, an identifier of the first terminal, and the identifier of the second terminal to an IDM entity, where the group flag field, the identifier of the first terminal, and the identifier of the second terminal are used to determine a group identifier.

In this embodiment, for this step, refer to step S12 in FIG. 8. Details are not described again.

S53. The IDM entity generates the group identifier.

In this embodiment, for this step, refer to step S13 in FIG. 8. Details are not described again.

S54. The IDM entity sends the group identifier and the identifier of the second terminal to the first terminal.

In this embodiment, for this step, refer to step S14 in FIG. 8. Details are not described again.

S55. The IDM entity sends generated group information to an IKMS entity.

In this embodiment, for this step, refer to step S15 in FIG. 8. Details are not described again.

S56. The first terminal sends a group joining response message to the second terminal based on the identifier of the second terminal, where the group joining response message includes the group identifier.

In this embodiment, for this step, refer to step S16 in FIG. 8. Details are not described again.

S57. The second terminal sends a first half session key parameter corresponding to the second terminal and the identifier of the second terminal to the first terminal, where the first half session key parameter corresponding to the second terminal and the identifier of the second terminal are used to generate an encrypted private key corresponding to the second terminal.

In this embodiment, after a group is created, the second terminal S_UE sends the first half session key parameter XA corresponding to the second terminal S_UE and the identifier S_UE_ID of the second terminal to the first terminal M_UE, where the first half session key parameter XA is used for session key negotiation.

S58. The first terminal sends the first half session key parameter corresponding to the second terminal and the identifier of the second terminal to the IKMS entity.

In this embodiment, the first terminal M_UE sends the first half session key parameter XA corresponding to the second terminal S_UE and the identifier S_UE_ID of the second terminal to the IKMS entity.

S59. The IKMS entity generates a private key corresponding to the second terminal based on the identifier of the second terminal.

In this embodiment, according to an IBS technology and by using the identifier S_UE_ID of the second terminal as a public key, the IKMS entity generates a private key SK corresponding to the identifier S_UE_ID of the second terminal, where the private key SK is the private key corresponding to the second terminal SUE.

S591. The IKMS entity generates a second half session key parameter corresponding to the second terminal, and generates a symmetric key corresponding to the second terminal based on the first half session key parameter corresponding to the second terminal and the second half session key parameter corresponding to the second terminal.

In this embodiment, the IKMS entity generates the second half session key parameter XB corresponding to the second terminal S_UE, and the IKMS entity generates the symmetric key key corresponding to the second terminal S_UE based on the received first half session key parameter XA corresponding to the second terminal S_UE and the second half session key parameter XB corresponding to the second terminal S_UE, where the symmetric key key is a symmetric key for the IKMS entity and the second terminal SUE.

S592. The IKMS entity encrypts the private key corresponding to the second terminal based on the symmetric key corresponding to the second terminal, to generate the encrypted private key corresponding to the second terminal, where the second half session key parameter corresponding to the second terminal is used to decrypt the encrypted private key corresponding to the second terminal.

In this embodiment, the IKMS entity encrypts the private key SK corresponding to the second terminal S_UE based on the symmetric key key corresponding to the second terminal S_UE, to generate the encrypted private key (SK)_{key} corresponding to the second terminal SUE.

S593. The IKMS entity sends the second half session key parameter corresponding to the second terminal, the identifier of the second terminal, and the encrypted private key corresponding to the second terminal to the first terminal, where the second half session key parameter corresponding to the second terminal is used to decrypt the encrypted private key corresponding to the second terminal.

In one embodiment, after step 208, the first terminal M_UE receives, from the IKMS entity, the second half session key parameter XB corresponding to the second terminal S_UE, the identifier S_UE_ID of the second terminal, and the encrypted private key (SK)_{key} corresponding to the second terminal S_UE.

S594. The first terminal sends the second half session key parameter corresponding to the second terminal and the encrypted private key corresponding to the second terminal to the second terminal.

In this embodiment, the first terminal M_UE sends the second half session key parameter XB corresponding to the second terminal S_UE and the encrypted private key (SK)_{key} corresponding to the second terminal S_UE to the second terminal S_UE. Then, the second terminal S_UE decrypts the encrypted private key (SK)_{key} corresponding to the second terminal S_UE, to obtain the private key SK corresponding to the second terminal SUE.

After a group is created for one second terminal and at least two first terminals, private key obtaining may be completed according to step S57 to step S594.

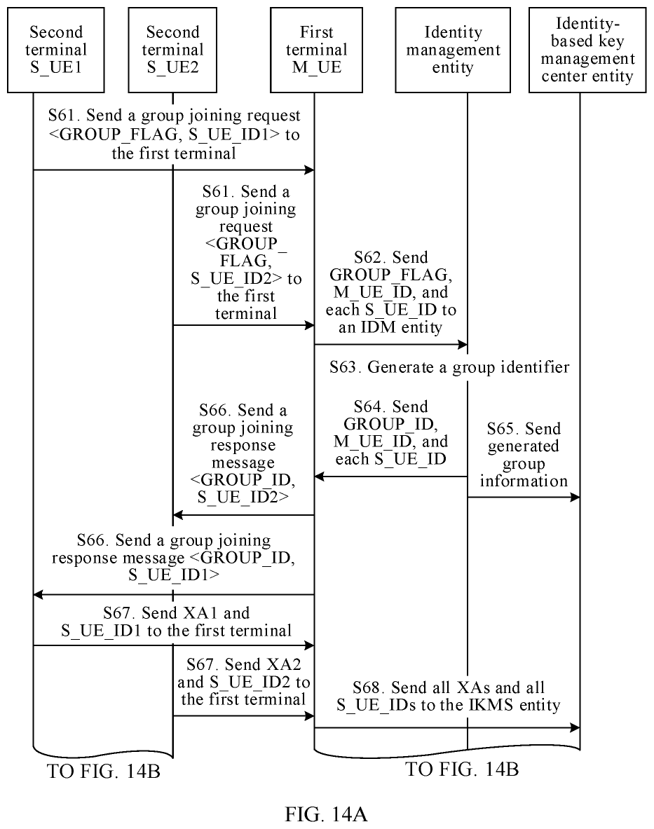

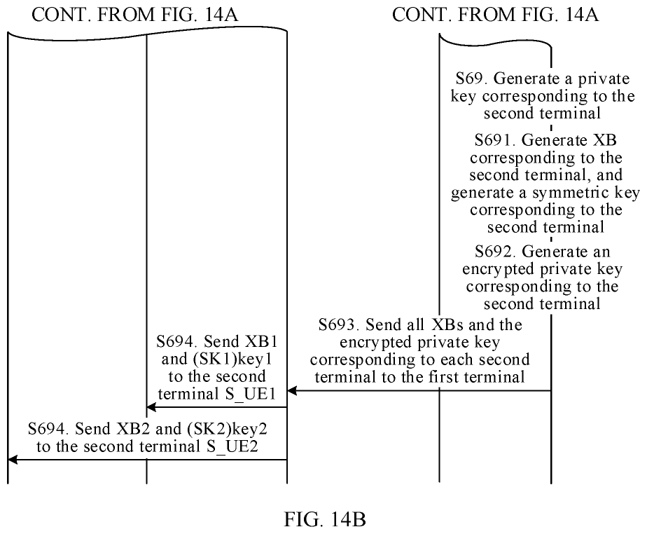

FIG. 14A and FIG. 14B are a schematic communication diagram 2 of another private key generation method according to an embodiment. FIG. 14A and FIG. 14B is a schematic communication diagram of private key generation performed between at least two second terminals and one first terminal. The method is as follows.

S61. Each second terminal sends a group joining request to the first terminal, where the group joining request includes a group flag field and an identifier of the second terminal, and the group flag field represents a relationship between the first terminal and the second terminal.

In this embodiment, the first terminal M_UE is a master node, and the second terminal S_UE is a slave node. For this step, refer to step S31 in FIG. 10. Details are not described again.

S62. The first terminal sends the group flag field, an identifier of the first terminal, and the identifier of each second terminal to an IDM entity.

In this embodiment, for this step, refer to step S32 in FIG. 10. Details are not described again.

S63. The IDM entity generates a group identifier.

In this embodiment, for this step, refer to step S33 in FIG. 10. Details are not described again.

S64. The IDM entity sends the group identifier and the identifier of the second terminal to the first terminal.

In this embodiment, for this step, refer to step S34 in FIG. 10. Details are not described again.

S65. The IDM entity sends generated group information to an IKMS entity.

In this embodiment, for this step, refer to step S35 in FIG. 10. Details are not described again.

S66. The first terminal sends a group joining response message to each second terminal, where the group joining response message includes the group identifier.

In this embodiment, for this step, refer to step S36 in FIG. 10. Details are not described again.

S67. Each second terminal sends a first half session key parameter corresponding to the second terminal and the identifier of the second terminal to the first terminal.

In this embodiment, after a group is created, each second terminal S_UE sends the first half session key parameter XA corresponding to the second terminal S_UE and the identifier S_UE_ID of the second terminal to the first terminal M_UE, where the first half session key parameter XA is used for session key negotiation.

For example, a second terminal S_UE1 sends a first half session key parameter XA1 corresponding to the second terminal S_UE1 and an identifier S_UE_ID1 of the second terminal S_UE1 to the first terminal M_UE; and a second terminal S_UE2 sends a first half session key parameter XA2 corresponding to the second terminal S_UE2 and an identifier S_UE_ID2 of the second terminal S_UE2 to the first terminal M_UE.

S68. The first terminal sends the first half session key parameter corresponding to each second terminal and the identifier of the second terminal to the IKMS entity.

In this embodiment, the first terminal M_UE adds first half session key parameters and identifiers of all second terminals S_UE to one message, and then the first terminal M_UE sends the first half session key parameter XA corresponding to each second terminal and the identifier S_UE_ID of the second terminal to the IKMS entity.

For example, the first terminal M_UE adds, to one message, the first half session key parameter XA1 corresponding to the second terminal S_UE1, the identifier S_UE_ID1 of the second terminal S_UE1, the first half session key parameter XA2 corresponding to the second terminal S_UE2, and the identifier S_UE_ID2 of the second terminal S_UE2; and then sends the message to the IKMS entity.

S69. The IKMS entity generates a private key corresponding to each second terminal based on the identifier of the second terminal.

S691. The IKMS entity generates a second half session key parameter corresponding to each second terminal, and generates a symmetric key corresponding to the second terminal based on the first half session key parameter corresponding to the second terminal and the second half session key parameter corresponding to the second terminal.

S692. The IKMS entity encrypts the private key corresponding to each second terminal based on the symmetric key corresponding to the second terminal, to generate an encrypted private key corresponding to the second terminal.

In this embodiment, for each second terminal S_UE, the IKMS entity performs S69, S691, and S692 to obtain the encrypted private key (SK)_{key} corresponding to the second terminal.

For example, according to an IBS technology, the IKMS entity generates a private key SK1 corresponding to the second terminal S_UE1 based on the identifier S_UE_ID1 of the second terminal S_UE1, and generates a private key SK2 corresponding to the second terminal S_UE2 based on the identifier S_UE_ID2 of the second terminal S_UE2. Then, the IKMS entity generates a second half session key parameter XB1 corresponding to the second terminal S_UE1, and generates a symmetric key key1 corresponding to the second terminal S_UE1 based on the received first half session key parameter XA1 corresponding to the second terminal S_UE1 and XB1. Next, the IKMS entity encrypts the private key SK2 corresponding to the second terminal S_UE1 based on the symmetric key key1 corresponding to the second terminal S_UE1, to generate an encrypted private key (SK1)_{key1} corresponding to the second terminal S_UE1. In addition, the IKMS entity generates a second half session key parameter XB2 corresponding to the second terminal S_UE2, and generates a symmetric key key2 corresponding to the second terminal S_UE2 based on the received first half session key parameter XA2 corresponding to the second terminal S_UE2 and XB2. Next, the IKMS entity encrypts the private key SK2 corresponding to the second terminal S_UE2 based on the symmetric key key2 corresponding to the second terminal S_UE2, to generate an encrypted private key (SK2)_{key2} corresponding to the second terminal S_UE2.

S693. The IKMS entity sends the second half session key parameter corresponding to each second terminal, the identifier of the second terminal, and the encrypted private key corresponding to the second terminal to the first terminal.

In one embodiment, the IKMS entity adds, to one message, the second half session key parameter XB corresponding to each second terminal S_UE, the identifier S_UE_ID of the second terminal, and the encrypted private key SK corresponding to the second terminal S_UE, and then sends the message to the first terminal. The first terminal M_UE receives, from the IKMS entity, the second half session key parameter XB corresponding to each second terminal S_UE, the identifier S_UE_ID of the second terminal, and the encrypted private key (SK)_{key} corresponding to the second terminal SUE.

For example, the IKMS entity sends XB1, S_UE_ID1, (SK1)_{key1}, XB2, S_UE_ID2, and (SK2)_{key2} to the first terminal M_UE.

S694. The first terminal sends the second half session key parameter corresponding to the second terminal and the encrypted private key corresponding to the second terminal to the second terminal.

In this embodiment, the first terminal M_UE sends the second half session key parameter XB corresponding to the second terminal S_UE and the encrypted private key SK corresponding to the second terminal S_UE to the second terminal S_UE. In other words, the first terminal M_UE sends the second half session key parameter and the private key to the corresponding second terminal SUE.

For example, the first terminal M_UE sends XB1 and (SK1)_{key1} to the corresponding second terminal S_UE1 based on S_UE_ID1, and the first terminal M_UE sends XB2 and (SK2)_{key2} to the corresponding second terminal S_UE2 based on S_UE_ID2.

Then, each second terminal S_UE decrypts the encrypted private key SK corresponding to the second terminal S_UE, to obtain the private key SK corresponding to the second terminal SUE. For example, the second terminal S_UE1 decrypts (SK1)_{key1}, to obtain the private key SK1 corresponding to the second terminal S_UE1; and the second terminal S_UE2 decrypts (SK2)_{key2}, to obtain the private key SK2 corresponding to the second terminal S_UE2.

In this embodiment, after a group is created, the first terminal receives, from the second terminal, the first half session key parameter corresponding to the second terminal and the identifier of the second terminal, where the first half session key parameter corresponding to the second terminal and the identifier of the second terminal are used to generate the encrypted private key corresponding to the second terminal; the first terminal sends the first half session key parameter corresponding to the second terminal and the identifier of the second terminal to the IKMS entity; the IKMS entity generates the private key corresponding to the second terminal based on the identifier of the second terminal; the IKMS entity generates the second half session key parameter corresponding to the second terminal, and generates the symmetric key corresponding to the second terminal based on the first half session key parameter corresponding to the second terminal and the second half session key parameter corresponding to the second terminal; the IKMS entity encrypts the private key corresponding to the second terminal based on the symmetric key corresponding to the second terminal, to generate the encrypted private key corresponding to the second terminal; the IKMS entity sends the second half session key parameter corresponding to the second terminal, the identifier of the second terminal, and the encrypted private key corresponding to the second terminal to the first terminal, where the second half session key parameter corresponding to the second terminal is used to decrypt the encrypted private key corresponding to the second terminal; and then the first terminal sends the second half session key parameter corresponding to the second terminal and the encrypted private key corresponding to the second terminal to the second terminal. In this way, a private key obtaining method is provided. After a group is created for terminals, the second terminal initiates a private key obtaining request, the IKMS entity generates the encrypted private key corresponding to the second terminal, and the second terminal receives, by using the first terminal, the encrypted private key corresponding to the second terminal sent by the IKMS entity. Therefore, the second terminal can relatively quickly obtain the encrypted private key corresponding to the second terminal. This can prevent the private key from being stolen, and prevent communication information between groups from being stolen.

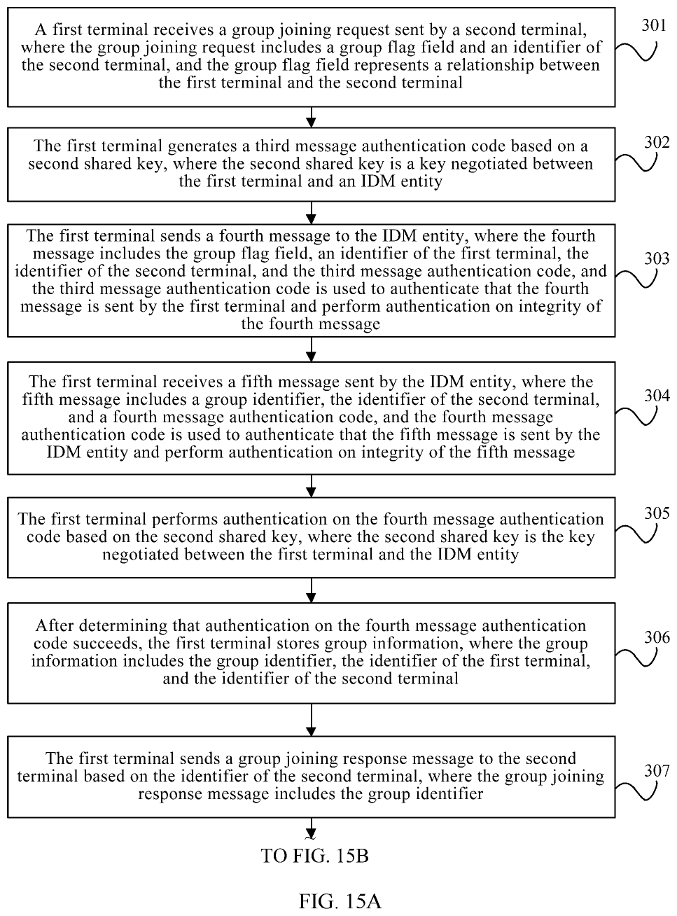

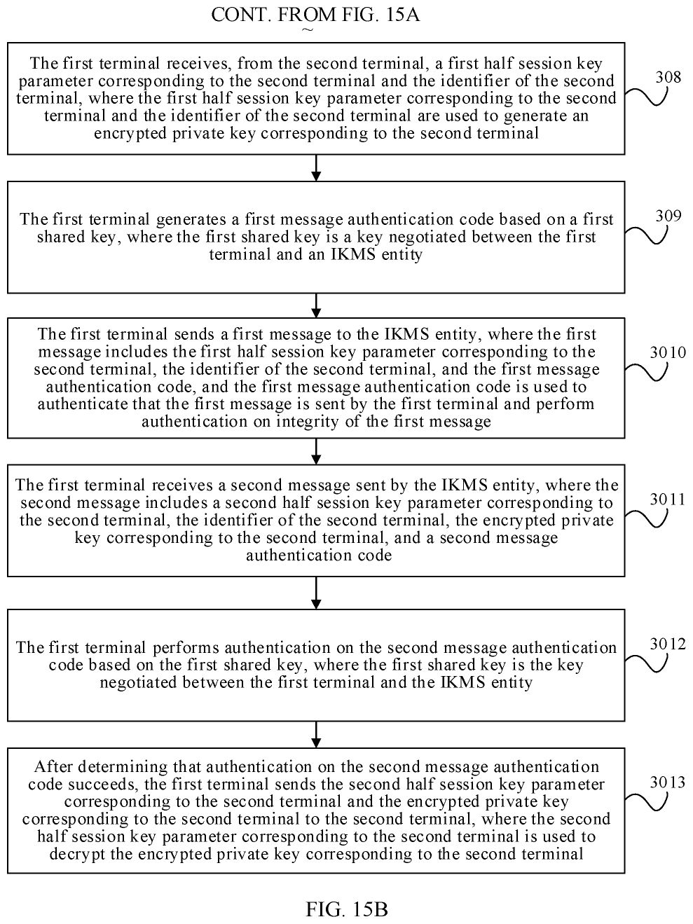

FIG. 15A and FIG. 15B are a schematic flowchart of still another private key generation method according to an embodiment. As shown in FIG. 15A and FIG. 15B, the method is as follows.

301. A first terminal receives a group joining request sent by a second terminal, where the group joining request includes a group flag field and an identifier of the second terminal, and the group flag field represents a relationship between the first terminal and the second terminal.

302. The first terminal generates a third message authentication code based on a second shared key, where the second shared key is a key negotiated between the first terminal and an IDM entity.

In one embodiment, the second shared key includes a third key for generating the message authentication code and a fourth key for data encryption.

303. The first terminal sends a fourth message to the IDM entity, where the fourth message includes the group flag field, an identifier of the first terminal, the identifier of the second terminal, and the third message authentication code, and the third message authentication code is used to authenticate that the fourth message is sent by the first terminal and perform authentication on integrity of the fourth message.

304. The first terminal receives a fifth message sent by the IDM entity, where the fifth message includes a group identifier, the identifier of the second terminal, and a fourth message authentication code, and the fourth message authentication code is used to authenticate that the fifth message is sent by the IDM entity and perform authentication on integrity of the fifth message.

305. The first terminal performs authentication on the fourth message authentication code based on the second shared key, where the second shared key is the key negotiated between the first terminal and the IDM entity.

306. After determining that authentication on the fourth message authentication code succeeds, the first terminal stores group information, where the group information includes the group identifier, the identifier of the first terminal, and the identifier of the second terminal.

307. The first terminal sends a group joining response message to the second terminal based on the identifier of the second terminal, where the group joining response message includes the group identifier.

308. The first terminal receives, from the second terminal, a first half session key parameter corresponding to the second terminal and the identifier of the second terminal, where the first half session key parameter corresponding to the second terminal and the identifier of the second terminal are used to generate an encrypted private key corresponding to the second terminal.

309. The first terminal generates a first message authentication code based on a first shared key, where the first shared key is a key negotiated between the first terminal and an IKMS entity.

In one embodiment, the first shared key includes a first key for generating the message authentication code and a second key for data encryption.

3010. The first terminal sends a first message to the IKMS entity, where the first message includes the first half session key parameter corresponding to the second terminal, the identifier of the second terminal, and the first message authentication code, and the first message authentication code is used to authenticate that the first message is sent by the first terminal and perform authentication on integrity of the first message.

3011. The first terminal receives a second message sent by the IKMS entity, where the second message includes a second half session key parameter corresponding to the second terminal, the identifier of the second terminal, the encrypted private key corresponding to the second terminal, and a second message authentication code, and the second message authentication code is used to authenticate that the second message is sent by the IKMS entity and perform authentication on integrity of the second message.

3012. The first terminal performs authentication on the second message authentication code based on the first shared key, where the first shared key is the key negotiated between the first terminal and the IKMS entity.

3013. After determining that authentication on the second message authentication code succeeds, the first terminal sends the second half session key parameter corresponding to the second terminal and the encrypted private key corresponding to the second terminal to the second terminal, where the second half session key parameter corresponding to the second terminal is used to decrypt the encrypted private key corresponding to the second terminal.

The following uses schematic communication diagrams to describe the method in FIG. 15A and FIG. 15B.

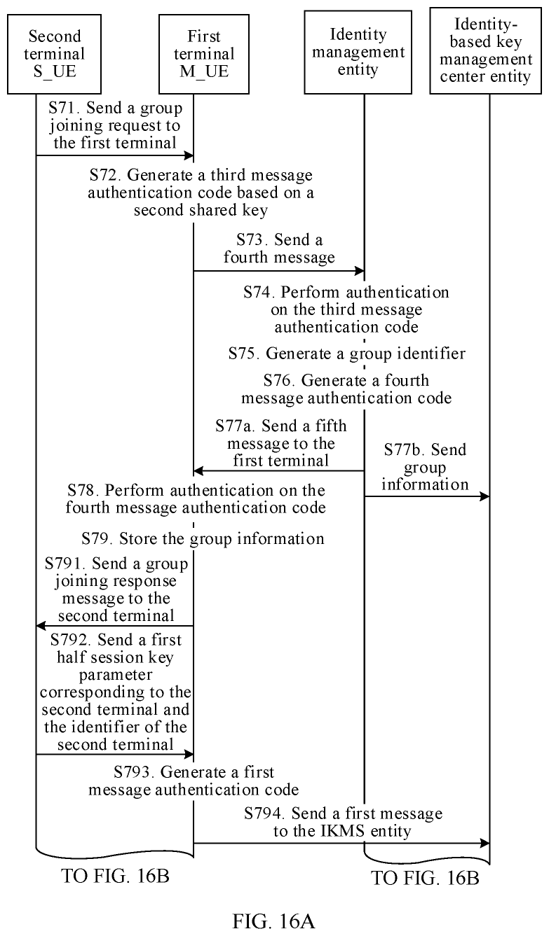

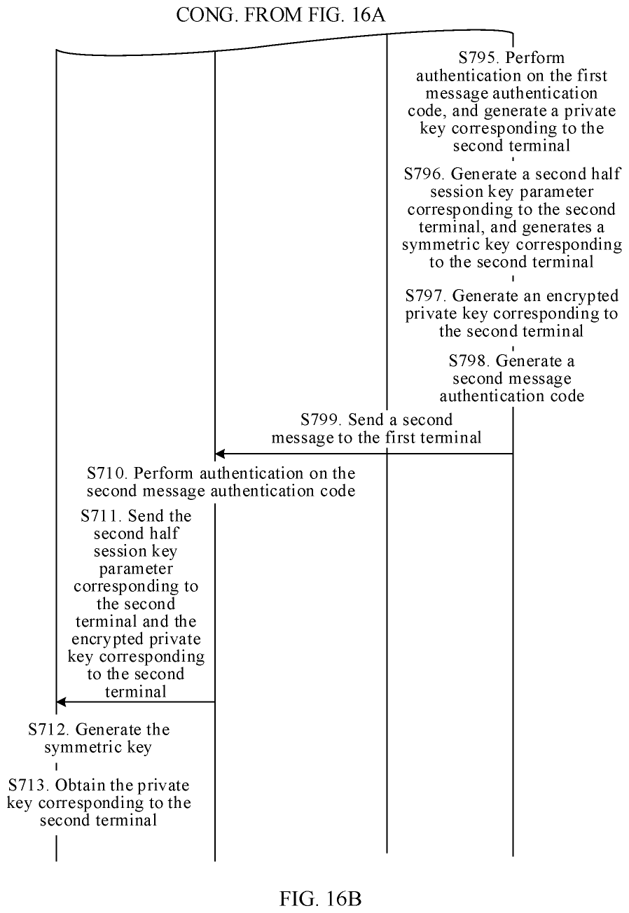

FIG. 16A and FIG. 16B is a schematic communication diagram of still another private key generation method according to an embodiment. FIG. 16A and FIG. 16B are a schematic communication diagram of private key generation performed between one second terminal and one first terminal. The method is as follows.

S71. The second terminal sends a group joining request to the first terminal, where the group joining request includes a group flag field and an identifier of the second terminal, and the group flag field represents a relationship between the first terminal and the second terminal.

In this embodiment, before step S71, through initiation, the first terminal M_UE and the second terminal S_UE can access a control plane, and the first terminal M_UE has negotiated a second shared key K_{IDM_M} and a first shared key K_{IKMS_M} with network elements such as an IDM entity and an IKMS entity, respectively. Specifically, the first terminal M_UE has negotiated the second shared key K_{IDM_M} with the IDM entity by using an HSS/AAA entity, and the first terminal M_UE has negotiated the first shared key K_{IKMS_M} with the IKMS entity by using the HSS/AAA entity.

The second terminal S_UE and the first terminal M_UE establish a secure channel, and the second terminal S_UE sends a group joining request bonding_request to the first terminal M_UE through the secure channel. The group joining request bonding_request includes the group flag field GROUP_FLAG and the identifier S_UE_ID of the second terminal, and the group flag field GROUP_FLAG represents that the first terminal M_UE and the second terminal S_UE are in a master-slave relationship. In other words, the first terminal M_UE is a master node, and the second terminal S_UE is a slave node. For example, message content of the group joining request bonding_request is <GROUP_FLAG, S_UE_ID>, and S_UE_ID is the ID of the second terminal SUE.

S72. The first terminal generates a third message authentication code based on the second shared key, where the second shared key is a key negotiated between the first terminal and the IDM entity.

In one embodiment, the second shared key includes a third key for generating the message authentication code and a fourth key for data encryption.

In this embodiment, the first terminal M_UE updates information required for group creation; and then the first terminal M_UE performs signature processing on a fourth message by using the second shared key K_{IDM_M}. In this case, the fourth message includes the group flag field GROUP_FLAG, an identifier M_UE_ID of the first terminal, the identifier S_UE_ID of the second terminal, and the generated third message authentication code MAC1. It can be learnt that the third message authentication code MAC1 is a message authentication code that is generated by the first terminal M_UE for the entire fourth message based on the symmetric key K_{IDM_M} for the first terminal M_UE and the IDM entity.

S73. The first terminal sends the fourth message to the IDM entity, where the fourth message includes the group flag field, the identifier of the first terminal, the identifier of the second terminal, and the third message authentication code, and the third message authentication code is used to authenticate that the fourth message is sent by the first terminal and perform authentication on integrity of the fourth message.

In this embodiment, the first terminal M_UE sends the fourth message to the IDM entity. It can be learnt that message content of the fourth message includes at least the group flag field GROUP_FLAG, the identifier M_UE_ID of the first terminal, the identifier S_UE_ID of the second terminal, and the third message authentication code MAC1, and the relationship between the first terminal M_UE and the second terminal S_UE is a master-slave relationship. For example, the message content of the fourth message is <GROUP_FLAG, M_UE_ID, S_UE_ID, MAC1, . . . >.

S74. The IDM entity performs authentication on the third message authentication code based on the second shared key, where the second shared key is the key negotiated between the first terminal and the IDM entity.

In this embodiment, after receiving the fourth message, the IDM entity performs authentication on the third message authentication code MAC1. Specifically, because the IDM entity has negotiated the second shared key K_{IDM_M} with the first terminal M_UE, the IDM entity may perform authentication on the third message authentication code MAC1 based on the second shared key K_{IDM_M} stored in the IDM entity.

S75. After determining that authentication on the third message authentication code succeeds, the IDM entity generates a group identifier.

In this embodiment, after determining that authentication on the third message authentication code MAC1 succeeds, the IDM entity generates the group identifier GROUP_ID for the first terminal M-UE and the second terminal SUE. In addition, the IDM entity stores group information, where the group information includes the group flag field GROUP_FLAG, the identifier M_UE_ID of the first terminal, the identifier S_UE_ID of the second terminal, and the group identifier GROUP_ID.

S76. The IDM entity generates a fourth message authentication code based on the second shared key, where the second shared key is the key negotiated between the first terminal and the IDM entity.

In this embodiment, the IDM entity signs a fifth message by using the second shared key K_{IDM_M}. The fifth message includes the group identifier GROUP_ID, the identifier M_UE_ID of the first terminal, the identifier S_UE_ID of the second terminal, and the generated fourth message authentication code MAC2. It can be learnt that the fourth message authentication code MAC2 is a message authentication code that is generated by the first terminal M_UE for the entire fifth message based on the symmetric key K_{IDM_M} for the first terminal M_UE and the IDM entity.

S77a. The IDM entity sends the fifth message to the first terminal, where the fifth message includes the group identifier, the identifier of the second terminal, and the fourth message authentication code, and the fourth message authentication code is used to authenticate that the fifth message is sent by the IDM entity and perform authentication on integrity of the fifth message.

S77b. The IDM entity sends the group information to the IKMS entity, where the group information includes the group identifier, the identifier of the first terminal, and the identifier of the second terminal.

In this embodiment, the IDM entity sends the fifth message to the first terminal. In this case, the fifth message includes at least the group identifier GROUP_ID, the identifier M_UE_ID of the first terminal, the identifier S_UE_ID of the second terminal, and the fourth message authentication code MAC2. For example, message content of the fifth message is <GROUP_ID, M_UE_ID, S_UE_ID, MAC2, . . . >.

In addition, the IDM entity sends the generated group information to the IKMS entity, where the group information includes the group flag field GROUP_FLAG, the identifier M_UE_ID of the first terminal, the identifier S_UE_ID of the second terminal, and the group identifier GROUP_ID.

A sequence of the step of sending, by the IDM entity, the fifth message to the first terminal and the step of sending, by the IDM entity, the generated group information to the IKMS entity is not limited.

S78. The first terminal performs authentication on the fourth message authentication code based on the second shared key, where the second shared key is the key negotiated between the first terminal and the IDM entity.

In this embodiment, after receiving the fifth message, the first terminal M_UE first needs to perform authentication on the fourth message authentication code MAC2. Specifically, because the DM entity has negotiated the second shared key K_{IDM_M} with the first terminal M-UE, the first terminal M-UE may perform authentication on the fourth message authentication code MAC2 based on the second shared key K_{IDM_M} stored in the first terminal M-UE.

S79. After determining that authentication on the fourth message authentication code succeeds, the first terminal stores the group information, where the group information includes the group identifier, the identifier of the first terminal, and the identifier of the second terminal.

In this embodiment, after determining that authentication on the fourth message authentication code MAC2 succeeds, the first terminal M-UE may store the group information.

S791. The first terminal sends a group joining response message to the second terminal based on the identifier of the second terminal, where the group joining response message includes the group identifier.

In this embodiment, the first terminal M-UE sends the group joining response message bonding_acknowledge to the second terminal S_UE through the secure channel, where the group joining response message bonding_acknowledge includes the group identifier GROUP_ID; and then notifies the second terminal S_UE that group creation succeeds.

Step S71 to step S791 are a process in which one second terminal S_UE and one first terminal M-UE complete group creation.

S792. The second terminal sends a first half session key parameter corresponding to the second terminal and the identifier of the second terminal to the first terminal, where the first half session key parameter corresponding to the second terminal and the identifier of the second terminal are used to generate an encrypted private key corresponding to the second terminal.

In this embodiment, after the second terminal S_UE and the first terminal M-UE complete group creation, private key obtaining may be performed. A private key obtaining process is based on an improved D-H key negotiation protocol.

The second terminal S_UE first sends the first half session key parameter XA corresponding to the second terminal S_UE and the identifier S_UE_ID of the second terminal to the first terminal M_UE, where the first half session key parameter XA is used for session key negotiation.

S793. The first terminal generates a first message authentication code based on the first shared key, where the first shared key is a key negotiated between the first terminal and the IKMS entity.

In one embodiment, the first shared key includes a first key for generating the message authentication code and a second key for data encryption.

In this embodiment, after receiving the first half session key parameter XA corresponding to the second terminal S_UE and the identifier S_UE_ID of the second terminal, the first terminal M_UE signs a first message by using the first shared key K_{IKMS_M} negotiated between the first terminal M_UE and the IKMS entity. In this case, the first message includes the first half session key parameter XA corresponding to the second terminal S_UE, the identifier S_UE_ID of the second terminal, and the generated first message authentication code MAC3.

S794. The first terminal sends the first message to the IKMS entity, where the first message includes the first half session key parameter corresponding to the second terminal, the identifier of the second terminal, and the first message authentication code, and the first message authentication code is used to authenticate that the first message is sent by the first terminal and perform authentication on integrity of the first message.

In this embodiment, the first terminal M_UE sends a signed first message to the IKMS entity. In this case, the first message includes the first half session key parameter XA corresponding to the second terminal S_UE, the identifier S_UE_ID of the second terminal, and the first message authentication code MAC3. For example, message content of the first message is <XA, S_UE_ID, MAC3>.

S795. The IKMS entity performs authentication on the first message authentication code based on the first shared key, where the first shared key is the key negotiated between the first terminal and the IKMS entity; and after determining that authentication on the first message authentication code succeeds, the IKMS entity generates a private key corresponding to the second terminal based on the identifier of the second terminal.

In this embodiment, after receiving the first message sent by the first terminal M_UE, the IKMS entity first performs authentication on the first message authentication code MAC3. Specifically, because the first terminal M_UE has negotiated the first shared key K_{IKMS_M} with the IKMS entity, the IKMS entity may perform authentication on the first message authentication code MAC3 based on the first shared key K_{IKMS_M}.

After determining that authentication on the first message authentication code MAC3 succeeds, according to an IBS technology and by using the identifier S_UE_ID of the second terminal as a public key, the IKMS entity generates a private key SK for the identifier S_UE_ID of the second terminal. In other words, the private key SK is the private key SK corresponding to the second terminal S_UE.

S796. The IKMS entity generates a second half session key parameter corresponding to the second terminal, and generates a symmetric key corresponding to the second terminal based on the first half session key parameter corresponding to the second terminal and the second half session key parameter corresponding to the second terminal.

In this embodiment, the IKMS entity generates the second half session key parameter XB corresponding to the second terminal S_UE, and the IKMS entity generates the symmetric key key corresponding to the second terminal S_UE based on the first half session key parameter XA corresponding to the second terminal S_UE and the second half session key parameter XB corresponding to the second terminal S_UE, where the symmetric key key is a symmetric key for the second terminal S_UE and the IKMS entity.

S797. The IKMS entity encrypts the private key corresponding to the second terminal based on the symmetric key corresponding to the second terminal, to generate the encrypted private key corresponding to the second terminal.

In this embodiment, the IKMS entity encrypts the private key SK corresponding to the second terminal S_UE based on the symmetric key key corresponding to the second terminal S_UE, to generate the encrypted private key (SK)_{key} corresponding to the second terminal SUE.

S798. The IKMS entity generates a second message authentication code based on the first shared key, where the first shared key is the key negotiated between the first terminal and the IKMS entity.

In this embodiment, the IKMS entity signs a second message by using the first shared key K_{IKMS_M}. In this case, the second message includes the second half session key parameter XB corresponding to the second terminal S_UE, the identifier S_UE_ID of the second terminal, the encrypted private key (SK)_{key} corresponding to the second terminal S_UE, and the generated second message authentication code MAC4.

S799. The IKMS entity sends the second message to the first terminal, where the second message includes the second half session key parameter corresponding to the second terminal, the identifier of the second terminal, the encrypted private key corresponding to the second terminal, and the second message authentication code, and the second message authentication code is used to authenticate that the second message is sent by the IKMS entity and perform authentication on integrity of the second message.

In this embodiment, the IKMS entity sends, to the first terminal M_UE, the second message carrying the second message authentication code MAC4. In this case, the second message includes the second half session key parameter XB corresponding to the second terminal S_UE, the identifier S_UE_ID of the second terminal, the encrypted private key (SK)_{key} corresponding to the second terminal S_UE, and the second message authentication code MAC4. For example, message content of the second message is <XB, S_UE_ID, (SK)_{key}, MAC4>.

S710. The first terminal performs authentication on the second message authentication code based on the first shared key, where the first shared key is the key negotiated between the first terminal and the IKMS entity.

In this embodiment, after receiving the second message, the first terminal M_UE first performs authentication on the second message authentication code MAC4. Specifically, because the first terminal M_UE has negotiated the first shared key K_{IKMS_M} with the IKMS entity, the first terminal M_UE may perform authentication on the second message authentication code MAC4 based on the first shared key K_{IKMS_M}.

S711. After determining that authentication on the second message authentication code succeeds, the first terminal sends the second half session key parameter corresponding to the second terminal and the encrypted private key corresponding to the second terminal to the second terminal, where the second half session key parameter corresponding to the second terminal is used to decrypt the encrypted private key corresponding to the second terminal.

In this embodiment, after determining that authentication on the second message authentication code MAC4 succeeds, the first terminal M_UE sends the second half session key parameter XB corresponding to the second terminal S_UE and the encrypted private key (SK)_{key} corresponding to the second terminal S_UE to the second terminal S_UE based on the identifier S_UE_ID of the second terminal. For example, the first terminal M_UE sends message content <XB, (SK)key> to the second terminal SUE.

S712. The second terminal generates the symmetric key based on the first half session key parameter corresponding to the second terminal and the second half session key parameter corresponding to the second terminal.

In this embodiment, after receiving the second half session key parameter XB corresponding to the second terminal S_UE and the encrypted private key (SK)_{key} corresponding to the second terminal S_UE, the second terminal S_UE first calculates the symmetric key key based on the first half session key parameter XA, generated by the second terminal S_UE, corresponding to the second terminal S_UE and the received second half session key parameter XB corresponding to the second terminal SUE.

S713. The second terminal decrypts the encrypted private key corresponding to the second terminal based on the symmetric key, to obtain the private key corresponding to the second terminal.

In this embodiment, the second terminal S_UE decrypts the encrypted private key (SK)_{key} corresponding to the second terminal S_UE based on the calculated symmetric key key, to obtain the private key SK corresponding to the second terminal S_UE. In this way, obtaining an initial key by the second terminal S_UE is completed.

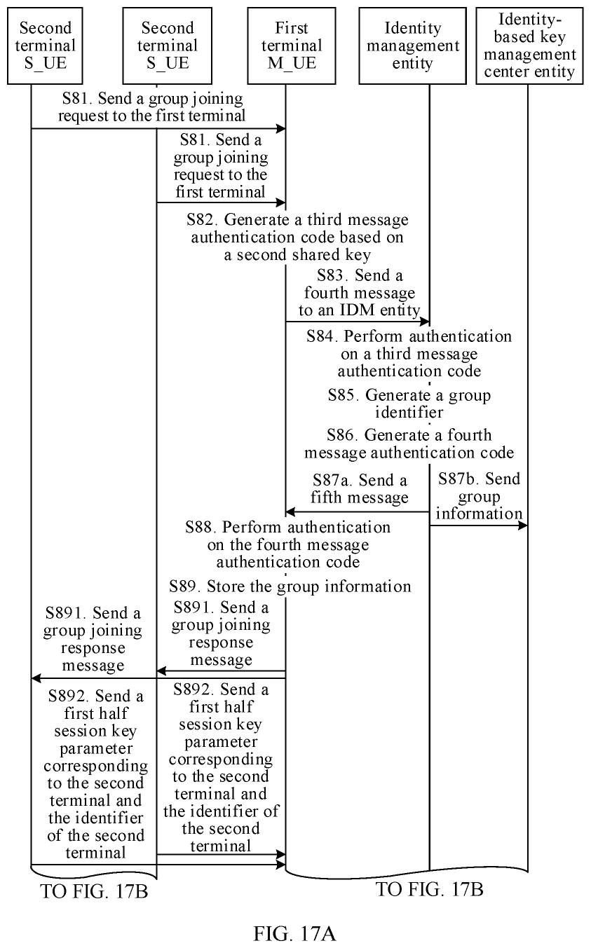

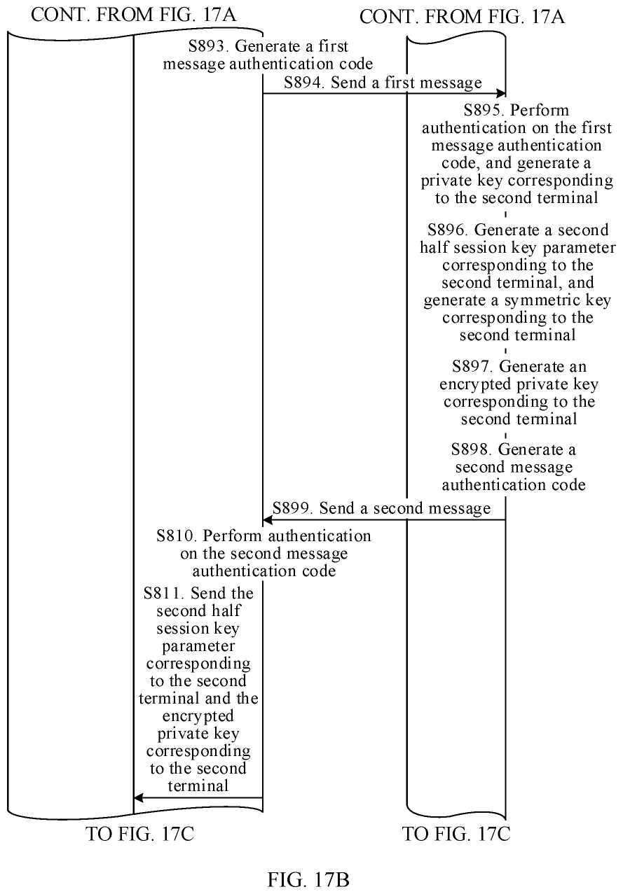

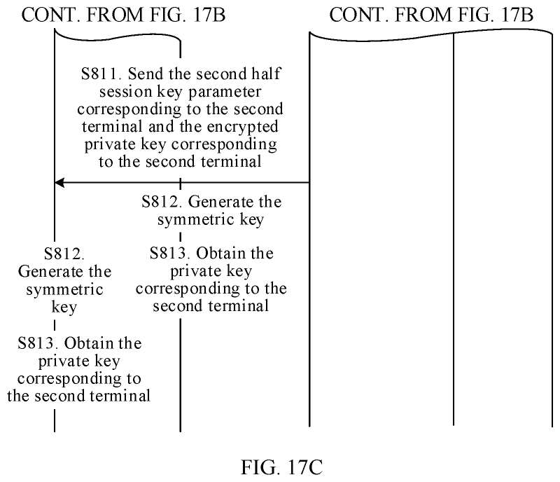

FIG. 17A to FIG. 17C are a schematic communication diagram 2 of still another private key generation method according to an embodiment. FIG. 17A to FIG. 17C are a schematic communication diagram of private key generation performed between at least two second terminals and one first terminal. The method is as follows.

S81. Each second terminal sends a group joining request to the first terminal, where the group joining request includes a group flag field and an identifier of the second terminal, and the group flag field represents a relationship between the first terminal and the second terminal.

In this embodiment, before step S81, through initiation, the first terminal M_UE and the second terminal S_UE can access a control plane, and the first terminal M_UE has negotiated a second shared key K_{IDM_M} and a first shared key K_{IKMS_M} with network elements such as an IDM entity and an IKMS entity, respectively. Specifically, the first terminal M_UE has negotiated the second shared key K_{IDM_M} with the IDM entity by using an HSS/AAA entity, and the first terminal M_UE has negotiated the first shared key K_{IKMS_M} with the IKMS entity by using the HSS/AAA entity.

Each second terminal S_UE and the first terminal M_UE establish a secure channel, and the second terminal S_UE sends a group joining request bonding_request to the first terminal M_UE through the secure channel. The group joining request bonding_request includes the group flag field GROUP_FLAG and the identifier S_UE_ID of the second terminal, and the group flag field GROUP_FLAG represents that the first terminal M_UE and the second terminal S_UE are in a master-slave relationship. In other words, the first terminal M_UE is a master node, and the second terminal S_UE is a slave node. For example, message content of the group joining request bonding_request sent by the second terminal S_UE to the first terminal M_UE is <GROUP_FLAG, S_UE_ID1>, and S_UE_ID1 is an ID of a second terminal S_UE1.

S82. The first terminal generates a third message authentication code based on the second shared key, where the second shared key is a key negotiated between the first terminal and the IDM entity.

In one embodiment, the second shared key includes a third key for generating the message authentication code and a fourth key for data encryption.

In this embodiment, the first terminal M_UE updates information required for group creation; and then the first terminal M_UE performs signature processing on a fourth message by using the second shared key K_{IDM_M}. In this case, the fourth message includes the group flag field GROUP_FLAG, an identifier M_UE_ID of the first terminal, the identifier S_UE_ID of each second terminal, and the generated third message authentication code MAC1. It can be learnt that the third message authentication code MAC1 is a message authentication code that is generated by the first terminal M_UE for the entire fourth message based on the symmetric key K_{IDM_M} for the first terminal M_UE and the IDM entity.

S83. The first terminal sends the fourth message to the IDM entity, where the fourth message includes the group flag field, the identifier of the first terminal, the identifier of the second terminal, and the third message authentication code, and the third message authentication code is used to authenticate that the fourth message is sent by the first terminal and perform authentication on integrity of the fourth message.

In this embodiment, the first terminal M_UE sends the fourth message to the IDM entity. It can be learnt that message content of the fourth message includes at least the group flag field GROUP_FLAG, the identifier M_UE_ID of the first terminal, the identifier S_UE_ID of each second terminal, and the third message authentication code MAC1, and the relationship between the first terminal M_UE and the second terminal S_UE is a master-slave relationship. For example, the message content of the fourth message is <GROUP_FLAG, M_UE_ID, S_UE_ID1, S_UE_ID2, MAC1, . . . >, where S_UE_ID1 is the ID of the second terminal S_UE1, and S_UE_ID2 is an ID of a second terminal S_UE2.

S84. The IDM entity performs authentication on the third message authentication code based on the second shared key, where the second shared key is the key negotiated between the first terminal and the IDM entity.

In this embodiment, after receiving the fourth message, the IDM entity performs authentication on the third message authentication code MAC1. Specifically, because the IDM entity has negotiated the second shared key K_{IDM_M} with the first terminal M-UE, the IDM entity may perform authentication on the third message authentication code MAC1 based on the second shared key K_{IDM_M} stored in the IDM entity.

S85. After determining that authentication on the third message authentication code succeeds, the IDM entity generates a group identifier.

In this embodiment, after determining that authentication on the third message authentication code MAC1 succeeds, the IDM entity generates the group identifier GROUP_ID for the first terminal M-UE and each second terminal SUE. In addition, the IDM entity stores group information, where the group information includes the group flag field GROUP_FLAG, the identifier M_UE_ID of the first terminal, the identifier S_UE_ID of each second terminal, and the group identifier GROUP_ID. For example, the group information includes information such as GROUP_FLAG, M_UE_ID, S_UE_ID1, S_UE_ID2, and GROUP_ID.

S86. The IDM entity generates a fourth message authentication code based on the second shared key, where the second shared key is the key negotiated between the first terminal and the IDM entity.

In this embodiment, the IDM entity signs a fifth message by using the second shared key K_{IDM_M}. The fifth message includes the group identifier GROUP_ID, the identifier M_UE_ID of the first terminal, the identifier S_UE_ID of each second terminal, and the generated fourth message authentication code MAC2. It can be learnt that the fourth message authentication code MAC2 is a message authentication code that is generated by the first terminal M_UE for the entire fifth message based on the symmetric key K_{IDM_M} for the first terminal M_UE and the IDM entity.

S87a. The IDM entity sends the fifth message to the first terminal, where the fifth message includes the group identifier, the identifier of the first terminal, the identifier of each second terminal, and the fourth message authentication code.

S87b. The IDM entity sends the group information to the IKMS entity, where the group information includes the group identifier, the identifier of the first terminal, and the identifier of the second terminal.

In this embodiment, the IDM entity sends the fifth message to the first terminal. In this case, the fifth message includes at least the group identifier GROUP_ID, the identifier M_UE_ID of the first terminal, the identifier S_UE_ID of each second terminal, and the fourth message authentication code MAC2. For example, message content of the fifth message is <GROUP_ID, M_UE_ID, S_UE_ID1, S_UE_ID2, MAC2, . . . >, where S_UE_ID1 is the ID of the second terminal S_UE1, and S_UE_ID2 is the ID of the second terminal S_UE2.

In addition, the IDM entity sends the generated group information to the IKMS entity, where the group information includes the group flag field GROUP_FLAG, the identifier M_UE_ID of the first terminal, the identifier S_UE_ID of each second terminal, and the group identifier GROUP_ID.

A sequence of the step of sending, by the IDM entity, the fifth message to the first terminal and the step of sending, by the IDM entity, the generated group information to the IKMS entity is not limited.

S88. The first terminal performs authentication on the fourth message authentication code based on the second shared key, where the second shared key is the key negotiated between the first terminal and the IDM entity.

In this embodiment, after receiving the fifth message, the first terminal M_UE first needs to perform authentication on the fourth message authentication code MAC2. Specifically, because the IDM entity has negotiated the second shared key K_{IDM_M} with the first terminal M-UE, the first terminal M-UE may perform authentication on the fourth message authentication code MAC2 based on the second shared key K_{IDM_M} stored in the first terminal M-UE.

S89. After determining that authentication on the fourth message authentication code succeeds, the first terminal stores the group information, where the group information includes the group identifier, the identifier of the first terminal, and the identifier of each second terminal.

In this embodiment, after determining that authentication on the fourth message authentication code MAC2 succeeds, the first terminal M-UE may store the group information. For example, the first terminal M-UE adds S_UE_ID1 and S_UE_ID2 of the group members.

S891. The first terminal sends a group joining response message to each second terminal, where the group joining response message includes the group identifier.

In this embodiment, the first terminal M-UE sends the group joining response message bonding acknowledge to each second terminal S_UE through the secure channel, where the group joining response message bonding acknowledge includes the group identifier GROUP_ID; and then notifies the second terminal S_UE that group creation succeeds. For example, the first terminal M-UE sends the group joining response message bonding acknowledge to the second terminal S_UE1, and the first terminal M-UE sends the group joining response message bonding acknowledge to the second terminal S_UE2.

Step S81 to step S891 are a process in which a plurality of second terminals S_UE and one first terminal M-UE complete group creation.

S892. Each second terminal sends a first half session key parameter corresponding to the second terminal and the identifier of the second terminal to the first terminal.

In this embodiment, after each second terminal S_UE and the first terminal M-UE complete group creation, private key obtaining may be performed. A private key obtaining process is based on an improved D-H key negotiation protocol.

Each second terminal S_UE first sends the first half session key parameter XA corresponding to the second terminal S_UE and the identifier S_UE_ID of the second terminal to the first terminal M_UE, where the first half session key parameter XA is used for session key negotiation.

For example, when there are two second terminals, the second terminal S_UE1 sends a half session key parameter XA1 corresponding to the second terminal S_UE1 and the identifier S_UE_ID1 of the second terminal to the first terminal M_UE; and the second terminal S_UE2 sends a half session key parameter XA2 corresponding to the second terminal S_UE2 and the identifier S_UE_ID2 of the second terminal to the first terminal M_UE.

S893. The first terminal generates a first message authentication code based on the first shared key, where the first shared key is a key negotiated between the first terminal and the IKMS entity.

In one embodiment, the first shared key includes a first key for generating the message authentication code and a second key for data encryption.

In this embodiment, the first terminal M_UE adds the first half session key parameter XA corresponding to each second terminal S_UE and the identifier S_UE_ID of the second terminal to a first message. Then, the first terminal M_UE signs the first message by using the first shared key K_{IKMS_M} negotiated between the first terminal M_UE and the IKMS entity. In this case, the first message includes the first half session key parameter XA corresponding to each second terminal S_UE, the identifier S_UE_ID of the second terminal, and the generated first message authentication code MAC3.

S894. The first terminal sends the first message to the IKMS entity, where the first message includes the first half session key parameter corresponding to each second terminal, the identifier of the second terminal, and the first message authentication code.

In this embodiment, the first terminal M_UE sends a signed first message to the IKMS entity. In this case, the first message includes the first half session key parameter XA corresponding to each second terminal S_UE, the identifier S_UE_ID of the second terminal, and the first message authentication code MAC3.

For example, when there are two second terminals, message content of the first message is <XA1, S_UE_ID1, XA2, S_UE_ID2, MAC3>.

S895. The IKMS entity performs authentication on the first message authentication code based on the first shared key, where the first shared key is the key negotiated between the first terminal and the IKMS entity; and after determining that authentication on the first message authentication code succeeds, the IKMS entity generates a private key corresponding to each second terminal based on the identifier of the second terminal.

In this embodiment, after receiving the first message sent by the first terminal M_UE, the IKMS entity first performs authentication on the first message authentication code MAC3. Specifically, because the first terminal M_UE has negotiated the first shared key K_{IKMS_M} with the IKMS entity, the IKMS entity may perform authentication on the first message authentication code MAC3 based on the first shared key K_{IKMS_M}.

After determining that authentication on the first message authentication code MAC3 succeeds, according to an IBS technology and by using the identifier S_UE_ID of the second terminal as a public key, the IKMS entity generates a private key SK for the identifier S_UE_ID of each second terminal. In other words, each private key SK is a private key SK corresponding to one second terminal S_UE.

For example, when there are two second terminals, according to the IBS technology, the IKMS entity generates a private key SK1 corresponding to the second terminal S_UE1 for the identifier S_UE_ID1 of the second terminal based on the identifier S_UE M1 of the second terminal, and generates a private key SK2 corresponding to the second terminal S_UE2 for the identifier S_UE_ID2 of the second terminal based on the identifier S_UE_ID2 of the second terminal.

S896. The IKMS entity generates a second half session key parameter corresponding to each second terminal, and generates a symmetric key corresponding to the second terminal based on the first half session key parameter corresponding to the second terminal and the second half session key parameter corresponding to the second terminal.

In this embodiment, the IKMS entity generates the second half session key parameter XB corresponding to each second terminal S_UE, and the IKMS entity generates the symmetric key key corresponding to the second terminal S_UE based on the first half session key parameter XA corresponding to the second terminal S_UE and the second half session key parameter XB corresponding to the second terminal S_UE, where the symmetric key key is a symmetric key for the second terminal S_UE and the IKMS entity.

S897. The IKMS entity encrypts the private key corresponding to each second terminal based on the symmetric key corresponding to the second terminal, to generate an encrypted private key corresponding to the second terminal.

In this embodiment, the IKMS entity encrypts the private key SK corresponding to each second terminal S_UE based on the symmetric key key corresponding to the second terminal S_UE, to generate the encrypted private key (SK)_{key} corresponding to the second terminal SUE.

For example, when there are two second terminals, the IKMS entity generates a second half session key parameter XB1 for the second terminal S_UE1, and generates a symmetric key key1 for the IKMS and the second terminal S_UE1 based on XB1 and the received XA1. Next, the IKMS entity encrypts the private key SK1 based on the key key1. The IKMS entity generates a second half session key parameter XB2 for the second terminal S_UE2, and generates a symmetric key key2 for the IKMS and the second terminal S_UE2 based on XB2 and the received XA2. Next, the IKMS entity encrypts the private key SK2 based on the key key2.

S898. The IKMS entity generates a second message authentication code based on the first shared key, where the first shared key is the key negotiated between the first terminal and the IKMS entity.

In this embodiment, the IKMS entity adds, to a second message, the second half session key parameter XB corresponding to each second terminal S_UE, the identifier S_UE_ID of the second terminal, and the encrypted private key (SK)_{key} corresponding to the second terminal SUE. Then, the IKMS entity signs the second message by using the first shared key K_{IKMS_M}. In this case, the second message includes the second half session key parameter XB corresponding to each second terminal S_UE, the identifier S_UE_ID of the second terminal, the encrypted private key (SK)_{key} corresponding to the second terminal S_UE, and the generated second message authentication code MAC4.

S899. The IKMS entity sends the second message to the first terminal, where the second message includes the second half session key parameter corresponding to each second terminal, the identifier of the second terminal, the encrypted private key corresponding to the second terminal, and the second message authentication code.

In this embodiment, the IKMS entity sends, to the first terminal M_UE, the second message carrying the second message authentication code MAC4. In this case, the second message includes the second half session key parameter XB corresponding to each second terminal S_UE, the identifier S_UE_ID of the second terminal, the encrypted private key (SK)_{key} corresponding to the second terminal S_UE, and the second message authentication code MAC4.

For example, the IKMS entity sends, together to the first terminal M_UE, the second half session key parameter XB1, the identifier S_UE_ID1 of the second terminal S_UE1, an encrypted private key (SK1)_{key1}, the second half session key parameter XB2, the identifier S_UE_ID2 of the second terminal S_UE2, an encrypted private key (SK2)_{key2}, and the message authentication code MAC4. In other words, message content includes <XB1, S_UE_ID1, (SK1)_{key1}, XB2, S_UE_ID2, (SK2)_{key2}, MAC4>.

S810. The first terminal performs authentication on the second message authentication code based on the first shared key, where the first shared key is the key negotiated between the first terminal and the IKMS entity.

In this embodiment, after receiving the second message, the first terminal M_UE first performs authentication on the second message authentication code MAC4. Specifically, because the first terminal M_UE has negotiated the first shared key K_{IKMS_M} with the IKMS entity, the first terminal M_UE may perform authentication on the second message authentication code MAC4 based on the first shared key K_{IKMS_M}.

S811. After determining that authentication on the second message authentication code succeeds, the first terminal sends the second half session key parameter corresponding to each second terminal and the encrypted private key corresponding to the second terminal to the second terminal.

In this embodiment, after determining that authentication on the second message authentication code MAC4 succeeds, the first terminal M_UE sends the second half session key parameter XB corresponding to the second terminal S_UE and the encrypted private key (SK)_{key} corresponding to the second terminal S_UE to the second terminal S_UE based on the identifier S_UE_ID of the second terminal.

For example, the first terminal M_UE sends the second half session key parameter XB1 corresponding to the second terminal S_UE1 and the encrypted private key (SK1)_{key1} corresponding to the second terminal S_UE1 to the second terminal S_UE1. In other words, the first terminal M_UE sends the message <XB1, (SK1)_{key1}> to the second terminal S_UE1. The first terminal M_UE sends the second half session key parameter XB2 corresponding to the second terminal S_UE2 and the encrypted private key (SK2)_{key2} corresponding to the second terminal S_UE2 to the second terminal S_UE2. In other words, the first terminal M_UE sends the message <XB2, (SK2)_{key2}> to the second terminal S_UE2.

S812. Each second terminal generates the symmetric key based on the first half session key parameter corresponding to the second terminal and the second half session key parameter corresponding to the second terminal.

In this embodiment, after receiving the second half session key parameter XB corresponding to each second terminal S_UE and the encrypted private key (SK)_{key} corresponding to the second terminal S_UE, the second terminal S_UE first calculates the symmetric key key based on the first half session key parameter XA, generated by the second terminal S_UE, corresponding to the second terminal S_UE and the received second half session key parameter XB corresponding to the second terminal SUE.

S813. Each second terminal decrypts the encrypted private key corresponding to the second terminal based on the symmetric key, to obtain the private key corresponding to the second terminal.

In this embodiment, each second terminal S_UE decrypts the encrypted private key (SK)_{key} corresponding to the second terminal S_UE based on the calculated symmetric key key, to obtain the private key SK corresponding to the second terminal S_UE. In this way, obtaining an initial key by each second terminal S_UE is completed.

For example, after receiving the message, the second terminal S_UE1 first generates, through calculation, the symmetric key key1 based on the received second half session key parameter XB1 corresponding to the second terminal S_UE1 and the first half session key parameter XA1 generated by the second terminal S_UE1. Then, the second terminal S_UE1 decrypts (SK1)_{key1} based on the key key1, to obtain the private key SK1 corresponding to the second terminal S_UE1. In this way, obtaining an initial key by the second terminal S_UE1 is completed. After receiving the message, the second terminal S_UE2 first generates, through calculation, the symmetric key key2 based on the received second half session key parameter XB2 corresponding to the second terminal S_UE2 and the first half session key parameter XA2 generated by the second terminal S_UE2. Then, the second terminal S_UE2 decrypts (SK2)_{key2} based on the key key2, to obtain the private key SK2 corresponding to the second terminal S_UE2. In this way, obtaining an initial key by the second terminal S_UE2 is completed.

It can be learnt that step S892 to step S813 are based on a symmetric key mechanism.

In this embodiment, the second terminal triggers group creation, the first terminal sends information such as the group flag field to the IDM entity, and the first terminal determines whether a group is to be created. In this way, the first terminal and the second terminal are trustworthy to each other, thereby improving a trust degree and security of the network elements in the group. In addition, characteristics of the group that can be created based on a group creation request proactively sent by the second terminal are diversified. In addition, a private key obtaining method is provided. After a group is created for terminals, the second terminal initiates a private key obtaining request, the IKMS entity generates the encrypted private key corresponding to the second terminal, and the second terminal receives, by using the first terminal, the encrypted private key corresponding to the second terminal sent by the IKMS entity. Therefore, the second terminal can relatively quickly obtain the encrypted private key corresponding to the second terminal. This can prevent the private key from being stolen, and prevent communication information between groups from being stolen.

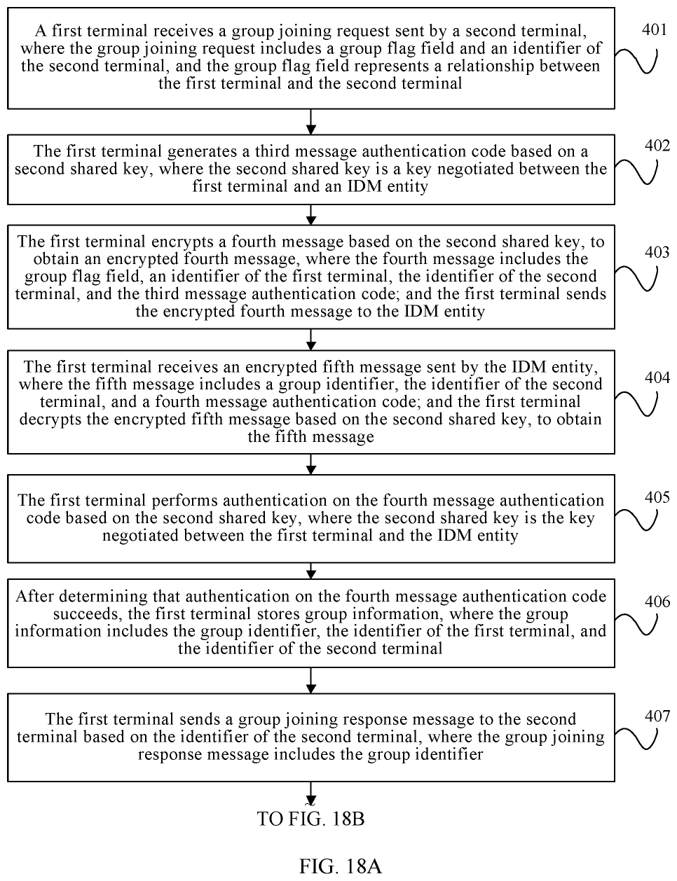

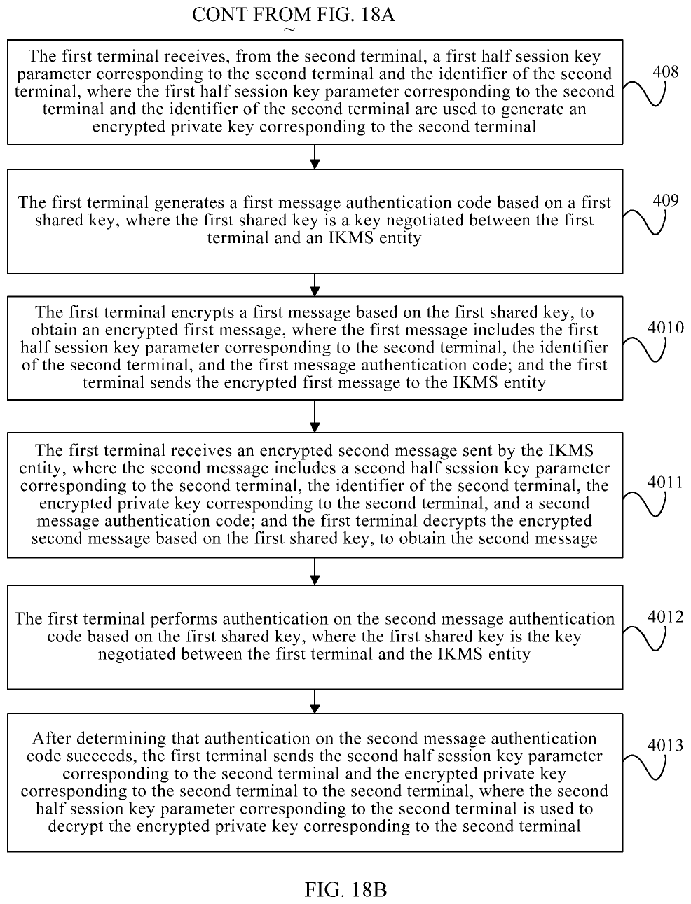

FIG. 18A and FIG. 18B are a schematic flowchart of yet another private key generation method according to an embodiment. As shown in FIG. 18A and FIG. 18B, the method is as follows.

401. A first terminal receives a group joining request sent by a second terminal, where the group joining request includes a group flag field and an identifier of the second terminal, and the group flag field represents a relationship between the first terminal and the second terminal.

402. The first terminal generates a third message authentication code based on a second shared key, where the second shared key is a key negotiated between the first terminal and an IDM entity.

In one embodiment, the second shared key includes a third key for generating the message authentication code and a fourth key for data encryption.

403. The first terminal encrypts a fourth message based on the second shared key, to obtain an encrypted fourth message, where the fourth message includes the group flag field, an identifier of the first terminal, the identifier of the second terminal, and the third message authentication code, and the third message authentication code is used to authenticate that the fourth message is sent by the first terminal and perform authentication on integrity of the fourth message; and the first terminal sends the encrypted fourth message to the IDM entity.

404. The first terminal receives an encrypted fifth message sent by the IDM entity, where the fifth message includes a group identifier, the identifier of the second terminal, and a fourth message authentication code, and the fourth message authentication code is used to authenticate that the fifth message is sent by the IDM entity and perform authentication on integrity of the fifth message; and the first terminal decrypts the encrypted fifth message based on the second shared key, to obtain the fifth message.

405. The first terminal performs authentication on the fourth message authentication code based on the second shared key, where the second shared key is the key negotiated between the first terminal and the IDM entity.

406. After determining that authentication on the fourth message authentication code succeeds, the first terminal stores group information, where the group information includes the group identifier, the identifier of the first terminal, and the identifier of the second terminal.

407. The first terminal sends a group joining response message to the second terminal based on the identifier of the second terminal, where the group joining response message includes the group identifier.

408. The first terminal receives, from the second terminal, a first half session key parameter corresponding to the second terminal and the identifier of the second terminal, where the first half session key parameter corresponding to the second terminal and the identifier of the second terminal are used to generate an encrypted private key corresponding to the second terminal.

409. The first terminal generates a first message authentication code based on a first shared key, where the first shared key is a key negotiated between the first terminal and an IKMS entity.

In one embodiment, the first shared key includes a first key for generating the message authentication code and a second key for data encryption.

4010. The first terminal encrypts a first message based on the first shared key, to obtain an encrypted first message, where the first message includes the first half session key parameter corresponding to the second terminal, the identifier of the second terminal, and the first message authentication code, and the first message authentication code is used to authenticate that the first message is sent by the first terminal and perform authentication on integrity of the first message; and the first terminal sends the encrypted first message to the IKMS entity.

4011. The first terminal receives an encrypted second message sent by the IKMS entity, where the second message includes a second half session key parameter corresponding to the second terminal, the identifier of the second terminal, the encrypted private key corresponding to the second terminal, and a second message authentication code, and the second message authentication code is used to authenticate that the second message is sent by the IKMS entity and perform authentication on integrity of the second message; and the first terminal decrypts the encrypted second message based on the first shared key, to obtain the second message.

4012. The first terminal performs authentication on the second message authentication code based on the first shared key, where the first shared key is the key negotiated between the first terminal and the IKMS entity.

4013. After determining that authentication on the second message authentication code succeeds, the first terminal sends the second half session key parameter corresponding to the second terminal and the encrypted private key corresponding to the second terminal to the second terminal, where the second half session key parameter corresponding to the second terminal is used to decrypt the encrypted private key corresponding to the second terminal.

The following uses schematic communication diagrams to describe the method in FIG. 18A and FIG. 18B.

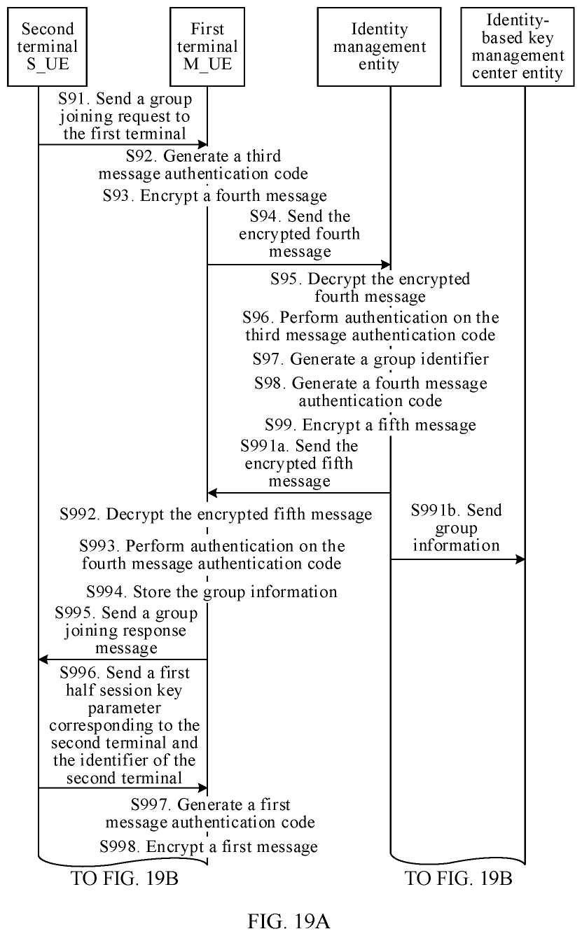

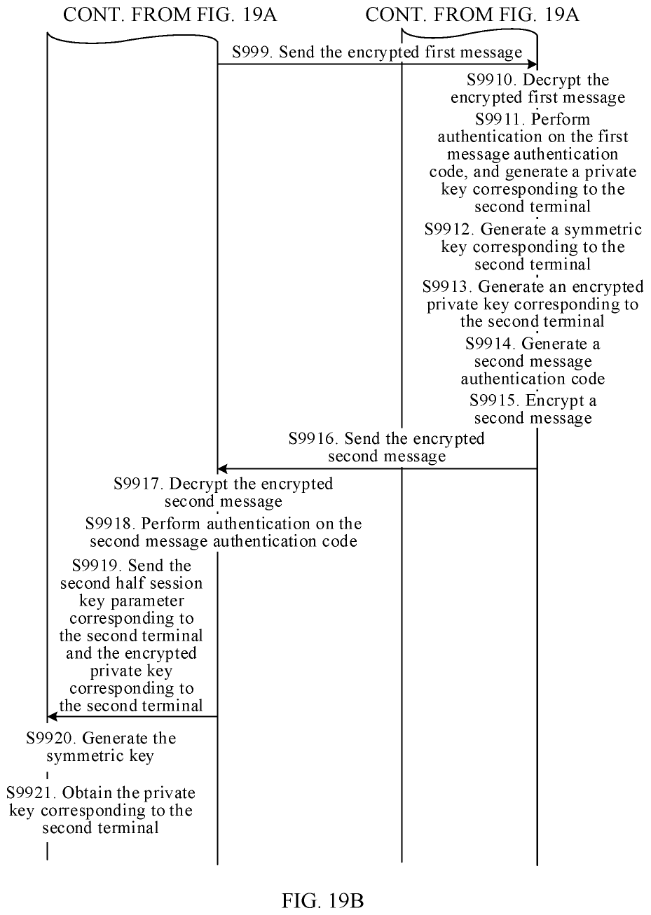

FIG. 19A and FIG. 19B are a schematic communication diagram of yet another private key generation method according to an embodiment. FIG. 19A and FIG. 19B are a schematic communication diagram of private key generation performed between one second terminal and one first terminal. The method is as follows.

S91. The second terminal sends a group joining request to the first terminal, where the group joining request includes a group flag field and an identifier of the second terminal, and the group flag field represents a relationship between the first terminal and the second terminal.

In this embodiment, for this step, refer to step S71 in FIG. 16A. Details are not described again.

S92. The first terminal generates a third message authentication code based on a second shared key, where the second shared key is a key negotiated between the first terminal and an IDM entity.

In one embodiment, the second shared key includes a third key for generating the message authentication code and a fourth key for data encryption.

In this embodiment, for this step, refer to step S72 in FIG. 16A. Details are not described again.

S93. The first terminal encrypts a fourth message based on the second shared key, to obtain an encrypted fourth message, where the fourth message includes the group flag field, an identifier of the first terminal, the identifier of the second terminal, and the third message authentication code, and the third message authentication code is used to authenticate that the fourth message is sent by the first terminal and perform authentication on integrity of the fourth message.

In this embodiment, the first terminal M_UE adds, to a fourth message, the group flag field GROUP_FLAG, the identifier M_UE_ID of the first terminal, the identifier S_UE_ID of the second terminal, and the third message authentication code MAC1; and then the first terminal M_UE encrypts the fourth message based on the second shared key K_{IDM_M}, to obtain the encrypted fourth message. The second shared key K_{IDM_M} is a symmetric key.

For example, message content of the encrypted fourth message is <(GROUP_FLAG, M_UE_ID, S_UE_ID, MAC1) K_{IDM_M}>. GROUP_FLAG is the group flag field, the relationship between the first terminal M_UE and the second terminal S_UE is a master-slave relationship, M_UE_ID is the ID of the first terminal M_UE, S_UE_ID is the ID of the second terminal S_UE, and MAC1 is the third message authentication code that is generated for the entire fourth message based on the second shared key K_{IDM_M}.

S94. The first terminal sends the encrypted fourth message to the IDM entity.

S95. The IDM entity decrypts the encrypted fourth message based on the second shared key, to obtain the fourth message, where the second shared key is the key negotiated between the first terminal and the IDM entity.

In this embodiment, after the IDM entity receives the encrypted fourth message, because the IDM entity has negotiated the second shared key K_{IDM_M} with the first terminal M-UE, the IDM entity decrypts the encrypted fourth message based on the second shared key K_{IDM_M}, to obtain the fourth message. Then, the IDM entity may obtain the group flag field GROUP_FLAG, the identifier M_UE_ID of the first terminal, the identifier S_UE_ID of the second terminal, and the third message authentication code MAC1.

S96. The IDM entity performs authentication on the third message authentication code based on the second shared key.

In this embodiment, after decrypting the fourth message, the IDM entity may obtain the third message authentication code MAC1, and the IDM entity needs to perform authentication on the third message authentication code MAC1. Specifically, because the IDM entity has negotiated the second shared key K_{IDM_M} with the first terminal M-UE, the IDM entity may perform authentication on the third message authentication code MAC1 based on the second shared key K_{IDM_M} stored in the IDM entity.

S97. After determining that authentication on the third message authentication code succeeds, the IDM entity generates a group identifier.

In this embodiment, for this step, refer to step S75 in FIG. 16A. Details are not described again.

S98. The IDM entity generates a fourth message authentication code based on the second shared key, where the second shared key is the key negotiated between the first terminal and the IDM entity.

In this embodiment, for this step, refer to step S76 in FIG. 16A. Details are not described again.

S99. The IDM entity encrypts a fifth message based on the second shared key, to generate an encrypted fifth message, where the fifth message includes the group identifier, the identifier of the second terminal, and the fourth message authentication code, and the fourth message authentication code is used to authenticate that the fifth message is sent by the IDM entity and perform authentication on integrity of the fifth message.

In this embodiment, the IDM entity adds, to a fifth message, the group identifier GROUP_ID, the identifier M_UE_ID of the first terminal, the identifier S_UE_ID of the second terminal, and the fourth message authentication code MAC2; and then the IDM entity encrypts the fifth message based on the second shared key K_{IDM_M}, to obtain the encrypted fifth message.

For example, the fifth message includes <(GROUP_ID, M_UE_ID, S_UE_ID, MAC2) K_{IDM_M}>. GROUP_ID is the group identifier, M_UE_ID is the ID of the first terminal M_UE, S_UE_ID is the ID of the second terminal S_UE, and MAC2 is a message authentication code that is generated for the entire fifth message based on the second shared key K_{IDM_M}. In addition, entire second information is encrypted based on the symmetric key K_{IDM_M} for the first terminal M_UE and the IDM entity.

S991a. The IDM entity sends the encrypted fifth message to the first terminal.

S991b. The IDM entity sends group information to an IKMS entity, where the group information includes the group identifier, the identifier of the first terminal, and the identifier of the second terminal.

In this embodiment, the IDM entity sends the encrypted fifth message to the first terminal, and the IDM entity sends the generated group information to the IKMS entity, where the group information includes the group flag field GROUP_FLAG, the identifier M_UE_ID of the first terminal, the identifier S_UE_ID of the second terminal, and the group identifier GROUP_ID.

A sequence of the step of sending, by the IDM entity, the encrypted fifth message to the first terminal and the step of sending, by the IDM entity, the generated group information to the IKMS entity is not limited.

S992. The first terminal decrypts the encrypted fifth message based on the second shared key, to obtain the fifth message.

In this embodiment, the first terminal M_UE decrypts the encrypted fifth message based on the second shared key K_{IDM_M}, to obtain the group identifier GROUP_ID, the identifier M_UE_ID of the first terminal, the identifier S_UE_ID of the second terminal, and the fourth message authentication code MAC2.

S993. The first terminal performs authentication on the fourth message authentication code based on the second shared key, where the second shared key is the key negotiated between the first terminal and the IDM entity.

In this embodiment, for this step, refer to step S78 in FIG. 16A. Details are not described again.

S994. After determining that authentication on the fourth message authentication code succeeds, the first terminal stores the group information, where the group information includes the group identifier, the identifier of the first terminal, and the identifier of the second terminal.

In this embodiment, for this step, refer to step S79 in FIG. 16A. Details are not described again.

S995. The first terminal sends a group joining response message to the second terminal based on the identifier of the second terminal, where the group joining response message includes the group identifier.

In this embodiment, for this step, refer to step S791 in FIG. 16A. Details are not described again.

Step S91 to step S995 are a process in which one second terminal S_UE and one first terminal M-UE complete group creation.

S996. The second terminal sends a first half session key parameter corresponding to the second terminal and the identifier of the second terminal to the first terminal, where the first half session key parameter corresponding to the second terminal and the identifier of the second terminal are used to generate an encrypted private key corresponding to the second terminal.

In this embodiment, for this step, refer to step S792 in FIG. 16A. Details are not described again.

S997. The first terminal generates a first message authentication code based on a first shared key, where the first shared key is a key negotiated between the first terminal and the IKMS entity.

In one embodiment, the first shared key includes a first key for generating the message authentication code and a second key for data encryption.

In this embodiment, for this step, refer to step S793 in FIG. 16A. Details are not described again.

S998. The first terminal encrypts a first message based on the first shared key, to obtain an encrypted first message, where the first message includes the first half session key parameter corresponding to the second terminal, the identifier of the second terminal, and the first message authentication code, and the first message authentication code is used to authenticate that the first message is sent by the first terminal and perform authentication on integrity of the first message.

In this embodiment, the first terminal M_UE adds, to a first message, the first half session key parameter XA corresponding to the second terminal S_UE, the identifier S_UE_ID of the second terminal, and the first message authentication code MAC3; and then the first terminal M_UE encrypts the first message based on the first shared key K_{IKMS_M}, to obtain the encrypted first message. The first shared key K_{IKMS_M} is a symmetric key.

For example, message content of the first message is <(XA, S_UE_ID, MAC3) K_{IKMS_M}>.

S999. The first terminal sends the encrypted first message to the IKMS entity.

S9910. The IKMS entity decrypts the encrypted first message based on the first shared key, to obtain the first message.

In this embodiment, the IKMS entity decrypts the encrypted first message based on the first shared key K_{IKMS_M}, to obtain the first half session key parameter XA corresponding to the second terminal S_UE, the identifier S_UE_ID of the second terminal, and the first message authentication code MAC3.

S9911. The IKMS entity performs authentication on the first message authentication code based on the first shared key, where the first shared key is the key negotiated between the first terminal and the IKMS entity; and after determining that authentication on the first message authentication code succeeds, the IKMS entity generates a private key corresponding to the second terminal based on the identifier of the second terminal.

In this embodiment, for this step, refer to step S795 in FIG. 16B. Details are not described again.

S9912. The IKMS entity generates a second half session key parameter corresponding to the second terminal, and generates a symmetric key corresponding to the second terminal based on the first half session key parameter corresponding to the second terminal and the second half session key parameter corresponding to the second terminal.

In this embodiment, for this step, refer to step S796 in FIG. 16B. Details are not described again.

S9913. The IKMS entity encrypts the private key corresponding to the second terminal based on the symmetric key corresponding to the second terminal, to generate the encrypted private key corresponding to the second terminal.

In this embodiment, for this step, refer to step S797 in FIG. 16B. Details are not described again.

S9914. The IKMS entity generates a second message authentication code based on the first shared key, where the first shared key is the key negotiated between the first terminal and the IKMS entity.

In this embodiment, for this step, refer to step S798 in FIG. 16B. Details are not described again.

S9915. The IKMS entity encrypts a second message based on the first shared key, to generate an encrypted second message, where the second message includes the second half session key parameter corresponding to the second terminal, the identifier of the second terminal, the encrypted private key corresponding to the second terminal, and the second message authentication code, and the second message authentication code is used to authenticate that the second message is sent by the IKMS entity and perform authentication on integrity of the second message.

In this embodiment, the IKMS entity adds, to a second message, the second half session key parameter XB corresponding to the second terminal S_UE, the identifier S_UE_ID of the second terminal, the encrypted private key (SK)_{key} corresponding to the second terminal S_UE, and the second message authentication code MAC4; and then the IKMS entity encrypts the second message based on the first shared key K_{IKMS_M}, to generate the encrypted second message.

For example, the encrypted second message is <(XB, S_UE_ID, (SK)key, MAC4) K_{IKMS_M}>.

S9916. The IKMS entity sends the encrypted second message to the first terminal.

S9917. The first terminal decrypts the encrypted second message based on the first shared key, to obtain the second message.

In this embodiment, the first terminal M_UE decrypts the encrypted second message based on the first shared key K_{IKMS_M}, to obtain the second half session key parameter XB corresponding to the second terminal S_UE, the identifier S_UE_ID of the second terminal, the encrypted private key (SK)_{key} corresponding to the second terminal S_UE, and the second message authentication code MAC4.

S9918. The first terminal performs authentication on the second message authentication code based on the first shared key, where the first shared key is the key negotiated between the first terminal and the IKMS entity.

In this embodiment, after decrypting the encrypted second message, the first terminal M_UE may obtain the second message authentication code MAC4, and the first terminal M_UE needs to perform authentication on the second message authentication code MAC4. Specifically, because the first terminal M_UE has negotiated the first shared key K_{IKMS_M} with the IKMS entity, the first terminal M_UE may perform authentication on the second message authentication code MAC4 based on the first shared key K_{IKMS_M}.

S9919. After determining that authentication on the second message authentication code succeeds, the first terminal sends the second half session key parameter corresponding to the second terminal and the encrypted private key corresponding to the second terminal to the second terminal, where the second half session key parameter corresponding to the second terminal is used to decrypt the encrypted private key corresponding to the second terminal.

In this embodiment, for this step, refer to step S711 in FIG. 16B. Details are not described again.

S9920. The second terminal generates the symmetric key based on the first half session key parameter corresponding to the second terminal and the second half session key parameter corresponding to the second terminal.

In this embodiment, for this step, refer to step S712 in FIG. 16B. Details are not described again.

S9921. The second terminal decrypts the encrypted private key corresponding to the second terminal based on the symmetric key, to obtain the private key corresponding to the second terminal.

In this embodiment, for this step, refer to step S713 in FIG. 16B. Details are not described again.

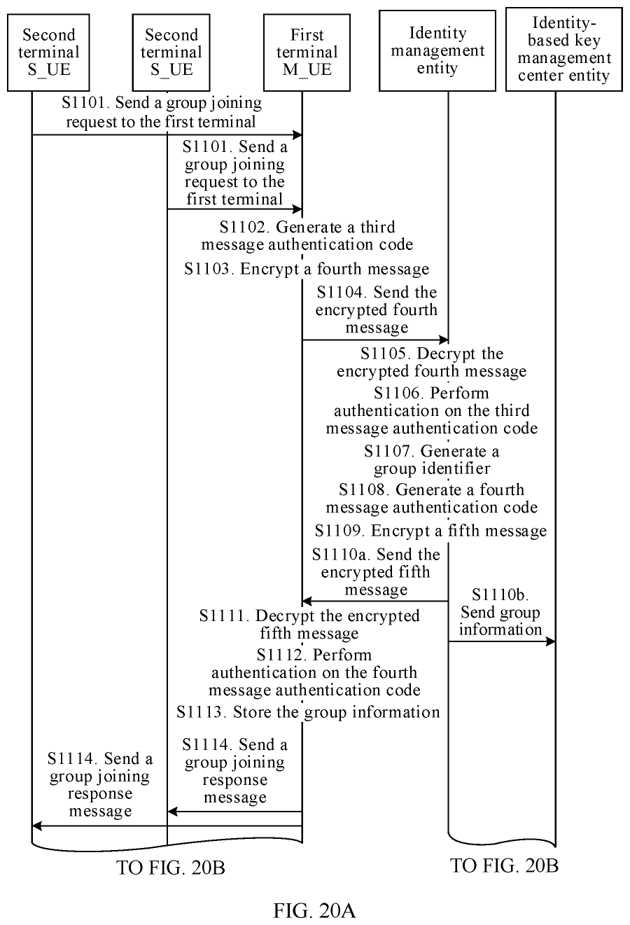

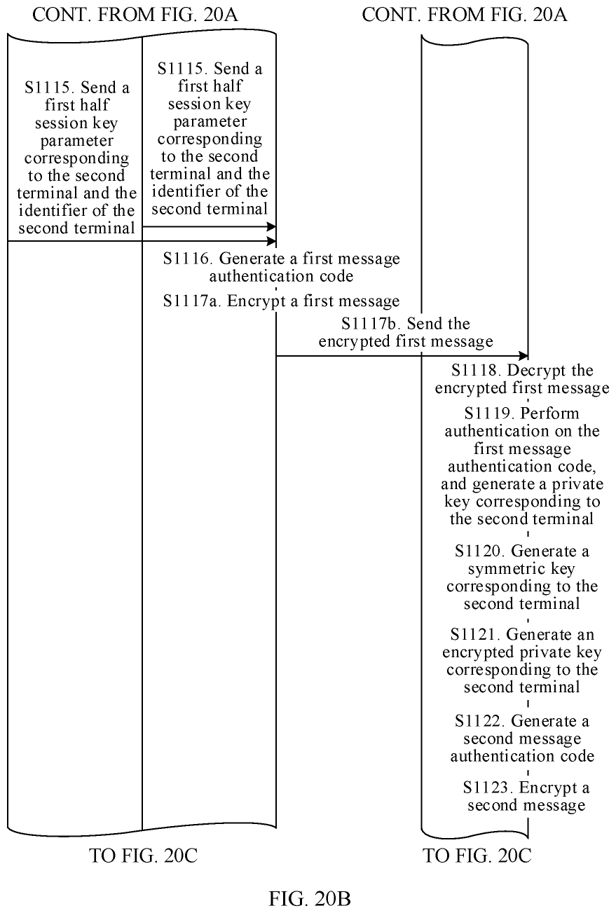

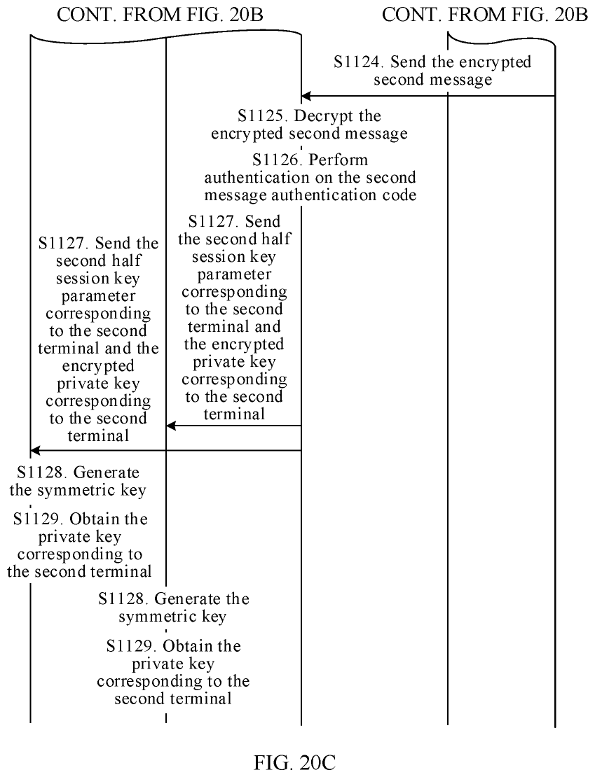

FIG. 20A to FIG. 20C are a schematic communication diagram 2 of yet another private key generation method according to an embodiment. FIG. 20A to FIG. 20C are a schematic communication diagram of private key generation performed between at least two second terminals and one first terminal. The method is as follows.

S1101. Each second terminal sends a group joining request to the first terminal, where the group joining request includes a group flag field and an identifier of the second terminal, and the group flag field represents a relationship between the first terminal and the second terminal.

In this embodiment, for this step, refer to step S81 in FIG. 17A. Details are not described again.

S1102. The first terminal generates a third message authentication code based on a second shared key, where the second shared key is a key negotiated between the first terminal and an IDM entity.

In one embodiment, the second shared key includes a third key for generating the message authentication code and a fourth key for data encryption.

In this embodiment, for this step, refer to step S82 in FIG. 17A. Details are not described again.

S1103. The first terminal encrypts a fourth message based on the second shared key, to obtain an encrypted fourth message, where the fourth message includes the group flag field, an identifier of the first terminal, the identifier of each second terminal, and the third message authentication code.

In this embodiment, the first terminal M_UE adds, to a fourth message, the group flag field GROUP_FLAG, the identifier M_UE_ID of the first terminal, the identifier S_UE_ID of each second terminal, and the third message authentication code MAC1; and then the first terminal M_UE encrypts the fourth message based on the second shared key K_{IDM_M}, to obtain the encrypted fourth message. The second shared key K_{IDM_M} is a symmetric key.

For example, message content of the encrypted fourth message is <(GROUP_FLAG, M_UE_ID, S_UE_ID1, S_UE_ID2, MAC1) K_{IDM_M} . . . >. GROUP_FLAG is the group flag field, the relationship between the first terminal M_UE and the second terminal S_UE is a master-slave relationship, M_UE_ID is the ID of the first terminal M_UE, S_UE_ID1 is an ID of a second terminal S_UE1, S_UE_ID2 is an ID of a second terminal S_UE2, and MAC1 is the third message authentication code that is generated for the entire fourth message based on the second shared key K_{IDM_M}.

S1104. The first terminal sends the encrypted fourth message to the IDM entity.

S1105. The IDM entity decrypts the encrypted fourth message based on the second shared key, to obtain the fourth message, where the second shared key is the key negotiated between the first terminal and the IDM entity.

In this embodiment, after the IDM entity receives the encrypted fourth message, because the IDM entity has negotiated the second shared key K_{IDM_M} with the first terminal M-UE, the IDM entity decrypts the encrypted fourth message based on the second shared key K_{IDM_M}, to obtain the fourth message. Then, the IDM entity may obtain the group flag field GROUP_FLAG, the identifier M_UE_ID of the first terminal, the identifier S_UE_ID of each second terminal, and the third message authentication code MAC1.

S1106. The IDM entity performs authentication on the third message authentication code based on the second shared key, where the second shared key is the key negotiated between the first terminal and the IDM entity.

In this embodiment, for this step, refer to step S84 in FIG. 17A. Details are not described again.

S1107. After determining that authentication on the third message authentication code succeeds, the IDM entity generates a group identifier.

In this embodiment, for this step, refer to step S85 in FIG. 17A. Details are not described again.

S1108. The IDM entity generates a fourth message authentication code based on the second shared key, where the second shared key is the key negotiated between the first terminal and the IDM entity.

In this embodiment, for this step, refer to step S86 in FIG. 17A. Details are not described again.

S1109. The IDM entity encrypts a fifth message based on the second shared key, to generate an encrypted fifth message, where the fifth message includes the group identifier, the identifier of the first terminal, the identifier of each second terminal, and the fourth message authentication code.

In this embodiment, the IDM entity adds, to a fifth message, the group identifier GROUP_ID, the identifier M_UE_ID of the first terminal, the identifier S_UE_ID of each second terminal, and the fourth message authentication code MAC2; and then the IDM entity encrypts the fifth message based on the second shared key K_{IDM_M}, to obtain the encrypted fifth message.

For example, the fifth message includes <(GROUP_ID, M_UE_ID, S_UE_ID1, S_UE_ID2, MAC2) K_{IDM_M}>. GROUP_ID is the group identifier, M_UE_ID is the ID of the first terminal M_UE, S_UE_ID1 is the ID of the second terminal S_UE1, S_UE_ID2 is the ID of the second terminal S_UE2, and MAC2 is a message authentication code that is generated for the entire fifth message based on the second shared key K_{IDM_M}. In addition, entire second information is encrypted based on the symmetric key K_{IDM_M} for the first terminal M_UE and the IDM entity.

S1110a. The IDM entity sends the encrypted fifth message to the first terminal.

S1110b. The IDM entity sends group information to an IKMS entity, where the group information includes the group identifier, the identifier of the first terminal, and the identifier of each second terminal.

In this embodiment, the IDM entity sends the encrypted fifth message to the first terminal, and the IDM entity sends the generated group information to the IKMS entity, where the group information includes the group flag field GROUP_FLAG, the identifier M_UE_ID of the first terminal, the identifier S_UE_ID of each second terminal, and the group identifier GROUP_ID.

A sequence of the step of sending, by the IDM entity, the encrypted fifth message to the first terminal and the step of sending, by the IDM entity, the generated group information to the IKMS entity is not limited.

S1111. The first terminal decrypts the encrypted fifth message based on the second shared key, to obtain the fifth message.

In this embodiment, the first terminal M_UE decrypts the encrypted fifth message based on the second shared key K_{IDM_M}, to obtain the group identifier GROUP_ID, the identifier M_UE_ID of the first terminal, the identifier S_UE_ID of each second terminal, and the fourth message authentication code MAC2.

S1112. The first terminal performs authentication on the fourth message authentication code based on the second shared key, where the second shared key is the key negotiated between the first terminal and the IDM entity.

In this embodiment, for this step, refer to step S88 in FIG. 17A. Details are not described again.

S1113. After determining that authentication on the fourth message authentication code succeeds, the first terminal stores the group information, where the group information includes the group identifier, the identifier of the first terminal, and the identifier of each second terminal.

In this embodiment, for this step, refer to step S89 in FIG. 17A. Details are not described again.

S1114. The first terminal sends a group joining response message to each second terminal, where the group joining response message includes the group identifier.

In this embodiment, for this step, refer to step S891 in FIG. 17A. Details are not described again.

Step S1101 to step S1114 are a process in which a plurality of second terminals S_UE and one first terminal M-UE complete group creation.

S1115. Each second terminal sends a first half session key parameter corresponding to the second terminal and the identifier of the second terminal to the first terminal.

In this embodiment, for this step, refer to step S892 in FIG. 17A. Details are not described again.

S1116. The first terminal generates a first message authentication code based on a first shared key, where the first shared key is a key negotiated between the first terminal and the IKMS entity.

In one embodiment, the first shared key includes a first key for generating the message authentication code and a second key for data encryption.

In this embodiment, for this step, refer to step S893 in FIG. 17B. Details are not described again.

S1117a. The first terminal encrypts a first message based on the first shared key, to obtain an encrypted first message, where the first message includes the first half session key parameter corresponding to each second terminal, the identifier of the second terminal, and the first message authentication code.

In this embodiment, the first terminal M_UE adds, to a first message, the first half session key parameter XA corresponding to each second terminal S_UE, the identifier S_UE_ID of the second terminal, and the first message authentication code MAC3; and then the first terminal M_UE encrypts the first message based on the first shared key K_{IKMS_M}, to obtain the encrypted first message. The first shared key K_{IKMS_M} is a symmetric key.

For example, when there are two second terminals, message content of the first message is <(XA1, S_UE_ID1, XA2, S_UE_ID2, MAC3) K_{IKMS_M}>. XA1 is a first half session key parameter corresponding to the second terminal S_UE1, S_UE_ID1 is the ID of the second terminal S_UE1, XA2 is a first half session key parameter corresponding to the second terminal S_UE2, S_UE_ID2 is the ID of the second terminal S_UE2, MAC3 is a message authentication code that is generated by the first terminal M_UE for the entire first message based on the first shared key K_{IKMS_M}.

S1117b. The first terminal sends the encrypted first message to the IKMS entity.

S1118. The IKMS entity decrypts the encrypted first message based on the first shared key, to obtain the first message.

In this embodiment, the IKMS entity decrypts the encrypted first message based on the first shared key K_{IKMS_M}, to obtain the first half session key parameter XA corresponding to each second terminal S_UE, the identifier S_UE_ID of the second terminal, and the first message authentication code MAC3.

S1119. The IKMS entity performs authentication on the first message authentication code based on the first shared key, where the first shared key is the key negotiated between the first terminal and the IKMS entity; and after determining that authentication on the first message authentication code succeeds, the IKMS entity generates a private key corresponding to each second terminal based on the identifier of the second terminal.

In this embodiment, for this step, refer to step S895 in FIG. 17B. Details are not described again.

S1120. The IKMS entity generates a second half session key parameter corresponding to each second terminal, and generates a symmetric key corresponding to the second terminal based on the first half session key parameter corresponding to the second terminal and the second half session key parameter corresponding to the second terminal.

In this embodiment, for this step, refer to step S896 in FIG. 17B. Details are not described again.

S1121. The IKMS entity encrypts the private key corresponding to each second terminal based on the symmetric key corresponding to the second terminal, to generate an encrypted private key corresponding to the second terminal.

In this embodiment, for this step, refer to step S897 in FIG. 17B. Details are not described again.

S1122. The IKMS entity generates a second message authentication code based on the first shared key, where the first shared key is the key negotiated between the first terminal and the IKMS entity.

In this embodiment, for this step, refer to step S898 in FIG. 17B. Details are not described again.

S1123. The IKMS entity encrypts a second message based on the first shared key, to generate an encrypted second message, where the second message includes the second half session key parameter corresponding to each second terminal, the identifier of the second terminal, the encrypted private key corresponding to the second terminal, and the second message authentication code.

In this embodiment, the IKMS entity adds, to a second message, the second half session key parameter XB corresponding to each second terminal S_UE, the identifier S_UE_ID of the second terminal, the encrypted private key (SK)_{key} corresponding to the second terminal S_UE, and the second message authentication code MAC4; and then the IKMS entity encrypts the second message based on the first shared key K_{IKMS_M}, to generate the encrypted second message.

For example, when there are two second terminals, message content of the encrypted second message is <(XB1, S_UE_ID1, (SK1)_{key1}, XB2, S_UE_ID2, (SK2)_{key2}, MAC4) K_{IKMS_M}>. XB1 is a second half session key parameter corresponding to the second terminal S_UE1, S_UE_ID1 is the ID of the second terminal S_UE1, and (SK1)_{key1} is an encrypted private key corresponding to the second terminal S_UE1. XB2 is a second half session key parameter corresponding to the second terminal S_UE2, S_UE_ID2 is the ID of the second terminal S_UE2, and (SK2)_{key2} is an encrypted private key corresponding to the second terminal S_UE2. MAC4 is a message authentication code that is generated by the first terminal M_UE for the entire second message based on the first shared key K_{IKMS_M}.

S1124. The IKMS entity sends the encrypted second message to the first terminal.

S1125. The first terminal decrypts the encrypted second message based on the first shared key, to obtain the second message.

In this embodiment, the first terminal M_UE decrypts the encrypted second message based on the first shared key K_{IKMS_M}, to obtain the second half session key parameter XB corresponding to each second terminal S_UE, the identifier S_UE_ID of the second terminal, the encrypted private key (SK)_{key} corresponding to the second terminal S_UE, and the second message authentication code MAC4.

S1126. The first terminal performs authentication on the second message authentication code based on the first shared key, where the first shared key is the key negotiated between the first terminal and the IKMS entity.

In this embodiment, after decrypting the encrypted second message, the first terminal M_UE may obtain the second message authentication code MAC4, and the first terminal M_UE needs to perform authentication on the second message authentication code MAC4. Specifically, because the first terminal M_UE has negotiated the first shared key K_{IKMS_M} with the IKMS entity, the first terminal M_UE may perform authentication on the second message authentication code MAC4 based on the first shared key K_{IKMS_M}.

S1127. After determining that authentication on the second message authentication code succeeds, the first terminal sends the second half session key parameter corresponding to each second terminal and the encrypted private key corresponding to the second terminal to the second terminal.

In this embodiment, for this step, refer to step S811 in FIG. 17B and FIG. 17C. Details are not described again.

S1128. Each second terminal generates the symmetric key based on the first half session key parameter corresponding to the second terminal and the second half session key parameter corresponding to the second terminal.

In this embodiment, for this step, refer to step S812 in FIG. 17C. Details are not described again.

S1129. Each second terminal decrypts the encrypted private key corresponding to the second terminal based on the symmetric key, to obtain the private key corresponding to the second terminal.

In this embodiment, for this step, refer to step S813 in FIG. 17C. Details are not described again.

It can be learnt that step S1115 to step S1129 are based on a symmetric key mechanism.

In this embodiment, the second terminal triggers group creation, the first terminal sends information such as the group flag field to the IDM entity, and the first terminal determines whether a group is to be created. In this way, the first terminal and the second terminal are trustworthy to each other, thereby improving a trust degree and security of the network elements in the group. In addition, characteristics of the group that can be created based on a group creation request proactively sent by the second terminal are diversified. In addition, a private key obtaining method is provided. After a group is created for terminals, the second terminal initiates a private key obtaining request, the IKMS entity generates the encrypted private key corresponding to the second terminal, and the second terminal receives, by using the first terminal, the encrypted private key corresponding to the second terminal sent by the IKMS entity. Therefore, the second terminal can relatively quickly obtain the encrypted private key corresponding to the second terminal. This can prevent the private key from being stolen, and prevent communication information between groups from being stolen. Further, encryption processing is performed during sending/receiving of the fourth message, the fifth message, the first message, and the second message, to prevent the foregoing messages from being stolen by another unauthorized device.

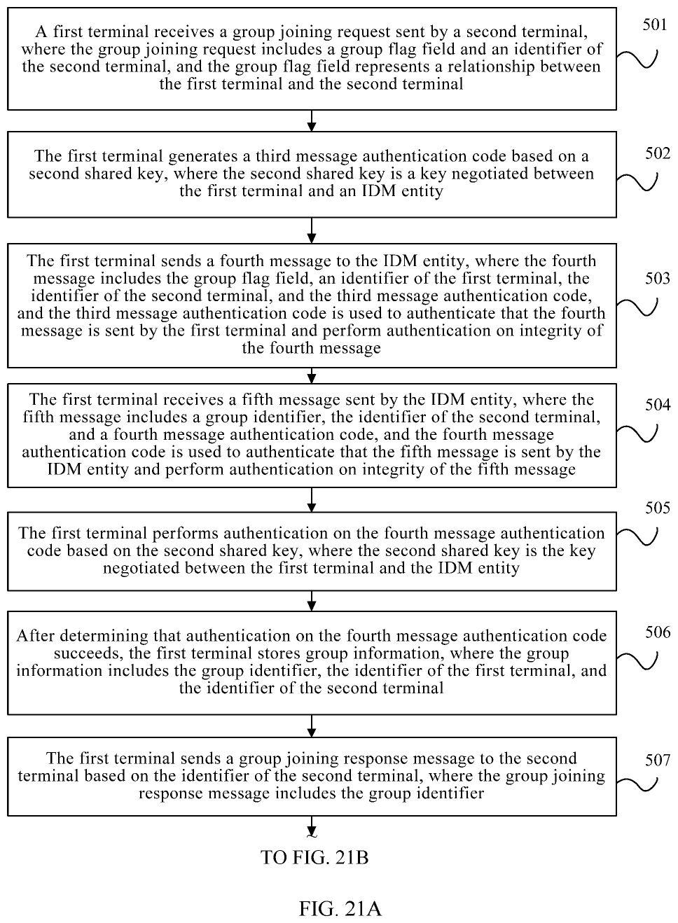

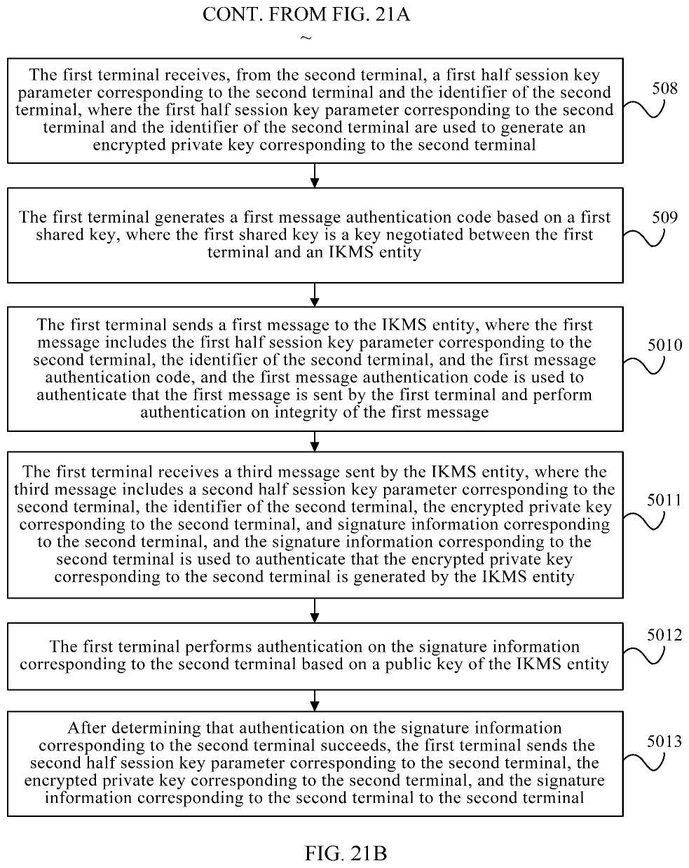

FIG. 21A and FIG. 21B are a schematic flowchart of still yet another private key generation method according to an embodiment. As shown in FIG. A and FIG. 21B, the method is as follows.

501. A first terminal receives a group joining request sent by a second terminal, where the group joining request includes a group flag field and an identifier of the second terminal, and the group flag field represents a relationship between the first terminal and the second terminal.

502. The first terminal generates a third message authentication code based on a second shared key, where the second shared key is a key negotiated between the first terminal and an IDM entity.

In one embodiment, the second shared key includes a third key for generating the message authentication code and a fourth key for data encryption.

503. The first terminal sends a fourth message to the IDM entity, where the fourth message includes the group flag field, an identifier of the first terminal, the identifier of the second terminal, and the third message authentication code, and the third message authentication code is used to authenticate that the fourth message is sent by the first terminal and perform authentication on integrity of the fourth message.

504. The first terminal receives a fifth message sent by the IDM entity, where the fifth message includes a group identifier, the identifier of the second terminal, and a fourth message authentication code, and the fourth message authentication code is used to authenticate that the fifth message is sent by the IDM entity and perform authentication on integrity of the fifth message.

505. The first terminal performs authentication on the fourth message authentication code based on the second shared key, where the second shared key is the key negotiated between the first terminal and the IDM entity.

506. After determining that authentication on the fourth message authentication code succeeds, the first terminal stores group information, where the group information includes the group identifier, the identifier of the first terminal, and the identifier of the second terminal.

507. The first terminal sends a group joining response message to the second terminal based on the identifier of the second terminal, where the group joining response message includes the group identifier.

508. The first terminal receives, from the second terminal, a first half session key parameter corresponding to the second terminal and the identifier of the second terminal, where the first half session key parameter corresponding to the second terminal and the identifier of the second terminal are used to generate an encrypted private key corresponding to the second terminal.

509. The first terminal generates a first message authentication code based on a first shared key, where the first shared key is a key negotiated between the first terminal and an IKMS entity.

In one embodiment, the first shared key includes a first key for generating the message authentication code and a second key for data encryption.

S010. The first terminal sends a first message to the IKMS entity, where the first message includes the first half session key parameter corresponding to the second terminal, the identifier of the second terminal, and the first message authentication code, and the first message authentication code is used to authenticate that the first message is sent by the first terminal and perform authentication on integrity of the first message.

S011. The first terminal receives a third message sent by the IKMS entity, where the third message includes a second half session key parameter corresponding to the second terminal, the identifier of the second terminal, the encrypted private key corresponding to the second terminal, and signature information corresponding to the second terminal, and the signature information corresponding to the second terminal is used to authenticate that the encrypted private key corresponding to the second terminal is generated by the IKMS entity.

S012. The first terminal performs authentication on the signature information corresponding to the second terminal based on a public key of the IKMS entity.

S013. After determining that authentication on the signature information corresponding to the second terminal succeeds, the first terminal sends the second half session key parameter corresponding to the second terminal, the encrypted private key corresponding to the second terminal, and the signature information corresponding to the second terminal to the second terminal.

The following uses schematic communication diagrams to describe the method in FIG. 21A and FIG. 21B.

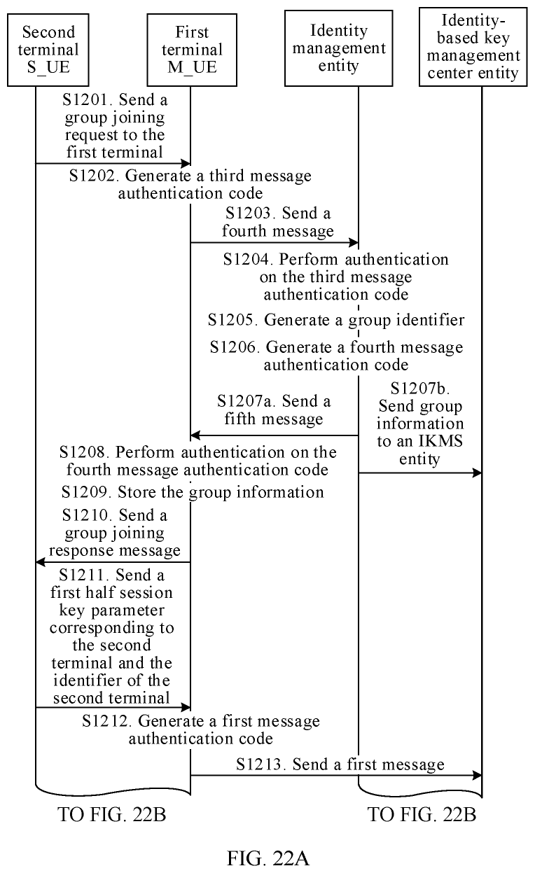

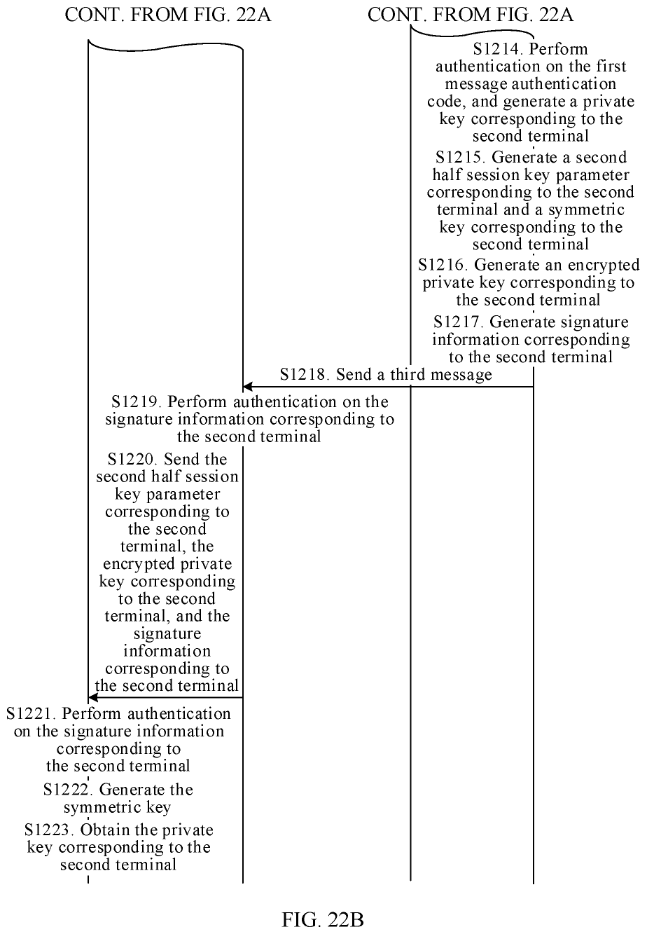

FIG. 22A and FIG. 22B are a schematic communication diagram of still yet another private key generation method according to an embodiment. FIG. 22A and FIG. 22B are a schematic communication diagram of private key generation performed between one second terminal and one first terminal. The method is as follows.

S1201. The second terminal sends a group joining request to the first terminal, where the group joining request includes a group flag field and an identifier of the second terminal, and the group flag field represents a relationship between the first terminal and the second terminal.

In this embodiment, for this step, refer to step S71 in FIG. 16A. Details are not described again.

S1202. The first terminal generates a third message authentication code based on a second shared key, where the second shared key is a key negotiated between the first terminal and an IDM entity.

In one embodiment, the second shared key includes a third key for generating the message authentication code and a fourth key for data encryption.

In this embodiment, for this step, refer to step S72 in FIG. 16A. Details are not described again.

S1203. The first terminal sends a fourth message to the IDM entity, where the fourth message includes the group flag field, an identifier of the first terminal, the identifier of the second terminal, and the third message authentication code, and the third message authentication code is used to authenticate that the fourth message is sent by the first terminal and perform authentication on integrity of the fourth message.

In this embodiment, for this step, refer to step S73 in FIG. 16A. Details are not described again.

S1204. The IDM entity performs authentication on the third message authentication code based on the second shared key, where the second shared key is the key negotiated between the first terminal and the IDM entity.

In this embodiment, for this step, refer to step S74 in FIG. 16A. Details are not described again.

S1205. After determining that authentication on the third message authentication code succeeds, the IDM entity generates a group identifier.

In this embodiment, for this step, refer to step S75 in FIG. 16A. Details are not described again.

S1206. The IDM entity generates a fourth message authentication code based on the second shared key, where the second shared key is the key negotiated between the first terminal and the IDM entity.

In this embodiment, for this step, refer to step S76 in FIG. 16A. Details are not described again.

S1207a. The IDM entity sends a fifth message to the first terminal, where the fifth message includes the group identifier, the identifier of the second terminal, and the fourth message authentication code, and the fourth message authentication code is used to authenticate that the fifth message is sent by the IDM entity and perform authentication on integrity of the fifth message.

S1207b. The IDM entity sends group information to an IKMS entity, where the group information includes the group identifier, the identifier of the first terminal, and the identifier of the second terminal.

In this embodiment, for this step, refer to step S77 in FIG. 16A. Details are not described again.

S1208. The first terminal performs authentication on the fourth message authentication code based on the second shared key, where the second shared key is the key negotiated between the first terminal and the IDM entity.

In this embodiment, for this step, refer to step S78 in FIG. 16A. Details are not described again.

S1209. After determining that authentication on the fourth message authentication code succeeds, the first terminal stores the group information, where the group information includes the group identifier, the identifier of the first terminal, and the identifier of the second terminal.

In this embodiment, for this step, refer to step S79 in FIG. 16A. Details are not described again.

S1210. The first terminal sends a group joining response message to the second terminal based on the identifier of the second terminal, where the group joining response message includes the group identifier.

In this embodiment, for this step, refer to step S791 in FIG. 16A. Details are not described again.

Step S1201 to step S1210 are a process in which one second terminal S_UE and one first terminal M-UE complete group creation.

S1211. The second terminal sends a first half session key parameter corresponding to the second terminal and the identifier of the second terminal to the first terminal, where the first half session key parameter corresponding to the second terminal and the identifier of the second terminal are used to generate an encrypted private key corresponding to the second terminal.

In this embodiment, for this step, refer to step S792 in FIG. 16A. Details are not described again.

S1212. The first terminal generates a first message authentication code based on a first shared key, where the first shared key is a key negotiated between the first terminal and the IKMS entity.

In one embodiment, for this step, refer to step S793 in FIG. 16A. Details are not described again.

S1213. The first terminal sends a first message to the IKMS entity, where the first message includes the first half session key parameter corresponding to the second terminal, the identifier of the second terminal, and the first message authentication code, and the first message authentication code is used to authenticate that the first message is sent by the first terminal and perform authentication on integrity of the first message.

In this embodiment, for this step, refer to step S794 in FIG. 16A. Details are not described again.

S1214. The IKMS entity performs authentication on the first message authentication code based on the first shared key, where the first shared key is the key negotiated between the first terminal and the IKMS entity; and after determining that authentication on the first message authentication code succeeds, the IKMS entity generates a private key corresponding to the second terminal based on the identifier of the second terminal.

In this embodiment, for this step, refer to step S795 in FIG. 16B. Details are not described again.

S1215. The IKMS entity generates a second half session key parameter corresponding to the second terminal, and generates a symmetric key corresponding to the second terminal based on the first half session key parameter corresponding to the second terminal and the second half session key parameter corresponding to the second terminal.

In this embodiment, for this step, refer to step S796 in FIG. 16B. Details are not described again.

S1216. The IKMS entity encrypts the private key corresponding to the second terminal based on the symmetric key corresponding to the second terminal, to generate the encrypted private key corresponding to the second terminal.

In this embodiment, for this step, refer to step S797 in FIG. 16B. Details are not described again.

S1217. The IKMS entity generates signature information corresponding to the second terminal based on a private key of the IKMS entity, where the signature information corresponding to the second terminal is used to authenticate that the encrypted private key corresponding to the second terminal is generated by the IKMS entity.

In this embodiment, the IKMS entity adds, to a third message, the second half session key parameter XB corresponding to the second terminal S_UE, the identifier S_UE_ID of the second terminal S_UE, and the encrypted private key SK corresponding to the second terminal S_UE; and then the IKMS entity generates the signature information SIG corresponding to the second terminal S_UE based on the private key of the IKMS entity.

S1218. The IKMS entity sends the third message to the first terminal, where the third message includes the second half session key parameter corresponding to the second terminal, the identifier of the second terminal, the encrypted private key corresponding to the second terminal, and the signature information corresponding to the second terminal.

In this embodiment, after generating the signature information SIG corresponding to the second terminal S_UE, the IKMS entity sends the signed third message to the first terminal M_UE. In this case, the third message includes the second half session key parameter XB corresponding to the second terminal S_UE, the identifier S_UE_ID of the second terminal S_UE, the encrypted private key SK corresponding to the second terminal S_UE, and the signature information SIG corresponding to the second terminal SUE.

For example, content of the third message is <XB, S_UE (SK)key, SIG>.

S1219. The first terminal performs authentication on the signature information corresponding to the second terminal based on a public key of the IKMS entity.

In this embodiment, the first terminal M_UE performs authentication on the signature information SIG corresponding to the second terminal S_UE based on the public key of the IKMS entity.

S1220. After determining that authentication on the signature information corresponding to the second terminal succeeds, the first terminal sends the second half session key parameter corresponding to the second terminal, the encrypted private key corresponding to the second terminal, and the signature information corresponding to the second terminal to the second terminal.

In this embodiment, after determining that authentication on the signature information SIG corresponding to the second terminal S_UE succeeds, the first terminal M_UE sends the second half session key parameter XB corresponding to the second terminal S_UE, the encrypted private key SK corresponding to the second terminal S_UE, and the signature information SIG corresponding to the second terminal SUE to the second terminal S_UE based on the identifier SUED of the second terminal SUE.

For example, the first terminal M_UE sends the message <XB, (SK)key, SIG> to the second terminal S_UE.

S1221. The second terminal performs authentication on the signature information corresponding to the second terminal.

In this embodiment, the second terminal S_UE verifies whether the signature information SIG corresponding to the second terminal S_UE is tampered with.

S1222. After determining that authentication on the signature information corresponding to the second terminal succeeds, the second terminal generates the symmetric key based on the first half session key parameter corresponding to the second terminal and the second half session key parameter corresponding to the second terminal.

In this embodiment, if determining that the signature information SIG corresponding to the second terminal S_UE is generated by the IKMS entity and is not tampered with, the second terminal S_UE determines that authentication on the signature information SIG corresponding to the second terminal S_UE succeeds; and then the second terminal S_UE calculates the symmetric key key based on the first half session key parameter XA, generated by the second terminal S_UE, corresponding to the second terminal S_UE and the received second half session key parameter XB corresponding to the second terminal SUE.

S1223. The second terminal decrypts the encrypted private key corresponding to the second terminal based on the symmetric key, to obtain the private key corresponding to the second terminal.

In this embodiment, the second terminal S_UE decrypts the encrypted private key (SK)_{key} corresponding to the second terminal S_UE based on the calculated symmetric key key, to obtain the private key SK corresponding to the second terminal S_UE. In this way, obtaining an initial key by the second terminal S_UE is completed.

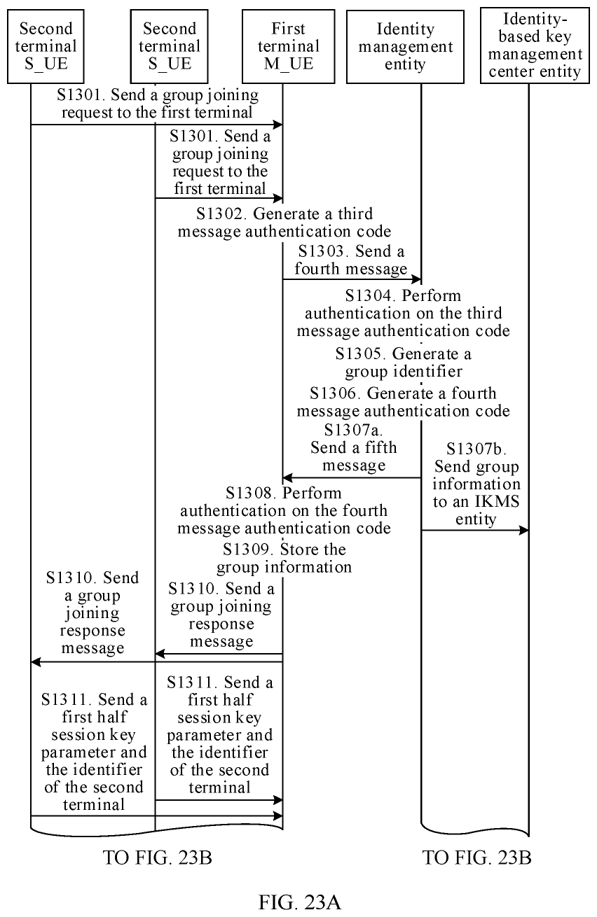

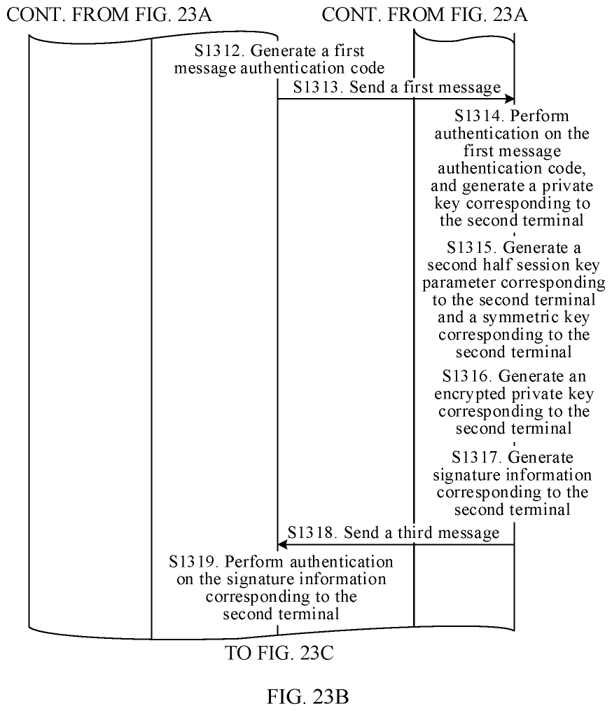

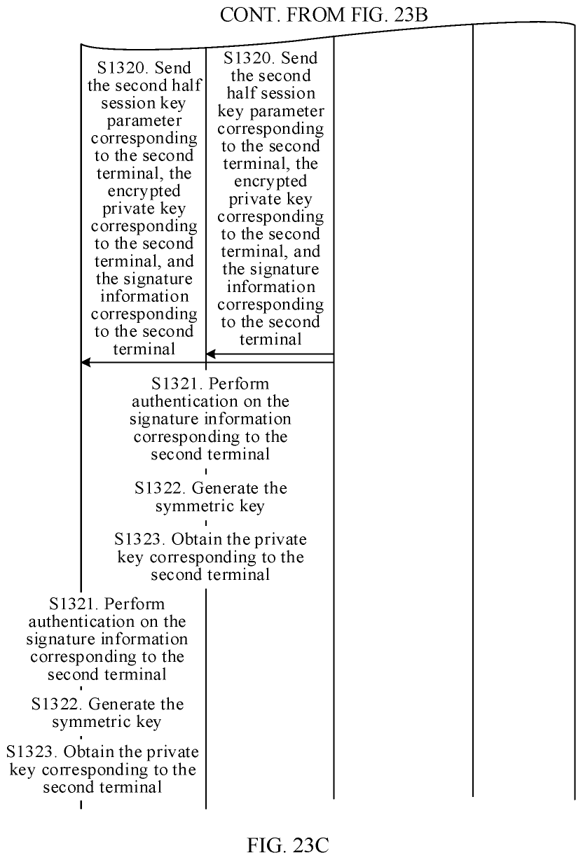

FIG. 23A to FIG. 23C are a schematic communication diagram 2 of still yet another private key generation method according to an embodiment. FIG. 23A to FIG. 23C are a schematic communication diagram of private key generation performed between at least two second terminals and one first terminal. The method is as follows.

S1301. Each second terminal sends a group joining request to the first terminal, where the group joining request includes a group flag field and an identifier of the second terminal, and the group flag field represents a relationship between the first terminal and the second terminal.

In this embodiment, for this step, refer to step S81 in FIG. 17A. Details are not described again.

S1302. The first terminal generates a third message authentication code based on a second shared key, where the second shared key is a key negotiated between the first terminal and an IDM entity.

In one embodiment, the second shared key includes a third key for generating the message authentication code and a fourth key for data encryption.

In this embodiment, for this step, refer to step S82 in FIG. 17A. Details are not described again.

S1303. The first terminal sends a fourth message to the IDM entity, where the fourth message includes the group flag field, an identifier of the first terminal, the identifier of the second terminal, and the third message authentication code, and the third message authentication code is used to authenticate that the fourth message is sent by the first terminal and perform authentication on integrity of the fourth message.

In this embodiment, for this step, refer to step S83 in FIG. 17A. Details are not described again.

S1304. The IDM entity performs authentication on the third message authentication code based on the second shared key, where the second shared key is the key negotiated between the first terminal and the IDM entity.

In this embodiment, for this step, refer to step S84 in FIG. 17A. Details are not described again.

S1305. After determining that authentication on the third message authentication code succeeds, the IDM entity generates a group identifier.

In this embodiment, for this step, refer to step S85 in FIG. 17A. Details are not described again.

S1306. The IDM entity generates a fourth message authentication code based on the second shared key, where the second shared key is the key negotiated between the first terminal and the IDM entity.

In this embodiment, for this step, refer to step S86 in FIG. 17A. Details are not described again.

S1307a. The IDM entity sends a fifth message to the first terminal, where the fifth message includes the group identifier, the identifier of the first terminal, the identifier of each second terminal, and the fourth message authentication code.

S1307b. The IDM entity sends group information to an IKMS entity, where the group information includes the group identifier, the identifier of the first terminal, and the identifier of the second terminal.

In this embodiment, for this step, refer to step S87 in FIG. 17A. Details are not described again.

S1308. The first terminal performs authentication on the fourth message authentication code based on the second shared key, where the second shared key is the key negotiated between the first terminal and the IDM entity.

In this embodiment, for this step, refer to step S88 in FIG. 17A. Details are not described again.

S1309. After determining that authentication on the fourth message authentication code succeeds, the first terminal stores the group information, where the group information includes the group identifier, the identifier of the first terminal, and the identifier of each second terminal.

In this embodiment, for this step, refer to step S89 in FIG. 17A. Details are not described again.

S1310. The first terminal sends a group joining response message to each second terminal, where the group joining response message includes the group identifier.

In this embodiment, for this step, refer to step S891 in FIG. 17A. Details are not described again.

Step S1301 to step S1310 are a process in which a plurality of second terminals S_UE and one first terminal M-UE complete group creation.

S1311. Each second terminal sends a first half session key parameter corresponding to the second terminal and the identifier of the second terminal to the first terminal.

In this embodiment, for this step, refer to step S892 in FIG. 17A. Details are not described again.

S1312. The first terminal generates a first message authentication code based on a first shared key, where the first shared key is a key negotiated between the first terminal and the IKMS entity.

In one embodiment, the first shared key includes a first key for generating the message authentication code and a second key for data encryption.

In this embodiment, for this step, refer to step S893 in FIG. 17B. Details are not described again.

S1313. The first terminal sends a first message to the IKMS entity, where the first message includes the first half session key parameter corresponding to each second terminal, the identifier of the second terminal, and the first message authentication code.

In this embodiment, for this step, refer to step S894 in FIG. 17B. Details are not described again.

S1314. The IKMS entity performs authentication on the first message authentication code based on the first shared key, where the first shared key is the key negotiated between the first terminal and the IKMS entity; and after determining that authentication on the first message authentication code succeeds, the IKMS entity generates a private key corresponding to each second terminal based on the identifier of the second terminal.

In this embodiment, for this step, refer to step S895 in FIG. 17B. Details are not described again.

S1315. The IKMS entity generates a second half session key parameter corresponding to each second terminal, and generates a symmetric key corresponding to the second terminal based on the first half session key parameter corresponding to the second terminal and the second half session key parameter corresponding to the second terminal.

In this embodiment, for this step, refer to step S896 in FIG. 17B. Details are not described again.

S1316. The IKMS entity encrypts the private key corresponding to each second terminal based on the symmetric key corresponding to the second terminal, to generate an encrypted private key corresponding to the second terminal.

In this embodiment, for this step, refer to step S897 in FIG. 17B. Details are not described again.

S1317. The IKMS entity generates signature information corresponding to the second terminal based on a private key of the IKMS entity, where the signature information corresponding to the second terminal is used to authenticate that the encrypted private key corresponding to the second terminal is generated by the IKMS entity.

In this embodiment, the IKMS entity generates the signature information SIG corresponding to each second terminal S_UE for related information of the second terminal S_UE based on the private key of the IKMS entity. The related information is the second half session key parameter XB corresponding to the second terminal S_UE, the identifier S_UE_ID of the second terminal S_UE, and the encrypted private key SK corresponding to the second terminal SUE.

For example, the IKMS entity generates signature information SIG1 corresponding to a second terminal S_UE1 for related information of the second terminal S_UE1 based on the private key of the IKMS entity. The related information of the second terminal S_UE1 includes a second half session key parameter XB1 corresponding to the second terminal S_UE1, an identifier S_UE_ID1 of the second terminal, and an encrypted private key (SK1)_{key1} corresponding to the second terminal S_UE1. The IKMS entity generates signature information SIG2 corresponding to a second terminal S_UE2 for related information of the second terminal S_UE2 based on the private key of the IKMS entity. The related information of the second terminal S_UE2 includes a second half session key parameter XB2 corresponding to the second terminal S_UE2, an identifier S_UE_ID2 of the second terminal, and an encrypted private key (SK2)_{key2} corresponding to the second terminal S_UE12.

S1318. The IKMS entity sends a third message to the first terminal, where the third message includes the second half session key parameter corresponding to each second terminal, the identifier of the second terminal, the encrypted private key corresponding to the second terminal, and the signature information corresponding to the second terminal.

In this embodiment, after generating the signature information SIG for each second terminal, the IKMS entity obtains the third message. The third message includes the second half session key parameter XB corresponding to each second terminal S_UE, the identifier S_UE_ID of the second terminal S_UE, the encrypted private key SK corresponding to the second terminal S_UE, and the signature information SIG corresponding to the second terminal.

For example, content of the third message is <<XB1, S_UE_ID1, (SK1)_{key1}>SIG1, <XB2, S_UE_ID2, (SK2)_{key2}>SIG2>.

Then, the IKMS entity sends the signed third message to the first terminal M_UE.

S1319. Each first terminal performs authentication on the signature information corresponding to each second terminal based on a public key of the IKMS entity.

In this embodiment, the first terminal M_UE separately performs authentication on all signature information SIG based on the public key of the IKMS entity.

For example, the first terminal M_UE separately performs authentication on SIG1 and SIG2 based on the public key of the IKMS.

S1320. After determining that authentication on the signature information corresponding to the second terminal succeeds, the first terminal sends the second half session key parameter corresponding to the second terminal, the encrypted private key corresponding to the second terminal, and the signature information corresponding to the second terminal to the second terminal.

In this embodiment, for each second terminal S_UE, after the first terminal M_UE determines that authentication on the signature information SIG corresponding to the second terminal S_UE succeeds, the first terminal M_UE sends the second half session key parameter XB corresponding to the second terminal S_UE, the encrypted private key SK corresponding to the second terminal S_UE, the identifier of the second terminal S_UE, and the signature information SIG corresponding to the second terminal S_UE to the second terminal S_UE based on the identifier S_UE_ID of the second terminal SUE.

For example, the first terminal M_UE sends the message <XB1, S_UE_ID1, (SK1)_{key1}>SIG1 to the second terminal S_UE1, and sends the message <XB2, S_UE_ID2, (SK2)_{key2}>SIG2 to the second terminal S_UE2.

S1321. Each second terminal performs authentication on the signature information corresponding to the second terminal.

In this embodiment, each second terminal S_UE verifies whether the signature information SIG corresponding to the second terminal S_UE is tampered with.

For example, the second terminal S_UE1 verifies whether SIG1 is tampered with, and the second terminal S_UE2 verifies whether SIG2 is tampered with.

S1322. After determining that authentication on the signature information corresponding to each second terminal succeeds, the second terminal generates the symmetric key based on the first half session key parameter corresponding to the second terminal and the second half session key parameter corresponding to the second terminal.

In this embodiment, if determining that the signature information SIG corresponding to the second terminal S_UE is generated by the IKMS entity and is not tampered with, the second terminal S_UE determines that authentication on the signature information SIG corresponding to the second terminal S_UE succeeds; and then the second terminal S_UE calculates the symmetric key key based on the first half session key parameter XA, generated by the second terminal S_UE, corresponding to the second terminal S_UE and the received second half session key parameter XB corresponding to the second terminal SUE.

S1323. Each second terminal decrypts the encrypted private key corresponding to the second terminal based on the symmetric key, to obtain the private key corresponding to the second terminal.

In this embodiment, the second terminal S_UE decrypts the encrypted private key (SK)_{key} corresponding to the second terminal S_UE based on the calculated symmetric key key, to obtain the private key SK corresponding to the second terminal S_UE. In this way, obtaining an initial key by the second terminal S_UE is completed.

For example, the second terminal S_UE1 determines that authentication on the signature information SIG1 corresponding to the second terminal S_UE1 succeeds. The second terminal S_UE1 first generates, through calculation, a symmetric key key1 based on the received second half session key parameter XB1 corresponding to the second terminal S_UE1 and a first half session key parameter XA1 generated by the second terminal S_UE1. Then, the second terminal S_UE1 decrypts (SK1)_{key1} based on the key key1, to obtain a private key SK1 corresponding to the second terminal S_UE1. In this way, obtaining an initial key by the second terminal S_UE1 is completed. The second terminal S_UE2 determines that authentication on the signature information SIG2 corresponding to the second terminal S_UE2 succeeds. The second terminal S_UE2 first generates, through calculation, a symmetric key key2 based on the received second half session key parameter XB2 corresponding to the second terminal S_UE2 and a first half session key parameter XA2 generated by the second terminal S_UE2. Then, the second terminal S_UE2 decrypts (SK2)_{key2} based on the key key2, to obtain a private key SK2 corresponding to the second terminal S_UE2. In this way, obtaining an initial key by the second terminal S_UE2 is completed.

It can be learnt that an asymmetric key mechanism is used for step S1311 to step S1323.

In this embodiment, the second terminal triggers group creation, the first terminal sends information such as the group flag field to the IDM entity, and the first terminal determines whether a group is to be created. In this way, the first terminal and the second terminal are trustworthy to each other, thereby improving a trust degree and security of the network elements in the group. In addition, characteristics of the group that can be created based on a group creation request proactively sent by the second terminal are diversified. In addition, a private key obtaining method is provided. After a group is created for terminals, the second terminal initiates a private key obtaining request, and the IKMS entity generates the encrypted private key corresponding to the second terminal. Moreover, the IKMS entity processes the encrypted private key corresponding to the second terminal by using the signature information corresponding to the second terminal. This prevents the encrypted private key corresponding to the second terminal from being tampered with by another terminal during transmission, can ensure that the encrypted private key corresponding to the second terminal is not tampered with or stolen by the another terminal, and prevents communication information between groups from being stolen. Furthermore, the second terminal can relatively quickly obtain the encrypted private key corresponding to the second terminal.

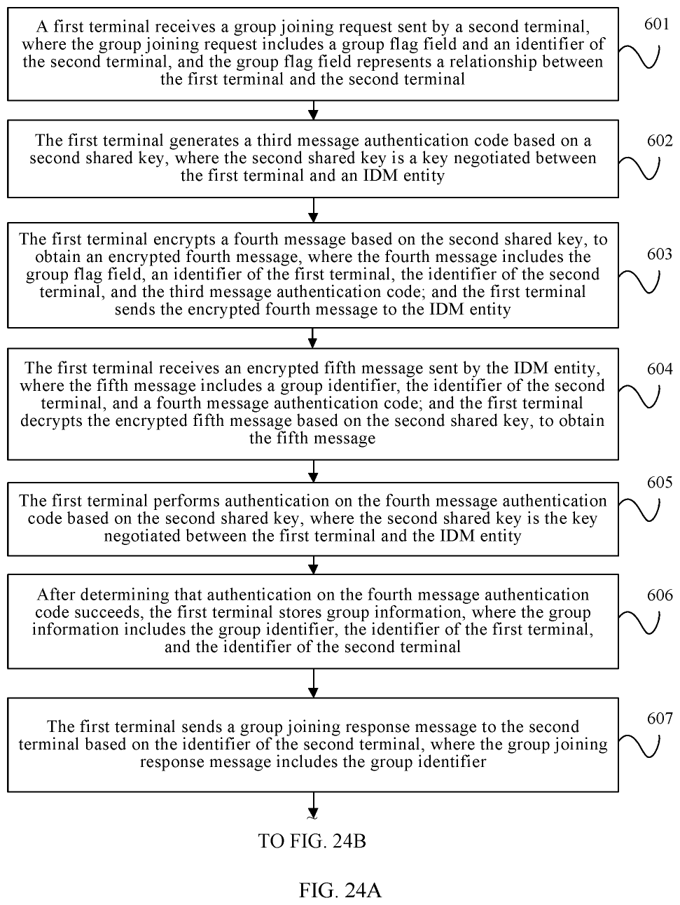

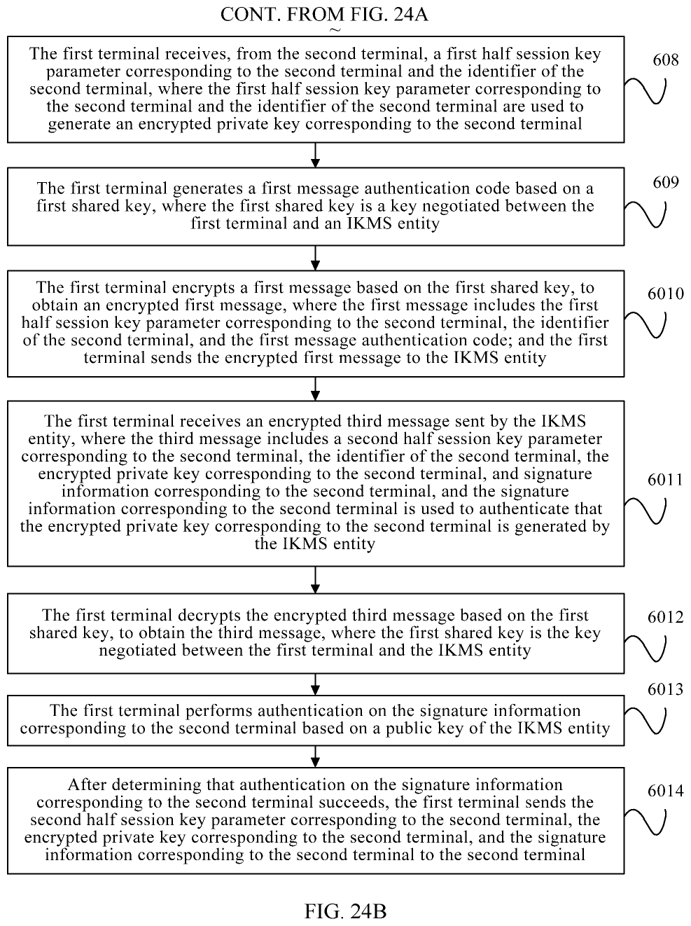

FIG. 24A and FIG. 24B are a schematic flowchart of a further private key generation method according to an embodiment. As shown in FIG. 24A and FIG. 24B, the method is as follows.

601. A first terminal receives a group joining request sent by a second terminal, where the group joining request includes a group flag field and an identifier of the second terminal, and the group flag field represents a relationship between the first terminal and the second terminal.

602. The first terminal generates a third message authentication code based on a second shared key, where the second shared key is a key negotiated between the first terminal and an IDM entity.

In one embodiment, the second shared key includes a third key for generating the message authentication code and a fourth key for data encryption.

603. The first terminal encrypts a fourth message based on the second shared key, to obtain an encrypted fourth message, where the fourth message includes the group flag field, an identifier of the first terminal, the identifier of the second terminal, and the third message authentication code, and the third message authentication code is used to authenticate that the fourth message is sent by the first terminal and perform authentication on integrity of the fourth message; and the first terminal sends the encrypted fourth message to the IDM entity.

604. The first terminal receives an encrypted fifth message sent by the IDM entity, where the fifth message includes a group identifier, the identifier of the second terminal, and a fourth message authentication code, and the fourth message authentication code is used to authenticate that the fifth message is sent by the IDM entity and perform authentication on integrity of the fifth message; and the first terminal decrypts the encrypted fifth message based on the second shared key, to obtain the fifth message.

605. The first terminal performs authentication on the fourth message authentication code based on the second shared key, where the second shared key is the key negotiated between the first terminal and the IDM entity.

606. After determining that authentication on the fourth message authentication code succeeds, the first terminal stores group information, where the group information includes the group identifier, the identifier of the first terminal, and the identifier of the second terminal.

607. The first terminal sends a group joining response message to the second terminal based on the identifier of the second terminal, where the group joining response message includes the group identifier.

608. The first terminal receives, from the second terminal, a first half session key parameter corresponding to the second terminal and the identifier of the second terminal, where the first half session key parameter corresponding to the second terminal and the identifier of the second terminal are used to generate an encrypted private key corresponding to the second terminal.

609. The first terminal generates a first message authentication code based on a first shared key, where the first shared key is a key negotiated between the first terminal and an IKMS entity.

In one embodiment, the first shared key includes a first key for generating the message authentication code and a second key for data encryption.

6010. The first terminal encrypts a first message based on the first shared key, to obtain an encrypted first message, where the first message includes the first half session key parameter corresponding to the second terminal, the identifier of the second terminal, and the first message authentication code, and the first message authentication code is used to authenticate that the first message is sent by the first terminal and perform authentication on integrity of the first message; and the first terminal sends the encrypted first message to the IKMS entity.

6011. The first terminal receives an encrypted third message sent by the IKMS entity, where the third message includes a second half session key parameter corresponding to the second terminal, the identifier of the second terminal, the encrypted private key corresponding to the second terminal, and signature information corresponding to the second terminal, and the signature information corresponding to the second terminal is used to authenticate that the encrypted private key corresponding to the second terminal is generated by the IKMS entity.

6012. The first terminal decrypts the encrypted third message based on the first shared key, to obtain the third message, where the first shared key is the key negotiated between the first terminal and the IKMS entity.

6013. The first terminal performs authentication on the signature information corresponding to the second terminal based on a public key of the IKMS entity.

6014. After determining that authentication on the signature information corresponding to the second terminal succeeds, the first terminal sends the second half session key parameter corresponding to the second terminal, the encrypted private key corresponding to the second terminal, and the signature information corresponding to the second terminal to the second terminal.

The following uses schematic communication diagrams to describe the method in FIG. 24A and FIG. 24B.

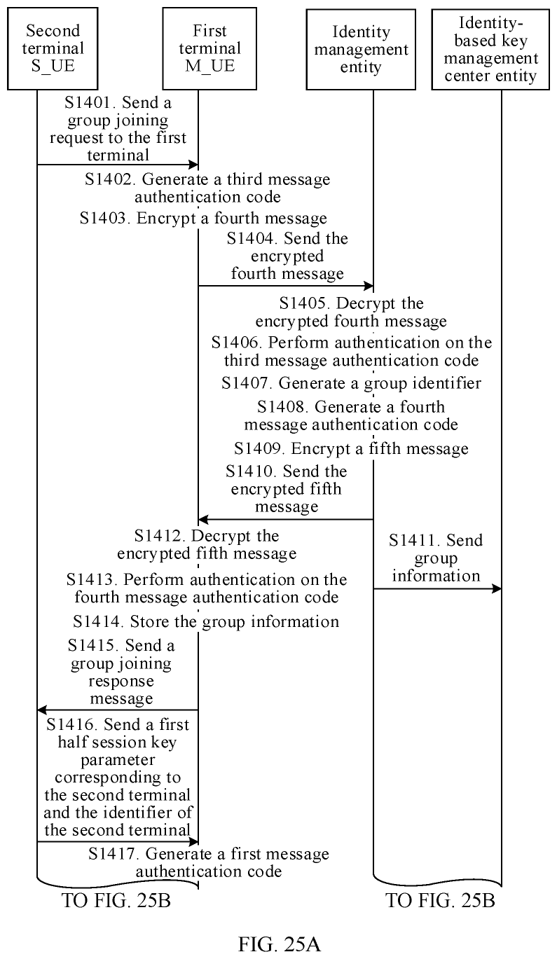

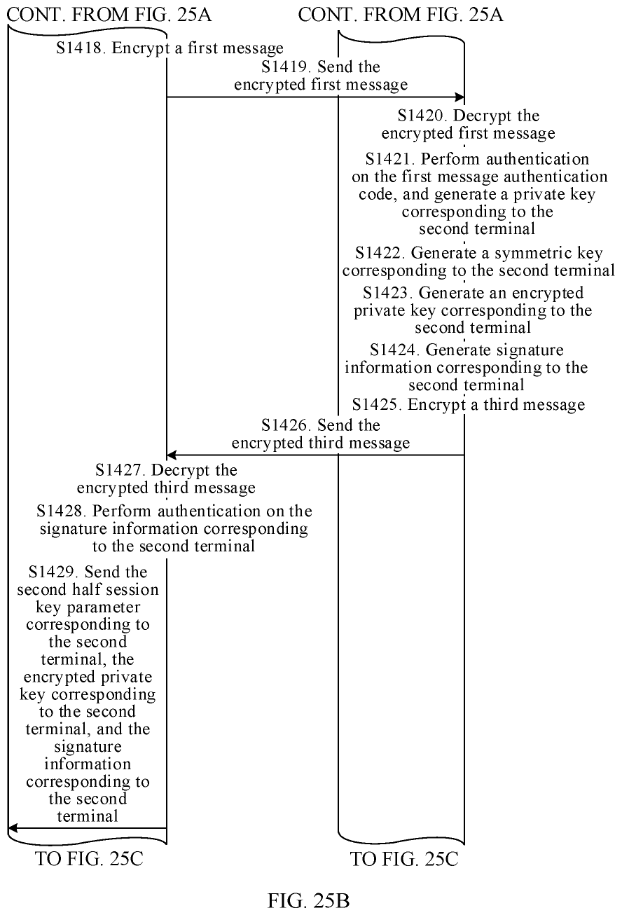

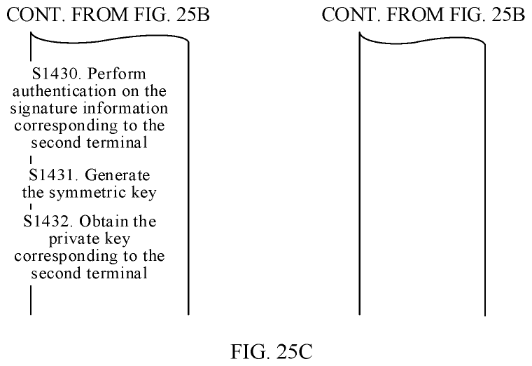

FIG. 25A to FIG. 25C are a schematic communication diagram of a further private key generation method according to an embodiment. FIG. 25A to FIG. 25C are a schematic communication diagram of private key generation performed between one second terminal and one first terminal. The method is as follows.

S1401. The second terminal sends a group joining request to the first terminal, where the group joining request includes a group flag field and an identifier of the second terminal, and the group flag field represents a relationship between the first terminal and the second terminal.

In this embodiment, for this step, refer to step S71 in FIG. 16A. Details are not described again.

S1402. The first terminal generates a third message authentication code based on a second shared key, where the second shared key is a key negotiated between the first terminal and an IDM entity.

In one embodiment, the second shared key includes a third key for generating the message authentication code and a fourth key for data encryption.

In this embodiment, for this step, refer to step S72 in FIG. 16A. Details are not described again.

S1403. The first terminal encrypts a fourth message based on the second shared key, to obtain an encrypted fourth message, where the fourth message includes the group flag field, an identifier of the first terminal, the identifier of the second terminal, and the third message authentication code, and the third message authentication code is used to authenticate that the fourth message is sent by the first terminal and perform authentication on integrity of the fourth message.

In this embodiment, for this step, refer to step S93 in FIG. 19A. Details are not described again.

S1404. The first terminal sends the encrypted fourth message to the IDM entity.

S1405. The IDM entity decrypts the encrypted fourth message based on the second shared key, to obtain the fourth message, where the second shared key is the key negotiated between the first terminal and the IDM entity.

In this embodiment, for this step, refer to step S95 in FIG. 19A. Details are not described again.

S1406. The IDM entity performs authentication on the third message authentication code based on the second shared key.

In this embodiment, for this step, refer to step S96 in FIG. 19A. Details are not described again.

S1407. After determining that authentication on the third message authentication code succeeds, the IDM entity generates a group identifier.

In this embodiment, for this step, refer to step S75 in FIG. 16A. Details are not described again.

S1408. The IDM entity generates a fourth message authentication code based on the second shared key, where the second shared key is the key negotiated between the first terminal and the IDM entity.

In this embodiment, for this step, refer to step S76 in FIG. 16A. Details are not described again.

S1409. The IDM entity encrypts a fifth message based on the second shared key, to generate an encrypted fifth message, where the fifth message includes the group identifier, the identifier of the second terminal, and the fourth message authentication code, and the fourth message authentication code is used to authenticate that the fifth message is sent by the IDM entity and perform authentication on integrity of the fifth message.

In this embodiment, for this step, refer to step S99 in FIG. 19A. Details are not described again.

S1410. The IDM entity sends the encrypted fifth message to the first terminal.

S1411. The IDM entity sends group information to an IKMS entity, where the group information includes the group identifier, the identifier of the first terminal, and the identifier of the second terminal.

In this embodiment, for this step, refer to step S991b in FIG. 19A. Details are not described again.

A sequence of the step of sending, by the IDM entity, the encrypted fifth message to the first terminal and the step of sending, by the IDM entity, the generated group information to the IKMS entity is not limited.

S1412. The first terminal decrypts the encrypted fifth message based on the second shared key, to obtain the fifth message.

In this embodiment, for this step, refer to step S992 in FIG. 19A. Details are not described again.

S1413. The first terminal performs authentication on the fourth message authentication code based on the second shared key, where the second shared key is the key negotiated between the first terminal and the IDM entity.

In this embodiment, for this step, refer to step S78 in FIG. 16A. Details are not described again.

S1414. After determining that authentication on the fourth message authentication code succeeds, the first terminal stores the group information, where the group information includes the group identifier, the identifier of the first terminal, and the identifier of the second terminal.

In this embodiment, for this step, refer to step S79 in FIG. 16A. Details are not described again.

S1415. The first terminal sends a group joining response message to the second terminal based on the identifier of the second terminal, where the group joining response message includes the group identifier.

In this embodiment, for this step, refer to step S791 in FIG. 16A. Details are not described again.

Step S1401 to step S1415 are a process in which one second terminal S_UE and one first terminal M-UE complete group creation.

S1416. The second terminal sends a first half session key parameter corresponding to the second terminal and the identifier of the second terminal to the first terminal, where the first half session key parameter corresponding to the second terminal and the identifier of the second terminal are used to generate an encrypted private key corresponding to the second terminal.

In this embodiment, for this step, refer to step S792 in FIG. 16A. Details are not described again.

S1417. The first terminal generates a first message authentication code based on a first shared key, where the first shared key is a key negotiated between the first terminal and the IKMS entity.

In one embodiment, the first shared key includes a first key for generating the message authentication code and a second key for data encryption.

In this embodiment, for this step, refer to step S793 in FIG. 16A. Details are not described again.

S1418. The first terminal encrypts a first message based on the first shared key, to obtain an encrypted first message, where the first message includes the first half session key parameter corresponding to the second terminal, the identifier of the second terminal, and the first message authentication code, and the first message authentication code is used to authenticate that the first message is sent by the first terminal and perform authentication on integrity of the first message.

In this embodiment, for this step, refer to step S998 in FIG. 19A. Details are not described again.

S1419. The first terminal sends the encrypted first message to the IKMS entity.

S1420. The IKMS entity decrypts the encrypted first message based on the first shared key, to obtain the first message.

In this embodiment, for this step, refer to step S9910 in FIG. 19A. Details are not described again.

S1421. The IKMS entity performs authentication on the first message authentication code based on the first shared key, where the first shared key is the key negotiated between the first terminal and the IKMS entity; and after determining that authentication on the first message authentication code succeeds, the IKMS entity generates a private key corresponding to the second terminal based on the identifier of the second terminal.

In this embodiment, for this step, refer to step S795 in FIG. 16B. Details are not described again.

S1422. The IKMS entity generates a second half session key parameter corresponding to the second terminal, and generates a symmetric key corresponding to the second terminal based on the first half session key parameter corresponding to the second terminal and the second half session key parameter corresponding to the second terminal.

In this embodiment, for this step, refer to step S796 in FIG. 16B. Details are not described again.

S1423. The IKMS entity encrypts the private key corresponding to the second terminal based on the symmetric key corresponding to the second terminal, to generate the encrypted private key corresponding to the second terminal.

In this embodiment, for this step, refer to step S797 in FIG. 16B. Details are not described again.

S1424. The IKMS entity generates signature information corresponding to the second terminal based on a private key of the IKMS entity, where the signature information corresponding to the second terminal is used to authenticate that the encrypted private key corresponding to the second terminal is generated by the IKMS entity.

In this embodiment, the IKMS entity adds, to a third message, the second half session key parameter XB corresponding to the second terminal S_UE, the identifier S_UE_ID of the second terminal S_UE, and the encrypted private key SK corresponding to the second terminal S_UE; and then the IKMS entity generates the signature information SIG corresponding to the second terminal S_UE based on the private key of the IKMS entity.

S1425. The IKMS entity encrypts the third message based on the first shared key, to generate an encrypted third message, where the third message includes the second half session key parameter corresponding to the second terminal, the identifier of the second terminal, the encrypted private key corresponding to the second terminal, and the signature information corresponding to the second terminal, and the first shared key is the key negotiated between the first terminal and the IKMS entity.

In this embodiment, the IKMS entity encrypts the third message based on the first shared key K_{IKMS_M}, to generate the encrypted third message.

For example, the encrypted third message is <(XB, S_UE_ID, (SK)key, SIG) K_{IKMS_M}>. XB is the second half session key parameter corresponding to the second terminal S_UE, S_UE_ID is the ID of the second terminal S_UE, (SK)_{key} is the encrypted private key corresponding to the second terminal S_UE, and SIG is the signature information corresponding to the second terminal S_UE.

S1426. The IKMS entity sends the encrypted third message to the first terminal.

S1427. The first terminal decrypts the encrypted third message based on the first shared key, to obtain the third message.

In this embodiment, the first terminal M_UE decrypts the encrypted third message based on the first shared key K_{IKMS_M}, to obtain the second half session key parameter XB corresponding to the second terminal S_UE, the identifier S_UE_ID of the second terminal, the encrypted private key (SK)_{key} corresponding to the second terminal S_UE, and the signature information SIG corresponding to the second terminal SUE.

S1428. The first terminal performs authentication on the signature information corresponding to the second terminal based on a public key of the IKMS entity.

In this embodiment, the first terminal M_UE performs authentication on the signature information SIG corresponding to the second terminal S_UE based on the public key of the IKMS entity.

S1429. After determining that authentication on the signature information corresponding to the second terminal succeeds, the first terminal sends the second half session key parameter corresponding to the second terminal, the encrypted private key corresponding to the second terminal, and the signature information corresponding to the second terminal to the second terminal.

In this embodiment, after determining that authentication on the signature information SIG corresponding to the second terminal S_UE succeeds, the first terminal M_UE sends the second half session key parameter XB corresponding to the second terminal S_UE, the encrypted private key SK corresponding to the second terminal S_UE, and the signature information SIG corresponding to the second terminal SUE to the second terminal S_UE based on the identifier SUED of the second terminal SUE.

For example, the first terminal M_UE sends the message <XB, (SK)key, SIG> to the second terminal S_UE.

S1430. The second terminal performs authentication on the signature information corresponding to the second terminal.

In this embodiment, the second terminal S_UE verifies whether the signature information SIG corresponding to the second terminal S_UE is tampered with.

S1431. After determining that authentication on the signature information corresponding to the second terminal succeeds, the second terminal generates the symmetric key based on the first half session key parameter corresponding to the second terminal and the second half session key parameter corresponding to the second terminal.

In this embodiment, if determining that the signature information SIG corresponding to the second terminal S_UE is generated by the IKMS entity and is not tampered with, the second terminal S_UE determines that authentication on the signature information SIG corresponding to the second terminal S_UE succeeds; and then the second terminal S_UE calculates the symmetric key key based on the first half session key parameter XA, generated by the second terminal S_UE, corresponding to the second terminal S_UE and the received second half session key parameter XB corresponding to the second terminal SUE.

S1432. The second terminal decrypts the encrypted private key corresponding to the second terminal based on the symmetric key, to obtain the private key corresponding to the second terminal.

In this embodiment, the second terminal S_UE decrypts the encrypted private key (SK)_{key} corresponding to the second terminal S_UE based on the calculated symmetric key key, to obtain the private key SK corresponding to the second terminal S_UE. In this way, obtaining an initial key by the second terminal S_UE is completed.

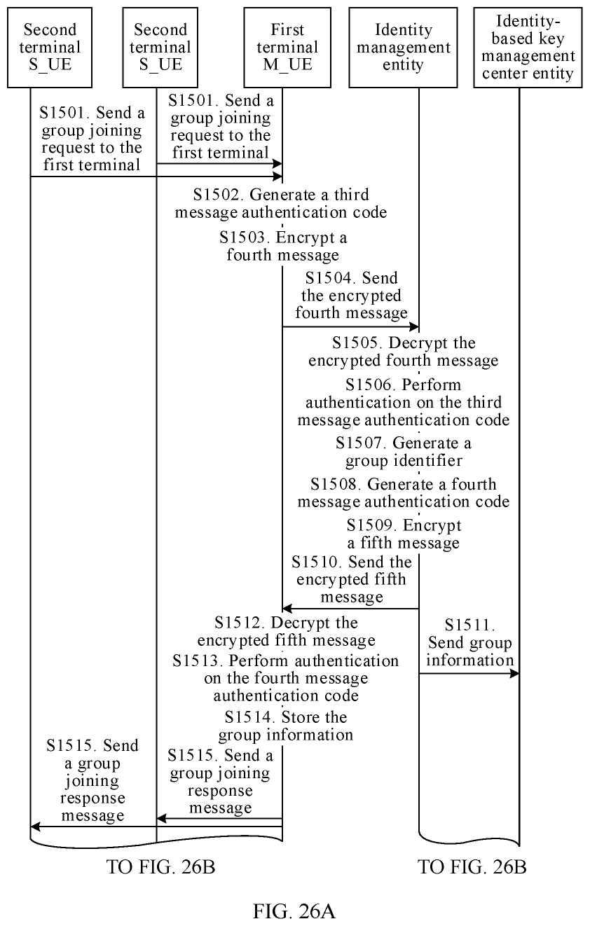

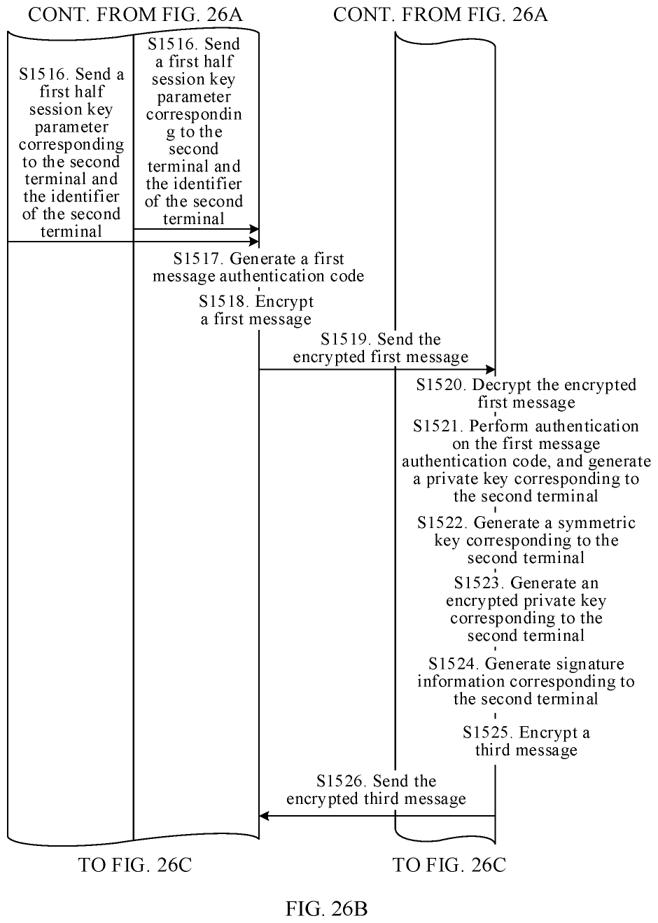

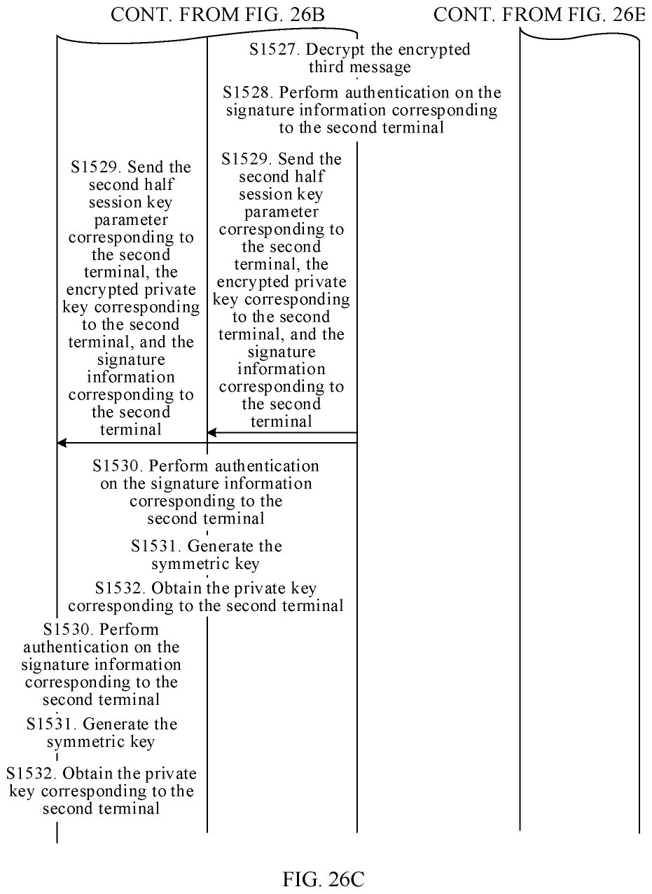

FIG. 26A to FIG. 26C are a schematic communication diagram 2 of a further private key generation method according to an embodiment. FIG. 26A to FIG. 26C are a schematic communication diagram of private key generation performed between at least two second terminals and one first terminal. The method is as follows.

S1501. Each second terminal sends a group joining request to the first terminal, where the group joining request includes a group flag field and an identifier of the second terminal, and the group flag field represents a relationship between the first terminal and the second terminal.

In this embodiment, for this step, refer to step S81 in FIG. 17A. Details are not described again.

S1502. The first terminal generates a third message authentication code based on a second shared key, where the second shared key is a key negotiated between the first terminal and an IDM entity.

In one embodiment, the second shared key includes a third key for generating the message authentication code and a fourth key for data encryption.

In this embodiment, for this step, refer to step S82 in FIG. 17A. Details are not described again.

S1503. The first terminal encrypts a fourth message based on the second shared key, to obtain an encrypted fourth message, where the fourth message includes the group flag field, an identifier of the first terminal, the identifier of each second terminal, and the third message authentication code.

In this embodiment, for this step, refer to step S1103 in FIG. 20A. Details are not described again.

S1504. The first terminal sends the encrypted fourth message to the IDM entity.

S1505. The IDM entity decrypts the encrypted fourth message based on the second shared key, to obtain the fourth message, where the second shared key is the key negotiated between the first terminal and the IDM entity.

In this embodiment, for this step, refer to step S1105 in FIG. 20A. Details are not described again.

S1506. The IDM entity performs authentication on the third message authentication code based on the second shared key, where the second shared key is the key negotiated between the first terminal and the IDM entity.

In this embodiment, for this step, refer to step S84 in FIG. 17A. Details are not described again.

S1507. After determining that authentication on the third message authentication code succeeds, the IDM entity generates a group identifier.

In this embodiment, for this step, refer to step S85 in FIG. 17A. Details are not described again.

S1508. The IDM entity generates a fourth message authentication code based on the second shared key, where the second shared key is the key negotiated between the first terminal and the IDM entity.

In this embodiment, for this step, refer to step S86 in FIG. 17A. Details are not described again.

S1509. The IDM entity encrypts a fifth message based on the second shared key, to generate an encrypted fifth message, where the fifth message includes the group identifier, the identifier of the first terminal, the identifier of each second terminal, and the fourth message authentication code.

In this embodiment, for this step, refer to step S1109 in FIG. 20A. Details are not described again.

S1510. The IDM entity sends the encrypted fifth message to the first terminal.

S1511. The IDM entity sends group information to an IKMS entity, where the group information includes the group identifier, the identifier of the first terminal, and the identifier of each second terminal.

In this embodiment, for this step, refer to step S1110b in FIG. 20A. Details are not described again.

S1512. The first terminal decrypts the encrypted fifth message based on the second shared key, to obtain the fifth message.

In this embodiment, for this step, refer to step S1111 in FIG. 20A. Details are not described again.

S1513. The first terminal performs authentication on the fourth message authentication code based on the second shared key, where the second shared key is the key negotiated between the first terminal and the IDM entity.

In this embodiment, for this step, refer to step S88 in FIG. 17A. Details are not described again.

S1514. After determining that authentication on the fourth message authentication code succeeds, the first terminal stores the group information, where the group information includes the group identifier, the identifier of the first terminal, and the identifier of each second terminal.

In this embodiment, for this step, refer to step S89 in FIG. 17A. Details are not described again.

S1515. The first terminal sends a group joining response message to each second terminal, where the group joining response message includes the group identifier.

In this embodiment, for this step, refer to step S891 in FIG. 17A. Details are not described again.

Step S1501 to step S1515 are a process in which a plurality of second terminals S_UE and one first terminal M-UE complete group creation.

S1516. Each second terminal sends a first half session key parameter corresponding to the second terminal and the identifier of the second terminal to the first terminal.

In this embodiment, for this step, refer to step S892 in FIG. 17A. Details are not described again.

S1517. The first terminal generates a first message authentication code based on a first shared key, where the first shared key is a key negotiated between the first terminal and the IKMS entity.

In one embodiment, the first shared key includes a first key for generating the message authentication code and a second key for data encryption.

In this embodiment, for this step, refer to step S893 in FIG. 17B. Details are not described again.

S1518. The first terminal encrypts a first message based on the first shared key, to obtain an encrypted first message, where the first message includes the first half session key parameter corresponding to each second terminal, the identifier of the second terminal, and the first message authentication code.

In this embodiment, for this step, refer to step S1117 in FIG. 20B. Details are not described again.

S1519. The first terminal sends the encrypted first message to the IKMS entity.

S1520. The IKMS entity decrypts the encrypted first message based on the first shared key, to obtain the first message.

In this embodiment, for this step, refer to step S1118 in FIG. 20B. Details are not described again.

S1521. The IKMS entity performs authentication on the first message authentication code based on the first shared key, where the first shared key is the key negotiated between the first terminal and the IKMS entity; and after determining that authentication on the first message authentication code succeeds, the IKMS entity generates a private key corresponding to each second terminal based on the identifier of the second terminal.

In this embodiment, for this step, refer to step S895 in FIG. 17B. Details are not described again.

S1522. The IKMS entity generates a second half session key parameter corresponding to each second terminal, and generates a symmetric key corresponding to the second terminal based on the first half session key parameter corresponding to the second terminal and the second half session key parameter corresponding to the second terminal.

In this embodiment, for this step, refer to step S896 in FIG. 17B. Details are not described again.

S1523. The IKMS entity encrypts the private key corresponding to each second terminal based on the symmetric key corresponding to the second terminal, to generate an encrypted private key corresponding to the second terminal.

In this embodiment, for this step, refer to step S897 in FIG. 17B. Details are not described again.

S1524. The IKMS entity generates signature information corresponding to each second terminal based on a private key of the IKMS entity.

In this embodiment, the IKMS entity generates the signature information SIG corresponding to each second terminal S_UE for related information of the second terminal S_UE based on the private key of the IKMS entity. The related information is the second half session key parameter XB corresponding to the second terminal S_UE, the identifier S_UE_ID of the second terminal S_UE, and the encrypted private key SK corresponding to the second terminal SUE.

For example, the IKMS entity generates signature information SIG1 corresponding to a second terminal S_UE1 for related information of the second terminal S_UE1 based on the private key of the IKMS entity. The related information of the second terminal S_UE1 includes a second half session key parameter XB1 corresponding to the second terminal S_UE1, an identifier S_UE_ID1 of the second terminal, and an encrypted private key (SK1)_{key1} corresponding to the second terminal S_UE1. The IKMS entity generates signature information SIG2 corresponding to a second terminal S_UE2 for related information of the second terminal S_UE2 based on the private key of the IKMS entity. The related information of the second terminal S_UE2 includes a second half session key parameter XB2 corresponding to the second terminal S_UE2, an identifier S_UE_ID2 of the second terminal, and an encrypted private key (SK2)_{key2} corresponding to the second terminal S_UE12.

S1525. The IKMS entity encrypts a third message based on the first shared key, to generate an encrypted third message, where the third message includes the second half session key parameter corresponding to each second terminal, the identifier of the second terminal, the encrypted private key corresponding to the second terminal, and the signature information corresponding to the second terminal, and the first shared key is the key negotiated between the first terminal and the IKMS entity.

In this embodiment, the IKMS entity generates a message authentication code MAC4 for the third message based on the first shared key K_{IKMS_M}, and then the IKMS entity encrypts the third message based on the first shared key K_{IKMS_M}, to generate the encrypted third message.

For example, content of the third message is (<<XB1, S_UE_ID1, (SK1)_{key1}>SIG1, <XB2, S_UE_ID2, (SK2)_{key2}>SIG2, MAC4>) K_{IKMS_M}. XB1 is the second half session key parameter corresponding to the second terminal S_UE1, S_UE_ID1 is the ID of the second terminal S_UE1, (SK1)_{key1} is the encrypted private key corresponding to the second terminal S_UE1, and SIG1 is the signature information corresponding to the second terminal S_UE1. XB2 is the second half session key parameter corresponding to the second terminal S_UE2, S_UE_ID2 is the ID of the second terminal S_UE2, (SK2)_{key2} is the encrypted private key corresponding to the second terminal S_UE2, and SIG2 is the signature information corresponding to the second terminal S_UE2. MAC4 is the message authentication code that is generated by the IKMS entity for the third message based on the first shared key K_{IKMS_M}.

S1526. The IKMS entity sends the encrypted third message to the first terminal.

S1527. The first terminal decrypts the encrypted third message based on the first shared key, to obtain the third message.

In this embodiment, the first terminal M_UE decrypts the encrypted third message based on the first shared key K_{IKMS_M}, to obtain the second half session key parameter XB corresponding to each second terminal S_UE, the identifier S_UE_ID of the second terminal, the encrypted private key (SK)_{key} corresponding to the second terminal S_UE, the signature information SIG corresponding to the second terminal S_UE, and the message authentication code MAC4.

The first terminal M_UE may perform authentication on the message authentication code MAC4; and after determining that authentication on the message authentication code MAC4 succeeds, perform step S1518.

S1528. The first terminal performs authentication on the signature information corresponding to each second terminal based on a public key of the IKMS entity.

In this embodiment, the first terminal M_UE performs authentication on the signature information SIG corresponding to each second terminal S_UE based on the public key of the IKMS entity.

For example, the first terminal M_UE separately performs authentication on the signature information SIG1 corresponding to the second terminal S_UE1 and the signature information SIG2 corresponding to the second terminal S_UE2 based on the public key of the IKMS entity.

S1529. After determining that authentication on the signature information corresponding to each second terminal succeeds, the first terminal sends the second half session key parameter corresponding to the second terminal, the encrypted private key corresponding to the second terminal, and the signature information corresponding to the second terminal to the second terminal.

In this embodiment, after determining that authentication on the signature information SIG corresponding to each second terminal S_UE succeeds, the first terminal M_UE sends the second half session key parameter XB corresponding to the second terminal S_UE, the encrypted private key SK corresponding to the second terminal S_UE, and the signature information SIG corresponding to the second terminal S_UE to the second terminal S_UE based on the identifier S_UE_ID of the second terminal SUE.

For example, the first terminal M_UE sends the message <XB1, (SK1)_{key1}, SIG1> to the second terminal S_UE1, and sends the message <XB2, (SK2)_{key2}, SIG2> to the second terminal S_UE2.

S1530. Each second terminal performs authentication on the signature information corresponding to the second terminal.

In this embodiment, each second terminal S_UE verifies whether the signature information SIG corresponding to the second terminal S_UE is tampered with.

S1531. After determining that authentication on the signature information corresponding to each second terminal succeeds, the second terminal generates the symmetric key based on the first half session key parameter corresponding to the second terminal and the second half session key parameter corresponding to the second terminal.

In this embodiment, if determining that the signature information SIG corresponding to each second terminal S_UE is generated by the IKMS entity and is not tampered with, the second terminal S_UE determines that authentication on the signature information SIG corresponding to the second terminal S_UE succeeds; and then the second terminal S_UE calculates the symmetric key key based on the first half session key parameter XA, generated by the second terminal S_UE, corresponding to the second terminal S_UE and the received second half session key parameter XB corresponding to the second terminal SUE.

S1532. Each second terminal decrypts the encrypted private key corresponding to the second terminal based on the symmetric key, to obtain the private key corresponding to the second terminal.

In this embodiment, each second terminal S_UE decrypts the encrypted private key (SK)_{key} corresponding to the second terminal S_UE based on the calculated symmetric key key, to obtain the private key SK corresponding to the second terminal S_UE. In this way, obtaining an initial key by the second terminal S_UE is completed.

For example, the second terminal S_UE1 performs authentication on the signature information SIG1 corresponding to the second terminal S_UE1; after determining that authentication on SIG1 succeeds, the second terminal S_UE1 generates, through calculation, a symmetric key key1 based on the received second half session key parameter XB1 corresponding to the second terminal S_UE1 and the first half session key parameter XA1 generated by the second terminal S_UE1; and the second terminal S_UE1 obtains the symmetric key corresponding to the control plane IKMS entity. Then, the second terminal S_UE1 decrypts the encrypted private key (SK1)_{key1} corresponding to the second terminal S_UE2 based on the symmetric key key1, to obtain a private key SK1 corresponding to the signature information corresponding to the second terminal S_UE2. The second terminal S_UE2 performs authentication on the signature information SIG2 corresponding to the second terminal S_UE2; after determining that authentication on SIG2 succeeds, the second terminal S_UE2 generates, through calculation, a symmetric key key2 based on the received second half session key parameter XB2 corresponding to the second terminal S_UE2 and the first half session key parameter XA2 generated by the second terminal S_UE2; and the second terminal S_UE2 obtains the symmetric key corresponding to the control plane IKMS entity. Then, the second terminal S_UE2 decrypts the encrypted private key (SK2)_{key2} corresponding to the second terminal S_UE2 based on the symmetric key key2, to obtain a private key SK2 corresponding to the signature information corresponding to the second terminal S_UE2.

It can be learnt that an asymmetric key mechanism is used for step S1516 to step S1532.

In this embodiment, the second terminal triggers group creation, the first terminal sends information such as the group flag field to the IDM entity, and the first terminal determines whether a group is to be created. In this way, the first terminal and the second terminal are trustworthy to each other, thereby improving a trust degree and security of the network elements in the group. In addition, characteristics of the group that can be created based on a group creation request proactively sent by the second terminal are diversified. In addition, a private key obtaining method is provided. After a group is created for terminals, the second terminal initiates a private key obtaining request, and the IKMS entity generates the encrypted private key corresponding to the second terminal. Moreover, the IKMS entity processes the encrypted private key corresponding to the second terminal by using the signature information corresponding to the second terminal. This prevents the encrypted private key corresponding to the second terminal from being tampered with by another terminal during transmission, can ensure that the encrypted private key corresponding to the second terminal is not tampered with or stolen by the another terminal, and prevents communication information between groups from being stolen. Furthermore, the second terminal can relatively quickly obtain the encrypted private key corresponding to the second terminal. Further, encryption processing is performed during sending/receiving of the fourth message, the fifth message, the first message, and the second message, to prevent the foregoing messages from being stolen by another unauthorized device.

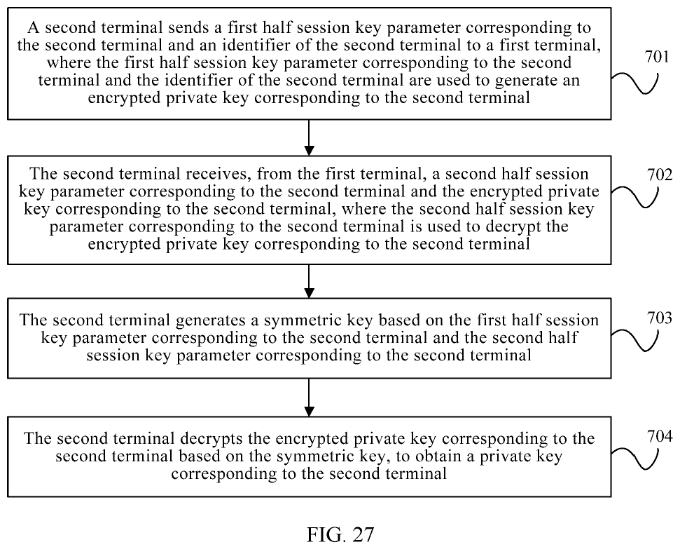

FIG. 27 is a schematic flowchart of a still further private key generation method according to an embodiment. As shown in FIG. 27, the method is as follows.

701. A second terminal sends a first half session key parameter corresponding to the second terminal and an identifier of the second terminal to a first terminal, where the first half session key parameter corresponding to the second terminal and the identifier of the second terminal are used to generate an encrypted private key corresponding to the second terminal.

702. The second terminal receives, from the first terminal, a second half session key parameter corresponding to the second terminal and the encrypted private key corresponding to the second terminal, where the second half session key parameter corresponding to the second terminal is used to decrypt the encrypted private key corresponding to the second terminal.

703. The second terminal generates a symmetric key based on the first half session key parameter corresponding to the second terminal and the second half session key parameter corresponding to the second terminal.

704. The second terminal decrypts the encrypted private key corresponding to the second terminal based on the symmetric key, to obtain a private key corresponding to the second terminal.

In one embodiment, step 702 includes the following:

The second terminal receives, from the first terminal, the second half session key parameter corresponding to the second terminal, the encrypted private key corresponding to the second terminal, and signature information corresponding to the second terminal, where the signature information corresponding to the second terminal is used to authenticate that the encrypted private key corresponding to the second terminal is generated by an IKMS entity.

Correspondingly, step 703 includes the following:

The second terminal performs authentication on the signature information corresponding to the second terminal; and after determining that authentication on the signature information corresponding to the second terminal succeeds, the second terminal generates the symmetric key based on the first half session key parameter corresponding to the second terminal and the second half session key parameter corresponding to the second terminal.

In one embodiment, the first terminal is a master node, and the second terminal is a slave node.

In one embodiment, before step 701, the method may further include the following steps:

705. The second terminal sends a group joining request to the first terminal, where the group joining request includes a group flag field and the identifier of the second terminal, and the group flag field represents a relationship between the first terminal and the second terminal.

706. The second terminal receives a group joining response message sent by the first terminal, where the group joining response message includes a group identifier.

In one embodiment, when only step 705 and step 706 are performed, the first terminal is a master node, and the second terminal is a master node; or the first terminal is a master node, and the second terminal is a slave node.

For the steps in this embodiment, refer to the steps in FIG. 4 to FIG. 26C. Details are not described again.

In this embodiment, the second terminal sends the first half session key parameter corresponding to the second terminal and the identifier of the second terminal to the first terminal, where the first half session key parameter corresponding to the second terminal and the identifier of the second terminal are used to generate the encrypted private key corresponding to the second terminal; the second terminal receives, from the first terminal, the second half session key parameter corresponding to the second terminal and the encrypted private key corresponding to the second terminal, where the second half session key parameter corresponding to the second terminal is used to decrypt the encrypted private key corresponding to the second terminal; the second terminal generates the symmetric key based on the first half session key parameter corresponding to the second terminal and the second half session key parameter corresponding to the second terminal; and the second terminal decrypts the encrypted private key corresponding to the second terminal based on the symmetric key, to obtain the private key corresponding to the second terminal. In this way, a private key obtaining method is provided. After a group is created for terminals, the second terminal initiates a private key obtaining request, the IKMS entity generates the encrypted private key corresponding to the second terminal, and the second terminal receives, by using the first terminal, the encrypted private key corresponding to the second terminal sent by the IKMS entity. Therefore, the second terminal can relatively quickly obtain the encrypted private key corresponding to the second terminal. This can prevent the private key from being stolen, and prevent communication information between groups from being stolen.

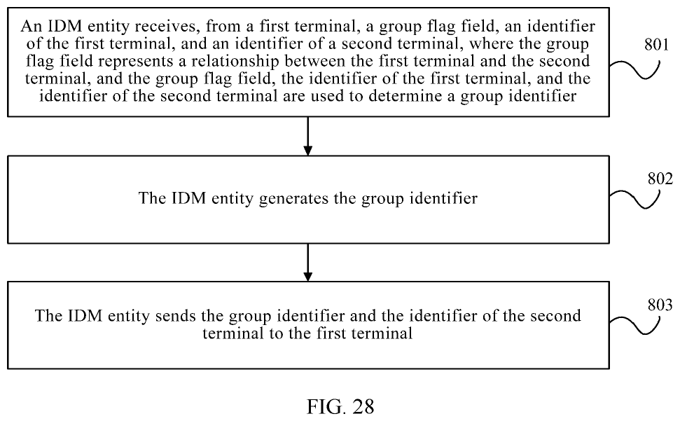

FIG. 28 is a schematic flowchart of another group creation method according to an embodiment. As shown in FIG. 28, the method is as follows.

801. An IDM entity receives, from a first terminal, a group flag field, an identifier of the first terminal, and an identifier of a second terminal, where the group flag field represents a relationship between the first terminal and the second terminal, and the group flag field, the identifier of the first terminal, and the identifier of the second terminal are used to determine a group identifier.

802. The IDM entity generates the group identifier.

803. The IDM entity sends the group identifier and the identifier of the second terminal to the first terminal.

In one embodiment, the group flag field represents that the first terminal is a master node, and the second terminal is a master node; or the group flag field represents that the first terminal is a master node, and the second terminal is a slave node.

In one embodiment, there are one or at least two second terminals.

For the steps in this embodiment, refer to the steps in FIG. 7 to FIG. 11. Details are not described again.

In this embodiment, the IDM entity receives, from the first terminal, the group flag field, the identifier of the first terminal, and the identifier of the second terminal, where the group flag field represents the relationship between the first terminal and the second terminal, and the group flag field, the identifier of the first terminal, and the identifier of the second terminal are used to determine the group identifier; the IDM entity generates the group identifier; and the IDM entity sends the group identifier and the identifier of the second terminal to the first terminal. Then, the second terminal triggers group creation, the first terminal sends information such as the group flag field to the IDM entity, and the first terminal determines whether a group is to be created. In this way, the first terminal and the second terminal are trustworthy to each other, thereby improving a trust degree and security of the network elements in the group. In addition, characteristics of the group that can be created based on a group creation request proactively sent by the second terminal are diversified.

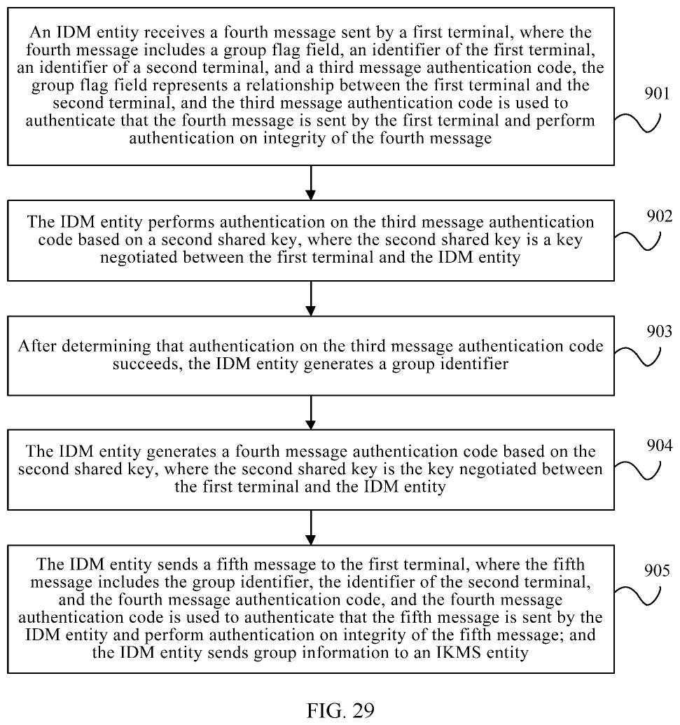

FIG. 29 is a schematic flowchart of still another group creation method according to an embodiment. As shown in FIG. 29, the method is as follows.

901. An IDM entity receives a fourth message sent by a first terminal, where the fourth message includes a group flag field, an identifier of the first terminal, an identifier of a second terminal, and a third message authentication code, the group flag field represents a relationship between the first terminal and the second terminal, and the third message authentication code is used to authenticate that the fourth message is sent by the first terminal and perform authentication on integrity of the fourth message.

In one embodiment, step 901 includes: The IDM entity receives an encrypted fourth message sent by the first terminal.

902. The IDM entity performs authentication on the third message authentication code based on a second shared key, where the second shared key is a key negotiated between the first terminal and the IDM entity.

In one embodiment, before step 902, the method further includes: decrypting, by the IDM entity, the encrypted fourth message based on the second shared key, to obtain the fourth message.

903. After determining that authentication on the third message authentication code succeeds, the IDM entity generates a group identifier.

904. The IDM entity generates a fourth message authentication code based on the second shared key, where the second shared key is the key negotiated between the first terminal and the IDM entity.

905. The IDM entity sends a fifth message to the first terminal, where the fifth message includes the group identifier, the identifier of the second terminal, and the fourth message authentication code, and the fourth message authentication code is used to authenticate that the fifth message is sent by the IDM entity and perform authentication on integrity of the fifth message; and the IDM entity sends group information to an IKMS entity, where the group information includes the group identifier, the identifier of the first terminal, and the identifier of the second terminal.

In one embodiment, step 905 includes: The IDM entity encrypts the fifth message based on the second shared key, to generate an encrypted fifth message; and the IDM entity sends the encrypted fifth message to the first terminal.

In one embodiment, the second shared key includes a third key for generating the message authentication code and a fourth key for data encryption.

For the steps in this embodiment, refer to the steps in FIG. 12 to FIG. 26C. Details are not described again.

In this embodiment, the IDM entity receives, from the first terminal, the group flag field, the identifier of the first terminal, and the identifier of the second terminal, where the group flag field represents the relationship between the first terminal and the second terminal, and the group flag field, the identifier of the first terminal, and the identifier of the second terminal are used to determine the group identifier; the IDM entity generates the group identifier; and the IDM entity sends the group identifier and the identifier of the second terminal to the first terminal. Then, the second terminal triggers group creation, the first terminal sends information such as the group flag field to the IDM entity, and the first terminal determines whether a group is to be created. In this way, the first terminal and the second terminal are trustworthy to each other, thereby improving a trust degree and security of the network elements in the group. In addition, characteristics of the group that can be created based on a group creation request proactively sent by the second terminal are diversified. Further, encryption processing is performed during sending/receiving of the messages, to prevent the foregoing messages from being stolen by another unauthorized device.

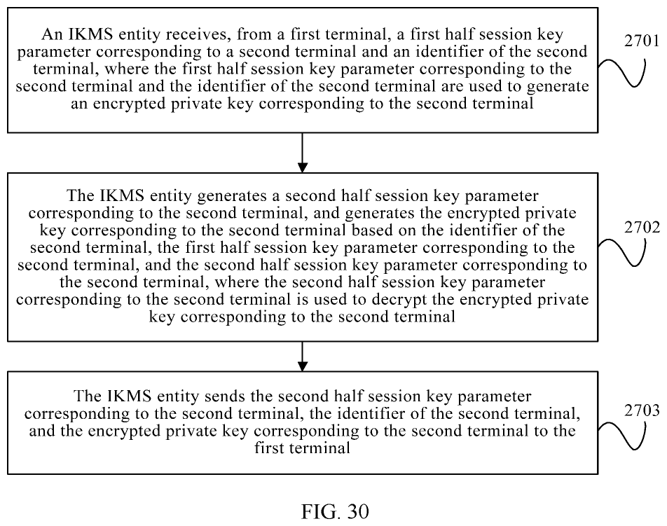

FIG. 30 is a schematic flowchart of a yet further private key generation method according to an embodiment. As shown in FIG. 30, the method is as follows.

2701. An IKMS entity receives, from a first terminal, a first half session key parameter corresponding to a second terminal and an identifier of the second terminal, where the first half session key parameter corresponding to the second terminal and the identifier of the second terminal are used to generate an encrypted private key corresponding to the second terminal.

2702. The IKMS entity generates a second half session key parameter corresponding to the second terminal, and generates the encrypted private key corresponding to the second terminal based on the identifier of the second terminal, the first half session key parameter corresponding to the second terminal, and the second half session key parameter corresponding to the second terminal, where the second half session key parameter corresponding to the second terminal is used to decrypt the encrypted private key corresponding to the second terminal.

In one embodiment, step 2702 includes the following:

The IKMS entity generates a private key corresponding to the second terminal based on the identifier of the second terminal.

The IKMS entity generates the second half session key parameter corresponding to the second terminal, and generates a symmetric key corresponding to the second terminal based on the first half session key parameter corresponding to the second terminal and the second half session key parameter corresponding to the second terminal.

The IKMS entity encrypts the private key corresponding to the second terminal based on the symmetric key corresponding to the second terminal, to generate the encrypted private key corresponding to the second terminal.

2703. The IKMS entity sends the second half session key parameter corresponding to the second terminal, the identifier of the second terminal, and the encrypted private key corresponding to the second terminal to the first terminal.

For the steps in this embodiment, refer to the steps in FIG. 4 to FIG. 6 and FIG. 12 to FIG. 14B. Details are not described again.

In this embodiment, a private key obtaining method is provided. After a group is created for terminals, the second terminal initiates a private key obtaining request, the IKMS entity generates the encrypted private key corresponding to the second terminal, and the second terminal receives, by using the first terminal, the encrypted private key corresponding to the second terminal sent by the IKMS entity. Therefore, the second terminal can relatively quickly obtain the encrypted private key corresponding to the second terminal. This can prevent the private key from being stolen, and prevent communication information between groups from being stolen.

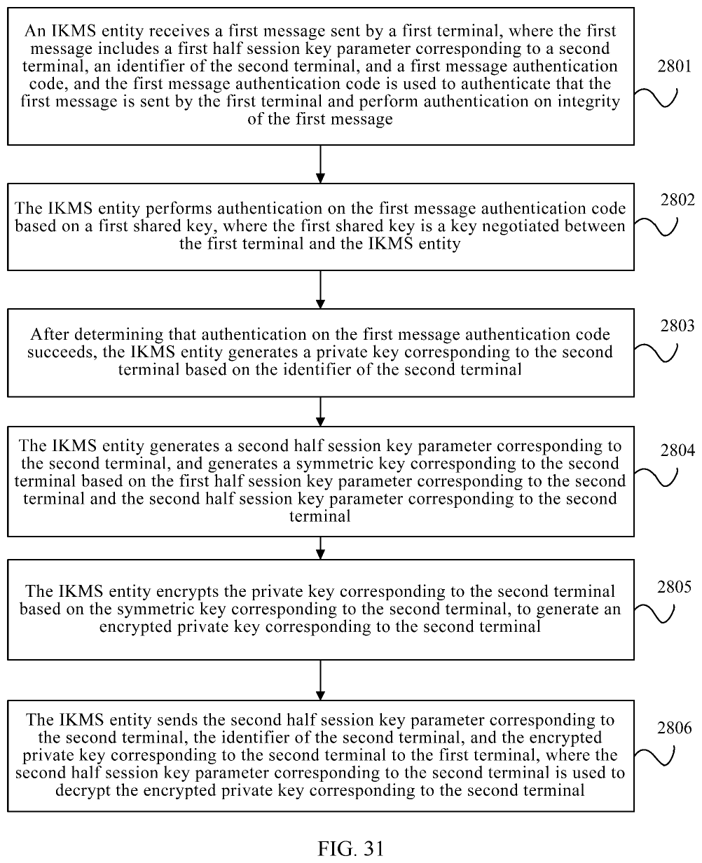

FIG. 31 is a schematic flowchart of a still yet further private key generation method according to an embodiment. As shown in FIG. 31, the method is as follows.

2801. An IKMS entity receives a first message sent by a first terminal, where the first message includes a first half session key parameter corresponding to a second terminal, an identifier of the second terminal, and a first message authentication code, and the first message authentication code is used to authenticate that the first message is sent by the first terminal and perform authentication on integrity of the first message.

In one embodiment, step 2801 includes: The IKMS entity receives an encrypted first message sent by the first terminal.

2802. The IKMS entity performs authentication on the first message authentication code based on a first shared key, where the first shared key is a key negotiated between the first terminal and the IKMS entity.

In one embodiment, before step 2802, the method further includes:

decrypting, by the IKMS entity, the encrypted first message based on the first shared key, to obtain the first message.

2803. After determining that authentication on the first message authentication code succeeds, the IKMS entity generates a private key corresponding to the second terminal based on the identifier of the second terminal.

2804. The IKMS entity generates a second half session key parameter corresponding to the second terminal, and generates a symmetric key corresponding to the second terminal based on the first half session key parameter corresponding to the second terminal and the second half session key parameter corresponding to the second terminal.

2805. The IKMS entity encrypts the private key corresponding to the second terminal based on the symmetric key corresponding to the second terminal, to generate an encrypted private key corresponding to the second terminal.

2806. The IKMS entity sends the second half session key parameter corresponding to the second terminal, the identifier of the second terminal, and the encrypted private key corresponding to the second terminal to the first terminal, where the second half session key parameter corresponding to the second terminal is used to decrypt the encrypted private key corresponding to the second terminal.

In one embodiment, there are one or at least two second terminals.

In one embodiment, the first shared key includes a first key for generating the message authentication code and a second key for data encryption.

In one embodiment, step 2806 includes the following steps:

28061a. The IKMS entity generates a second message authentication code based on the first shared key, where the first shared key is the key negotiated between the first terminal and the IKMS entity.

28062a. The IKMS entity sends a second message to the first terminal, where the second message includes the second half session key parameter corresponding to the second terminal, the identifier of the second terminal, the encrypted private key corresponding to the second terminal, and the second message authentication code, and the second message authentication code is used to authenticate that the second message is sent by the IKMS entity and perform authentication on integrity of the second message.

Step 28062a includes: The IKMS entity encrypts the second message based on the first shared key, to generate an encrypted second message; and the IKMS entity sends the encrypted second message to the first terminal.

Alternatively, in one embodiment, step 2806 includes the following steps:

28061b. The IKMS entity generates signature information corresponding to the second terminal based on a private key of the IKMS entity, where the signature information corresponding to the second terminal is used to authenticate that the encrypted private key corresponding to the second terminal is generated by the IKMS entity.

28062b. The IKMS entity sends a third message to the first terminal, where the third message includes the second half session key parameter corresponding to the second terminal, the identifier of the second terminal, the encrypted private key corresponding to the second terminal, and the signature information corresponding to the second terminal.

Step 28062b includes: The IKMS entity encrypts the third message based on the first shared key, to generate an encrypted third message, where the first shared key is the key negotiated between the first terminal and the IKMS entity; and the IKMS entity sends the encrypted third message to the first terminal.

For the steps in this embodiment, refer to the steps in FIG. 15A to FIG. 26C. Details are not described again.

In this embodiment, a private key obtaining method is provided. After a group is created for terminals, the second terminal initiates a private key obtaining request, and the IKMS entity generates the encrypted private key corresponding to the second terminal. Moreover, the IKMS entity processes the encrypted private key corresponding to the second terminal by using the signature information corresponding to the second terminal. This prevents the encrypted private key corresponding to the second terminal from being tampered with by another terminal during transmission, can ensure that the encrypted private key corresponding to the second terminal is not tampered with or stolen by the another terminal, and prevents communication information between groups from being stolen. Furthermore, the second terminal can relatively quickly obtain the encrypted private key corresponding to the second terminal.

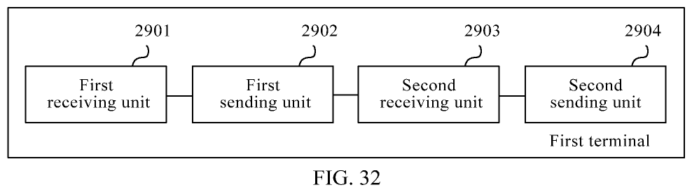

FIG. 32 is a schematic structural diagram of a first terminal according to an embodiment. As shown in FIG. 32, the first terminal includes:

a first receiving unit 2901, configured to receive, from a second terminal, a first half session key parameter corresponding to the second terminal and an identifier of the second terminal, where the first half session key parameter corresponding to the second terminal and the identifier of the second terminal are used to generate an encrypted private key corresponding to the second terminal;

a first sending unit 2902, configured to send the first half session key parameter corresponding to the second terminal and the identifier of the second terminal to an IKMS entity;

a second receiving unit 2903, configured to receive, from the IKMS entity, a second half session key parameter corresponding to the second terminal, the identifier of the second terminal, and the encrypted private key corresponding to the second terminal, where the second half session key parameter corresponding to the second terminal is used to decrypt the encrypted private key corresponding to the second terminal; and

a second sending unit 2904, configured to send the second half session key parameter corresponding to the second terminal and the encrypted private key corresponding to the second terminal to the second terminal based on the identifier of the second terminal.

In one embodiment, a group flag field represents that the first terminal is a master node, and the second terminal is a slave node.

In one embodiment, there are one or at least two second terminals.

The first receiving unit 2901 may perform step 101a of the method shown in FIG. 4. The first sending unit 2902 may perform step 102a of the method shown in FIG. 4. The second receiving unit 2903 may perform step 103a of the method shown in FIG. 4. The second sending unit 2904 may perform step 104a of the method shown in FIG. 4.

In addition, for the units and modules in this implementation, refer to the steps in FIG. 5 to FIG. 11, or refer to the steps in FIG. 12 to FIG. 14B.

In this embodiment, the terminal device in the embodiment shown in FIG. 32 may be configured to execute the technical solutions of the embodiment shown in FIG. 4 in the foregoing method. Implementation principles and technical effects of the network device are similar to those in the foregoing embodiment, and details are not described herein again.

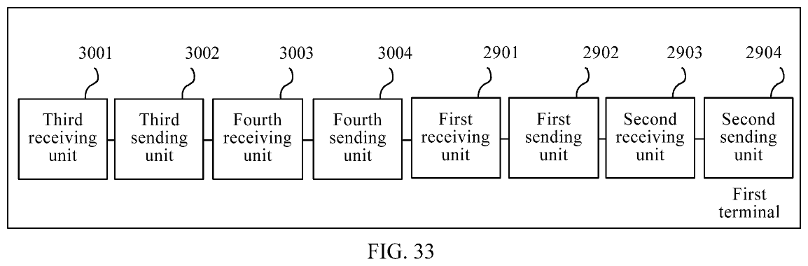

FIG. 33 is a schematic structural diagram of another first terminal according to an embodiment. Based on the embodiment shown in FIG. 32, as shown in FIG. 33, the first terminal further includes:

a third receiving unit 3001, configured to: before the first receiving unit 2901 receives, from the second terminal, the first half session key parameter corresponding to the second terminal and the identifier of the second terminal, receive a group joining request sent by the second terminal, where the group joining request includes a group flag field and the identifier of the second terminal, and the group flag field represents a relationship between the first terminal and the second terminal;

a third sending unit 3002, configured to send the group flag field, an identifier of the first terminal, and the identifier of the second terminal to an IDM entity, where the group flag field, the identifier of the first terminal, and the identifier of the second terminal are used to determine a group identifier;

a fourth receiving unit 3003, configured to receive the group identifier and the identifier of the second terminal that are sent by the IDM entity; and

a fourth sending unit 3004, configured to send a group joining response message to the second terminal based on the identifier of the second terminal, where the group joining response message includes the group identifier.

In one embodiment, if only the foregoing four units are executed, the group flag field represents that the first terminal is a master node, and the second terminal is a master node; or the group flag field represents that the first terminal is a master node, and the second terminal is a slave node.

The third receiving unit 3001 may perform step 101 of the method shown in FIG. 7, or may perform step 201 of the method shown in FIG. 8. The third sending unit 3002 may perform step 102 of the method shown in FIG. 7, or may perform step 202 of the method shown in FIG. 8. The fourth receiving unit 3003 may perform step 103 of the method shown in FIG. 7, or may perform step 203 of the method shown in FIG. 8. The fourth sending unit 3004 may perform step 104 of the method shown in FIG. 7, or may perform step 204 of the method shown in FIG. 8.

In addition, for the units and modules in this embodiment, refer to the steps in FIG. 13 to FIG. 14B.

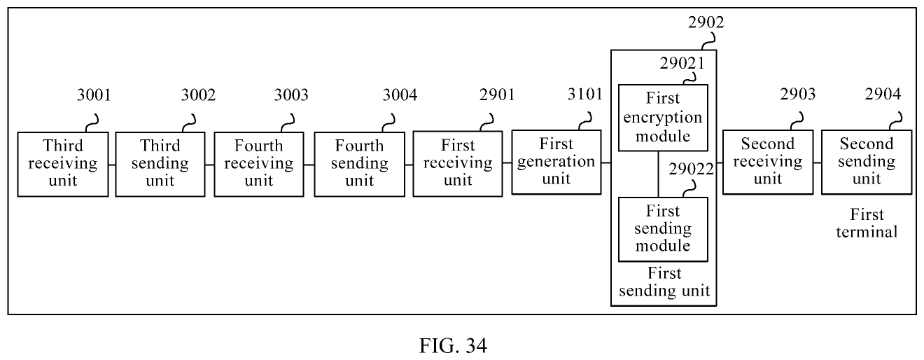

FIG. 34 is a schematic structural diagram of another first terminal according to an embodiment. Based on the embodiment shown in FIG. 33, as shown in FIG. 34, the first terminal further includes:

a first generation unit 3101, configured to: before the first sending unit 2902 sends the first half session key parameter corresponding to the second terminal and the identifier of the second terminal to the IKMS entity, generate a first message authentication code based on a first shared key, where the first shared key is a key negotiated between the first terminal and the IKMS entity. In this case, the first generation unit 3101 may perform step 309 of the method shown in FIG. 15B.

Correspondingly 2902, the first sending unit 2902 is configured to:

send a first message to the IKMS entity, where the first message includes the first half session key parameter corresponding to the second terminal, the identifier of the second terminal, and the first message authentication code, and the first message authentication code is used to authenticate that the first message is sent by the first terminal and perform authentication on integrity of the first message. In this case, the first sending unit 2902 may perform step 3010 of the method shown in FIG. 15B.

In one embodiment, the first shared key includes a first key for generating the message authentication code and a second key for data encryption.

The first sending unit 2902 includes:

a first encryption module 29021, configured to encrypt the first message based on the first shared key, to obtain an encrypted first message; and

a first sending module 29022, configured to send the encrypted first message to the IKMS entity.

The second receiving unit 2903 and the second sending unit 2904 include the following two implementations.

In one embodiment, the second receiving unit 2903 is configured to:

receive a second message sent by the IKMS entity, where the second message includes the second half session key parameter corresponding to the second terminal, the identifier of the second terminal, the encrypted private key corresponding to the second terminal, and a second message authentication code, and the second message authentication code is used to authenticate that the second message is sent by the IKMS entity and perform authentication on integrity of the second message. In this case, the second receiving unit 2903 may perform step 3011 in FIG. 15B.

Correspondingly, the second sending unit 2904 includes:

a first authentication module, configured to perform authentication on the second message authentication code based on the first shared key, where the first shared key is the key negotiated between the first terminal and the IKMS entity; and

a second sending module, configured to: after it is determined that authentication on the second message authentication code succeeds, send the second half session key parameter corresponding to the second terminal and the encrypted private key corresponding to the second terminal to the second terminal based on the identifier of the second terminal. In this case, the second sending unit 2904 may perform step 3012 and step 3013 in FIG. 15B.

In one embodiment, the second receiving unit 2903 is configured to receive an encrypted second message sent by the IKMS entity. In this case, the second receiving unit 2903 may perform step 4011 in FIG. 18B. Correspondingly, the second sending unit 2904 further includes: a first decryption module, configured to: before the authentication module performs authentication on the second message authentication code based on the first shared key, decrypt the encrypted second message based on the first shared key, to obtain the second message. In this case, the second sending unit 2904 may perform step 4011 in FIG. 18B.

In addition, for the second receiving unit 2903 and the second sending unit 2904, refer to the steps in FIG. 16A to FIG. 17C, or refer to the steps in FIG. 19A to FIG. 20C.

In a second optional implementation, the second receiving unit 2903 is configured to:

receive a third message sent by the IKMS entity, where the third message includes the second half session key parameter corresponding to the second terminal, the identifier of the second terminal, the encrypted private key corresponding to the second terminal, and signature information corresponding to the second terminal, and the signature information corresponding to the second terminal is used to authenticate that the encrypted private key corresponding to the second terminal is generated by the IKMS entity. In this case, the second receiving unit 2903 may perform step 6011 in FIG. 21B.

Correspondingly, the second sending unit 2904 includes:

a second authentication module, configured to perform authentication on the signature information corresponding to the second terminal based on a public key of the IKMS entity; and

a third sending module, configured to: after it is determined that authentication on the signature information corresponding to the second terminal succeeds, send the second half session key parameter corresponding to the second terminal, the encrypted private key corresponding to the second terminal, and the signature information corresponding to the second terminal to the second terminal based on the identifier of the second terminal. In this case, the second sending unit 2904 may perform step S012 and step S013 in FIG. 21B.

In one embodiment, the second receiving unit 2903 is configured to receive an encrypted third message sent by the IKMS entity. In this case, the second receiving unit 2903 may perform step 6011 in FIG. 24B. Correspondingly, the second sending unit 2904 further includes: a second decryption module, configured to: before the second authentication module performs authentication on the signature information corresponding to the second terminal based on the public key of the IKMS entity, decrypt the encrypted third message based on the first shared key, to obtain the third message, where the first shared key is the key negotiated between the first terminal and the IKMS entity. In this case, the second sending unit 2904 may perform step 6012 in

FIG. 18.

In addition, for the second receiving unit 2903 and the second sending unit 2904, refer to the steps in FIG. 22A to FIG. 23C, or refer to the steps in FIG. 25A to FIG. 26C.

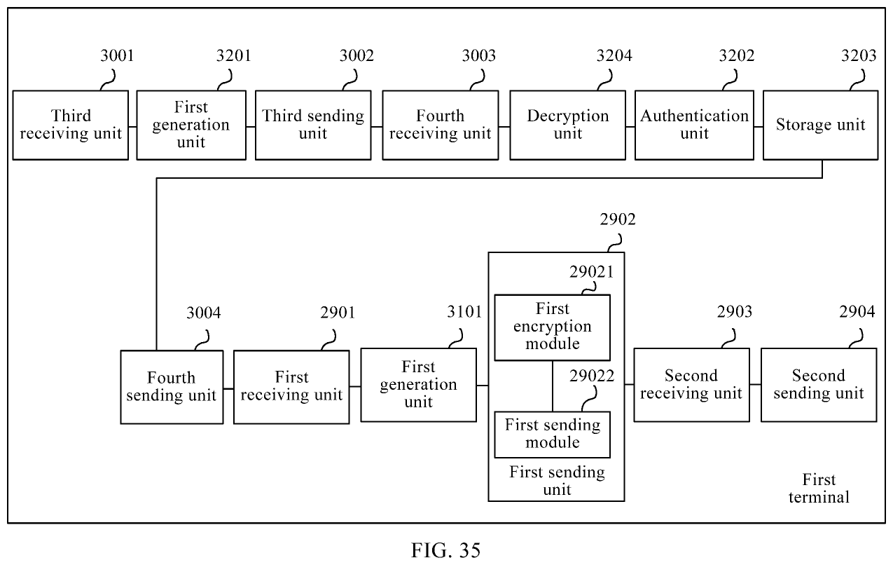

FIG. 35 is a schematic structural diagram of yet another first terminal according to an embodiment. Based on the embodiment shown in FIG. 34, as shown in FIG. 35, the first terminal further includes:

a first generation unit 3201, configured to: before the third sending unit 3002 sends the group flag field, the identifier of the first terminal, and the identifier of the second terminal to the IDM entity, generate a third message authentication code based on a second shared key, where the second shared key is a key negotiated between the first terminal and the IDM entity. In this case, the first generation unit 3201 may perform step 302 of the method shown in FIG. 15A.

Correspondingly, the third sending unit 3002 is configured to:

send a fourth message to the IDM entity, where the fourth message includes the group flag field, the identifier of the first terminal, the identifier of the second terminal, and the third message authentication code, and the third message authentication code is used to authenticate that the fourth message is sent by the first terminal and perform authentication on integrity of the fourth message. In this case, the third sending unit 3002 may perform step 303 of the method shown in FIG. 15A.

In one embodiment, the second shared key includes a third key for generating the message authentication code and a fourth key for data encryption.

In one embodiment, the third sending unit 3002 includes: a second encryption module, configured to encrypt the fourth message based on the second shared key, to obtain an encrypted fourth message; and; a fourth sending module, configured to send the encrypted fourth message to the IDM entity. In this case, the third sending unit 3002 may perform step 403 of the method shown in FIG. 18A.

In one embodiment, the fourth receiving unit 3003 is configured to:

receive a fifth message sent by the IDM entity, where the fifth message includes the group identifier, the identifier of the second terminal, and a fourth message authentication code, and the fourth message authentication code is used to authenticate that the fifth message is sent by the IDM entity and perform authentication on integrity of the fifth message. In this case, the fourth receiving unit 3003 may perform step 304 of the method shown in FIG. 15A.

Correspondingly, the first terminal further includes:

an authentication unit 3202, configured to: after the fourth receiving unit 3003 receives the fifth message sent by the IDM entity, perform authentication on the fourth message authentication code based on the second shared key, where the second shared key is the key negotiated between the first terminal and the IDM entity, where in this case, the authentication unit 3202 may perform step 305 of the method shown in FIG. 15A; and

a storage unit 3203, configured to: after it is determined that authentication on the fourth message authentication code succeeds, store group information, where the group information includes the group identifier, the identifier of the first terminal, and the identifier of the second terminal. In this case, the storage unit 3203 may perform step 306 of the method shown in FIG. 15A.

In one embodiment, the fourth receiving unit 3003 is configured to: receive an encrypted fifth message sent by the IDM entity. In this case, the fourth receiving unit 3003 may perform step 404 of the method shown in FIG. 18A.

Correspondingly, the first terminal further includes:

a decryption unit 3204, configured to: before the authentication unit 3202 performs authentication on the fourth message authentication code based on the second shared key, decrypt the encrypted fifth message based on the second shared key, to obtain the fifth message. In this case, the decryption unit may perform step 404 of the method shown in FIG. 18A.

In addition, for the units and modules in this implementation, refer to the steps in FIG. 16A to FIG. 17C, refer to the steps in FIG. 19A to FIG. 20C.

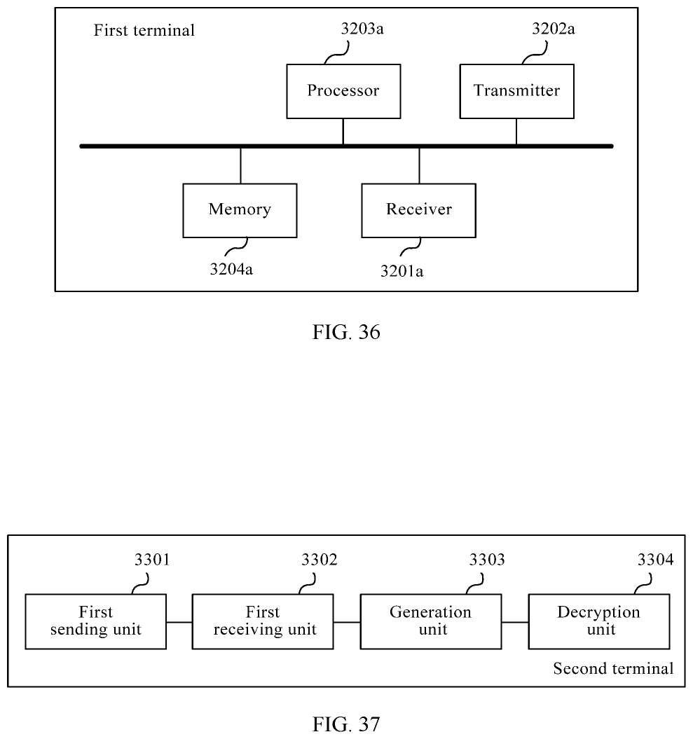

FIG. 36 is a schematic structural diagram of still yet another first terminal according to an embodiment. The first terminal may be configured to perform actions or steps of the first terminal in the embodiments shown in FIG. 4 to FIG. 26C. The first terminal includes a receiver 3201a, a transmitter 3202a, a processor 3203a, and a memory 3204a.

The components in the first terminal are configured to implement the actions in the embodiments shown in FIG. 4 to FIG. 26C. Details are not described again. In addition, the components in the first terminal are configured to implement functions of the units and the modules in the embodiments shown in FIG. 32 to FIG. 35. Details are not described again.

In the embodiments of this application, reference may be made to each other for the foregoing embodiments. Same or similar steps and nouns are not described one by one again.

Alternatively, some or all of the foregoing modules may be implemented in a form of an integrated circuit that is embedded in a chip of the terminal device. In addition, the modules may be independently implemented, or may be integrated together. The foregoing modules may be configured as one or more integrated circuits for implementing the foregoing methods, for example, one or more application-specific integrated circuits (Application Specific Integrated Circuit, ASIC), one or more microprocessors (digital signal processor, DSP), or one or more field programmable gate arrays (Field Programmable Gate Array, FPGA).

FIG. 37 is a schematic structural diagram of a second terminal according to an embodiment. As shown in FIG. 37, the second terminal includes:

a first sending unit 3301, configured to send a first half session key parameter corresponding to the second terminal and an identifier of the second terminal to a first terminal, where the first half session key parameter corresponding to the second terminal and the identifier of the second terminal are used to generate an encrypted private key corresponding to the second terminal, and the first sending unit 3301 may perform step 703a of the method shown in FIG. 27;

a first receiving unit 3302, configured to receive, from the first terminal, a second half session key parameter corresponding to the second terminal and the encrypted private key corresponding to the second terminal, where the second half session key parameter corresponding to the second terminal is used to decrypt the encrypted private key corresponding to the second terminal, and the first receiving unit 3302 may perform step 704a of the method shown in FIG. 27;

a generation unit 3303, configured to generate a symmetric key based on the first half session key parameter corresponding to the second terminal and the second half session key parameter corresponding to the second terminal, and the generation unit 3303 may perform step 705a of the method shown in FIG. 27; and

a decryption unit 3304, configured to decrypt the encrypted private key corresponding to the second terminal based on the symmetric key, to obtain a private key corresponding to the second terminal, where the decryption unit 3304 may perform step 706a of the method shown in FIG. 27.

In addition, for the units and modules in this implementation, refer to the steps in FIG. 27.

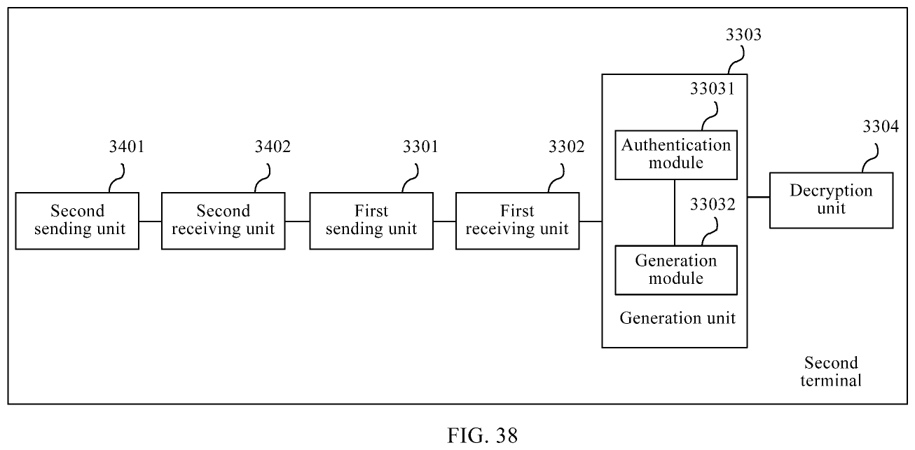

FIG. 38 is a schematic structural diagram of another second terminal according to an embodiment. Based on the embodiment shown in FIG. 37, as shown in FIG. 38, the first receiving unit 3302 is configured to:

receive, from the first terminal, the second half session key parameter corresponding to the second terminal, the encrypted private key corresponding to the second terminal, and signature information corresponding to the second terminal, where the signature information corresponding to the second terminal is used to authenticate that the encrypted private key corresponding to the second terminal is generated by an IKMS entity, and in this case, the first receiving unit 3302 may perform step 704b of the method shown in FIG. 27.

Correspondingly, the generation unit 3303 includes:

an authentication module 33031, configured to perform authentication on the signature information corresponding to the second terminal, where the authentication module 33031 may perform step 705b of the method shown in FIG. 27;

and

a generation module 33032, configured to: after it is determined that authentication on the signature information corresponding to the second terminal succeeds, generate the symmetric key based on the first half session key parameter corresponding to the second terminal and the second half session key parameter corresponding to the second terminal, where the generation module 33032 may perform step 706b of the method shown in FIG. 27.

In one embodiment, the first terminal is a master node, and the second terminal is a slave node.

In one embodiment, the second terminal further includes:

a second sending unit 3401, configured to: before the first sending unit 3301 sends the first half session key parameter corresponding to the second terminal and the identifier of the second terminal to the first terminal, send a group joining request to the first terminal, where the group joining request includes a group flag field and the identifier of the second terminal, and the group flag field represents a relationship between the first terminal and the second terminal; and the second sending unit 3401 may perform step 701 of the method shown in FIG. 27; and

a second receiving unit 3402, configured to receive a group joining response message sent by the first terminal, where the group joining response message includes the group identifier. The second receiving unit 3402 may perform the method step 702 in FIG. 27.

In addition, for the units and modules in this implementation, refer to the steps in FIG. 27.

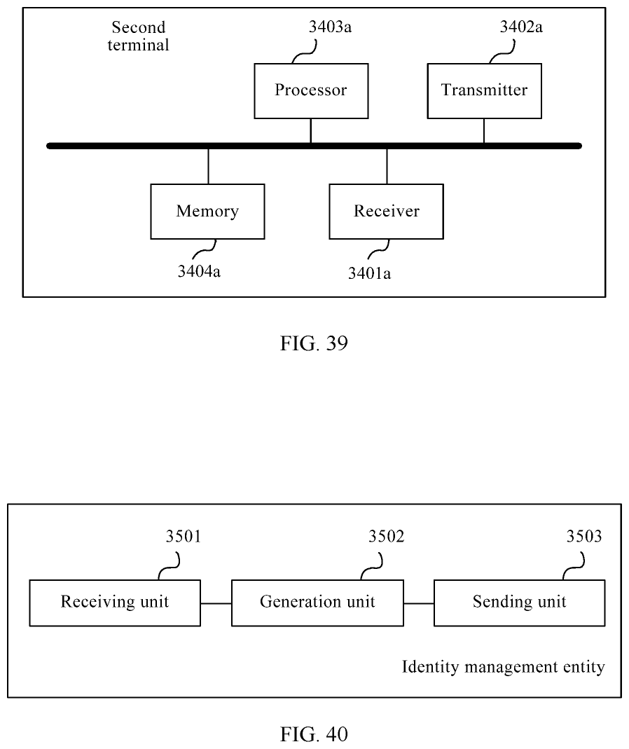

FIG. 39 is a schematic structural diagram of still another second terminal according to an embodiment. The second terminal may be configured to perform actions or steps of the second terminal in the embodiments shown in FIG. 27. The second terminal includes a receiver 3401a, a transmitter 3402a, a processor 3403a, and

a memory 3404a.

The components in the second terminal are configured to implement the actions in the embodiments shown in FIG. 27. Details are not described again. In addition, the components in the second terminal are configured to implement functions of the units and the modules in the embodiments shown in FIG. 37 and FIG. 38. Details are not described again.

In the embodiments of this application, reference may be made to each other for the foregoing embodiments. Same or similar steps and nouns are not described one by one again.

Alternatively, some or all of the foregoing modules may be implemented in a form of an integrated circuit that is embedded in a chip of the terminal device. In addition, the modules may be independently implemented, or may be integrated together. That is, the foregoing modules may be one or more integrated circuits, for example, one or more ASICs, one or more DSPs, or one or more FPGAs, configured to implement the foregoing methods.

FIG. 40 is a schematic structural diagram of an IDM entity according to an embodiment. As shown in FIG. 40, the IDM entity includes:

a receiving unit 3501, configured to receive, from a first terminal, a group flag field, an identifier of the first terminal, and an identifier of a second terminal, where the group flag field represents a relationship between the first terminal and the second terminal, and the group flag field, the identifier of the first terminal, and the identifier of the second terminal are used to determine a group identifier;

a generation unit 3502, configured to generate the group identifier; and

a sending unit 3503, configured to send the group identifier and the identifier of the second terminal to the first terminal.

In one embodiment, the group flag field represents that the first terminal is a master node, and the second terminal is a master node; or the group flag field represents that the first terminal is a master node, and the second terminal is a slave node.

In one embodiment, there are one or at least two second terminals.

The receiving unit 3501 may perform step 801 of the method shown in FIG. 28, the generation unit 3502 may perform step 802 of the method shown in FIG. 28, and the sending unit 3503 may perform step 803 of the method shown in FIG. 28.

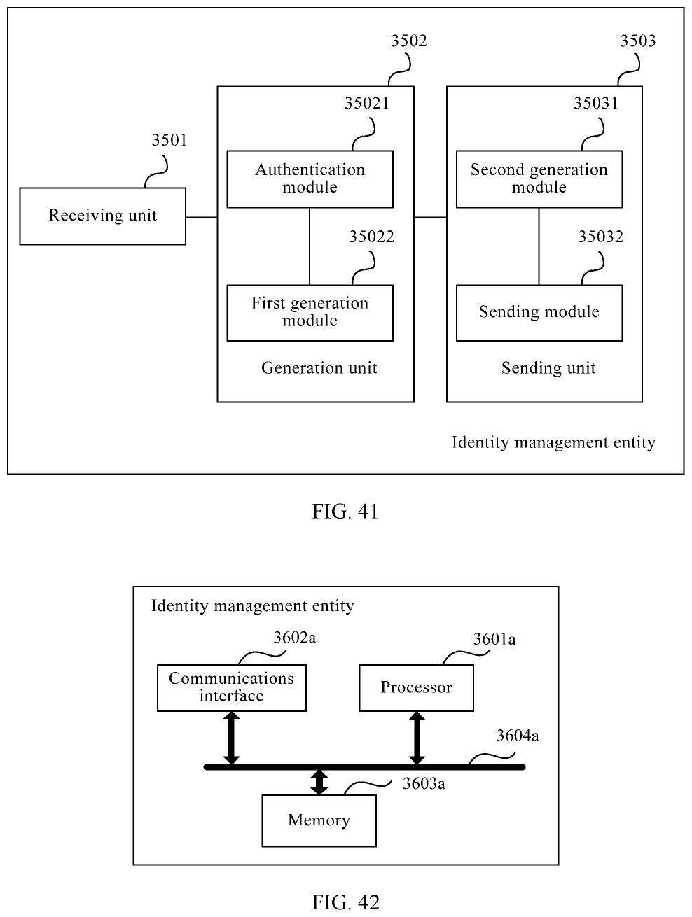

FIG. 41 is a schematic structural diagram of another IDM entity according to an embodiment. Based on the embodiment shown in FIG. 40, as shown in FIG. 41, in the IDM entity, the receiving unit 3501 is configured to:

receive a fourth message sent by the first terminal, where the fourth message includes the group flag field, the identifier of the first terminal, the identifier of the second terminal, and a third message authentication code, and the third message authentication code is used to authenticate that the fourth message is sent by the first terminal and perform authentication on integrity of the fourth message. In this case, the receiving unit 3501 may perform the method step 901 in FIG. 29.

Correspondingly, the generation unit 3502 includes:

an authentication module 35021, configured to perform authentication on the third message authentication code based on a second shared key, where the second shared key is a key negotiated between the first terminal and the IDM entity, and in this case, the authentication module 35021 may perform the method step 902 in FIG. 29;

and

a first generation module 35022, configured to: after it is determined that authentication on the third message authentication code succeeds, generate the group identifier, where in this case, the first generation unit 35022 may perform step 903 of the method shown in FIG. 29.

The first sending unit 3503 includes:

a second generation module 35031, configured to generate a fourth message authentication code based on the second shared key, where the second shared key is the key negotiated between the first terminal and the IDM entity. In this case, the second generation unit 35031 may perform step 904 of the method shown in FIG. 29; and

a sending module 35032, configured to: send a fifth message to the first terminal, where the fifth message includes the group identifier, the identifier of the second terminal, and the fourth message authentication code; and send, for the IDM entity, group information to an IKMS entity, where the group information includes the group identifier, the identifier of the first terminal, and the identifier of the second terminal, and the fourth message authentication code is used to authenticate that the fifth message is sent by the IDM entity and perform authentication on integrity of the fifth message. In this case, the sending module 35032 may perform the method step 905 in FIG. 29.

In one embodiment, the second shared key includes a third key for generating the message authentication code and a fourth key for data encryption.

In one embodiment, the receiving unit 3501 is configured to: receive an encrypted fourth message sent by the first terminal. In this case, the receiving unit 3501 may perform step 901 of the method shown in FIG. 29. Correspondingly, the generation unit further includes: a decryption module, configured to: before the authentication module performs authentication on the third message authentication code based on the second shared key, decrypt the encrypted fourth message based on the second shared key, to obtain the fourth message. In this case, the decryption module may perform step 902 in the method shown in FIG. 29.

In one embodiment, the sending module 35032 is configured to: encrypt the fifth message based on the second shared key, to generate an encrypted fifth message; and send the encrypted fifth message to the first terminal. In this case, the sending module 35032 may perform step 905 in the method shown in FIG. 29.

It can be learned that for the units and modules in this embodiment, refer to the steps in FIG. 28 and FIG. 29.

FIG. 42 is a schematic structural diagram of still another IDM entity according to an embodiment. The IDM entity may be configured to perform actions or steps of the IDM entity in the embodiments shown in FIG. 28 and FIG. 29. The IDM entity includes a processor 3601a, a communications interface 3602a, and a memory 3603a.

The components in the IDM entity are configured to implement the actions in the embodiments shown in FIG. 28 and FIG. 29. Details are not described again. In addition, the components in the IDM entity are configured to implement functions of the units and the modules in the embodiments shown in FIG. 40 and FIG. 41. Details are not described again.

In one embodiment, the IDM entity may further include a bus 3604a. The processor 3601a, the communications interface 3602a, and the memory 3603a may be connected to each other by using the bus 3604a. The bus 3604a may be a peripheral component interconnect (peripheral component interconnect, PCI) bus, an extended industry standard architecture (extended industry standard architecture, EISA) bus, or the like. The bus 3604a may be classified into an address bus, a data bus, a control bus, and the like. For ease of representation, only one thick line is used to represent the bus in FIG. 42, but this does not mean that there is only one bus or only one type of bus.

In the embodiments of this application, reference may be made to each other for the foregoing embodiments. Same or similar steps and nouns are not described one by one again.

Alternatively, some or all of the foregoing modules may be implemented in a form of an integrated circuit that is embedded in a chip of the terminal device. In addition, the modules may be independently implemented, or may be integrated together. That is, the foregoing modules may be one or more integrated circuits, for example, one or more ASICs, one or more DSPs, or one or more FPGAs, configured to implement the foregoing methods.

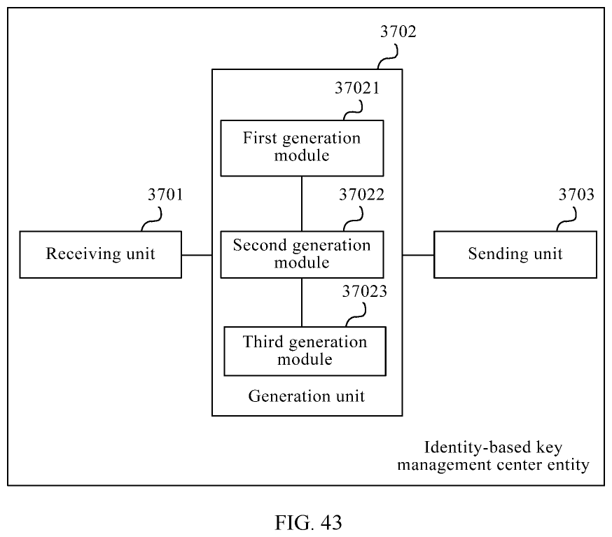

FIG. 43 is a schematic structural diagram of an IKMS entity according to an embodiment. As shown in FIG. 43, the IKMS entity includes:

a receiving unit 3701, configured to receive, from a first terminal, a first half session key parameter corresponding to a second terminal and an identifier of the second terminal, where the first half session key parameter corresponding to the second terminal and the identifier of the second terminal are used to generate an encrypted private key corresponding to the second terminal;

a generation unit 3702, configured to: generate a second half session key parameter corresponding to the second terminal, and generate the encrypted private key corresponding to the second terminal based on the identifier of the second terminal, the first half session key parameter corresponding to the second terminal, and the second half session key parameter corresponding to the second terminal, where the second half session key parameter corresponding to the second terminal is used to decrypt the encrypted private key corresponding to the second terminal; and

a sending unit 3703, configured to send the second half session key parameter corresponding to the second terminal, the identifier of the second terminal, and the encrypted private key corresponding to the second terminal to the first terminal.

In one embodiment, there are one or at least two second terminals.

In one embodiment, the generation unit 3702 includes:

a first generation module 37021, configured to generate a private key corresponding to the second terminal based on the identifier of the second terminal;

a second generation module 37022, configured to: generate the second half session key parameter corresponding to the second terminal, and generate a symmetric key corresponding to the second terminal based on the first half session key parameter corresponding to the second terminal and the second half session key parameter corresponding to the second terminal; and

a third generation module 37023, configured to encrypt the private key corresponding to the second terminal based on the symmetric key corresponding to the second terminal, to generate the encrypted private key corresponding to the second terminal.

The receiving unit 3701 may perform step 2701 of the method shown in FIG. 30, the generation unit 3702 may perform step 2702 of the method shown in FIG. 30, and the sending unit 3703 may perform step 2703 of the method shown in FIG. 30.

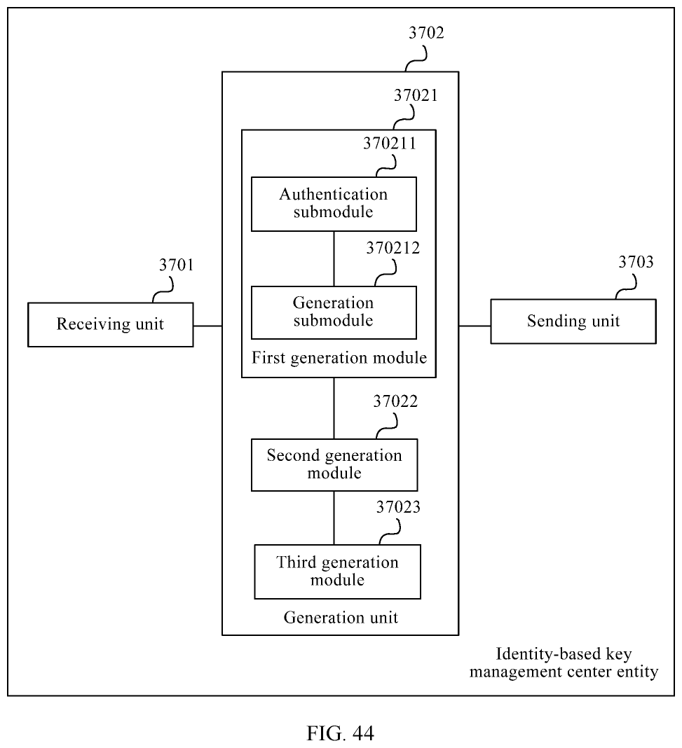

FIG. 44 is a schematic structural diagram of another IKMS entity according to an embodiment. Based on the embodiment shown in FIG. 43, as shown in FIG. 44, in the IKMS entity, the receiving unit 3701 is configured to:

receive a first message sent by the first terminal, where the first message includes the first half session key parameter corresponding to the second terminal, the identifier of the second terminal, and a first message authentication code, and the first message authentication code is used to authenticate that the first message is sent by the first terminal and perform authentication on integrity of the first message. In this case, the receiving unit 3701 may perform step 2801 of the method shown FIG. 31.

Correspondingly, the first generation module 37021 includes:

an authentication submodule 370211, configured to perform authentication on the first message authentication code based on a first shared key, where the first shared key is a key negotiated between the first terminal and the IKMS entity; and

a generation submodule 370212, configured to: after it is determined that authentication on the first message authentication code succeeds, generate the private key corresponding to the second terminal based on the identifier of the second terminal. In this case, the first generation unit 37021 may perform step 2802 and step 2803 of the method shown in FIG. 31.

In one embodiment, the first shared key includes a first key for generating the message authentication code and a second key for data encryption.

In one embodiment, the receiving unit 3701 is configured to: receive an encrypted first message sent by the first terminal. In this case, the receiving unit 3701 may perform step 2801 of the method shown in FIG. 31. Correspondingly, the first generation module 37021 further includes: a decryption submodule 370212, configured to: before the authentication submodule 370211 performs authentication on the first message authentication code based on the first shared key, decrypt the encrypted first message based on the first shared key, to obtain the first message. In this case, the first generation unit 37021 may perform step 2802 of the method shown in FIG. 31.

In one embodiment, the sending unit 3703 includes:

a fourth generation module, configured to generate a second message authentication code based on the first shared key, where the first shared key is the key negotiated between the first terminal and the IKMS entity; and a first sending module, configured to send a second message to the first terminal, where the second message includes the second half session key parameter corresponding to the second terminal, the identifier of the second terminal, the encrypted private key corresponding to the second terminal, and the second message authentication code, and the second message authentication code is used to authenticate that the second message is sent by the IKMS entity and perform authentication on integrity of the second message.

The first sending module includes: a first encryption submodule, configured to encrypt the second message based on the first shared key, to generate an encrypted second message; and a first sending submodule, configured to send the encrypted second message to the first terminal.

Alternatively, in one embodiment, the sending unit 3703 includes:

a fifth generation module, configured to generate signature information corresponding to the second terminal based on a private key of the IKMS entity, where the signature information corresponding to the second terminal is used to authenticate that the encrypted private key corresponding to the second terminal is generated by the IKMS entity; and a second sending module, configured to send a third message to the first terminal, where the third message includes the second half session key parameter corresponding to the second terminal, the identifier of the second terminal, the encrypted private key corresponding to the second terminal, and the signature information corresponding to the second terminal.

The second sending module includes: a second encryption submodule, configured to encrypt the third message based on the first shared key, to generate an encrypted third message, where the first shared key is the key negotiated between the first terminal and the IKMS entity; and a second sending submodule, configured to send the encrypted third message to the first terminal.

The sending unit 3703 may perform step 2806 of the method shown in FIG. 31.

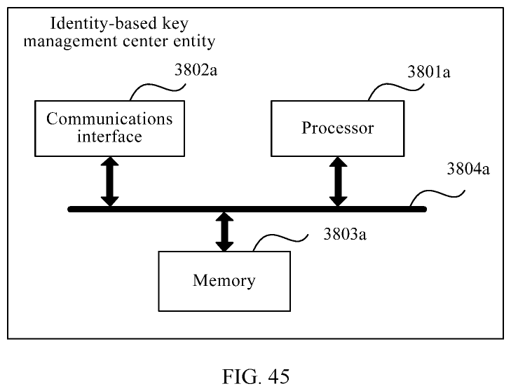

FIG. 45 is a schematic structural diagram of still another IKMS entity according to an embodiment. The IKMS entity may be configured to perform actions or steps of the IKMS entity in the embodiments shown in FIG. 30 and FIG. 31. The IKMS entity includes a processor 3801a, a communications interface 3802a, and a memory 3803a.

The components in the IKMS entity are configured to implement the actions in the embodiments shown in FIG. 30 and FIG. 31. Details are not described again. In addition, the components in the IKMS entity are configured to implement functions of the units and the modules in the embodiments shown in FIG. 43 and FIG. 44. Details are not described again.

In one embodiment, the IKMS entity may further include a bus 3804a. The processor 3801a, the communications interface 3802a, and the memory 3803a may be connected to each other by using the bus 3804a. The bus 3804a may be a PCI bus, an EISA bus, or the like. The bus 3804a may be classified into an address bus, a data bus, a control bus, and the like. For ease of representation, only one thick line is used to represent the bus in FIG. 45, but this does not mean that there is only one bus or only one type of bus.

In the embodiments of this application, reference may be made to each other for the foregoing embodiments. Same or similar steps and nouns are not described one by one again.

Alternatively, some or all of the foregoing modules may be implemented in a form of an integrated circuit that is embedded in a chip of the device. In addition, the modules may be independently implemented, or may be integrated together. That is, the foregoing modules may be one or more integrated circuits, for example, one or more ASICs, one or more DSPs, or one or more FPGAs, configured to implement the foregoing methods.

All or some of the foregoing embodiments may be implemented by using software, hardware, firmware, or any combination thereof in the foregoing embodiments. When software is used to implement the embodiments, all or some of the embodiments may be implemented in a form of a computer program product. The computer program product includes one or more computer instructions. When the computer program instructions are loaded and executed on a computer, all or some of the procedure or functions according to the embodiments of this application are generated. The computer may be a general-purpose computer, a dedicated computer, a computer network, or another programmable apparatus. The computer instruction may be stored in a computer-readable storage medium or may be transmitted from a computer-readable storage medium to another computer-readable storage medium. For example, the computer instruction may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state disk (SSD)), or the like.

A person skilled in the art should be aware that in the foregoing one or more examples, functions described in the embodiments of this application may be implemented by hardware, software, firmware, or any combination thereof. When the functions are implemented by software, the foregoing functions may be stored in a computer-readable medium or transmitted as one or more instructions or code in the computer-readable medium. The computer-readable medium includes a computer storage medium and a communications medium, where the communications medium includes any medium that facilitates transmission of a computer program from one place to another. The storage medium may be any available medium accessible to a general-purpose or special-purpose computer.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A method for private key generation, the method comprising:
receiving, by a first terminal from a second terminal, a first half session key parameter corresponding to the second terminal and an identifier of the second terminal, wherein the first half session key parameter corresponding to the second terminal and the identifier of the second terminal are used to generate an encrypted private key corresponding to the second terminal;
sending, by the first terminal, the first half session key parameter corresponding to the second terminal and the identifier of the second terminal to an identity-based key management system (IKMS) entity;
receiving, by the first terminal from the IKMS entity, a second half session key parameter corresponding to the second terminal, the identifier of the second terminal, and the encrypted private key corresponding to the second terminal, wherein the second half session key parameter corresponding to the second terminal is used to decrypt the encrypted private key corresponding to the second terminal; and
sending, by the first terminal, the second half session key parameter corresponding to the second terminal and the encrypted private key corresponding to the second terminal to the second terminal based on the identifier of the second terminal.

2. The method according to claim 1,
further comprising: before sending, by the first terminal, the first half session key parameter corresponding to the second terminal and the identifier of the second terminal to an IKMS entity,
generating, by the first terminal, a first message authentication code based on a first shared key, wherein the first shared key is a key negotiated between the first terminal and the IKMS entity; and
wherein sending, by the first terminal, the first half session key parameter corresponding to the second terminal and the identifier of the second terminal to the IKMS entity comprises:
sending, by the first terminal, a first message to the IKMS entity, wherein the first message comprises the first half session key parameter corresponding to the second terminal, the identifier of the second terminal, and the first message authentication code, and the first message authentication code is used to authenticate that the first message is sent by the first terminal and perform authentication on integrity of the first message.

3. The method according to claim 2, wherein the first shared key comprises a first key for generating the message authentication code and a second key for data encryption.

4. The method according to claim 2, wherein
receiving, by the first terminal from the IKMS entity, the second half session key parameter corresponding to the second terminal, the identifier of the second terminal, and the encrypted private key corresponding to the second terminal comprises:
receiving, by the first terminal, a second message sent by the IKMS entity, wherein the second message comprises the second half session key parameter corresponding to the second terminal, the identifier of the second terminal, the encrypted private key corresponding to the second terminal, and a second message authentication code that is used to authenticate that the second message is sent by the IKMS entity and perform authentication on integrity of the second message; and
sending, by the first terminal, the second half session key parameter corresponding to the second terminal and the encrypted private key corresponding to the second terminal to the second terminal based on the identifier of the second terminal comprises:
performing, by the first terminal, authentication on the second message authentication code based on the first shared key, wherein the first shared key is the key negotiated between the first terminal and the IKMS entity, and
after determining that the authentication on the second message authentication code succeeds, sending, by the first terminal, the second half session key parameter corresponding to the second terminal and the encrypted private key corresponding to the second terminal to the second terminal based on the identifier of the second terminal.

5. The method according to claim 1, wherein
receiving, by the first terminal from the IKMS entity, the second half session key parameter corresponding to the second terminal, the identifier of the second terminal, and the encrypted private key corresponding to the second terminal comprises:
receiving, by the first terminal, a third message sent by the IKMS entity, wherein the third message comprises the second half session key parameter corresponding to the second terminal, the identifier of the second terminal, the encrypted private key corresponding to the second terminal, and signature information corresponding to the second terminal that is used to authenticate that the encrypted private key corresponding to the second terminal is generated by the IKMS entity; and
sending, by the first terminal, the second half session key parameter corresponding to the second terminal and the encrypted private key corresponding to the second terminal to the second terminal based on the identifier of the second terminal comprises:
performing, by the first terminal, authentication on the signature information corresponding to the second terminal based on a public key of the IKMS entity, and
after determining that authentication on the signature information corresponding to the second terminal succeeds, sending, by the first terminal, the second half session key parameter corresponding to the second terminal, the encrypted private key corresponding to the second terminal, and the signature information corresponding to the second terminal to the second terminal based on the identifier of the second terminal.

6. A private key generation method, comprising:
receiving, by an identity-based key management system (IKMS) entity from a first terminal, a first half session key parameter corresponding to a second terminal and an identifier of the second terminal, wherein the first half session key parameter corresponding to the second terminal and the identifier of the second terminal are used to generate an encrypted private key corresponding to the second terminal;
generating, by the IKMS entity, a second half session key parameter corresponding to the second terminal, and generating the encrypted private key corresponding to the second terminal based on the identifier of the second terminal, the first half session key parameter corresponding to the second terminal, and the second half session key parameter corresponding to the second terminal, wherein the second half session key parameter corresponding to the second terminal is used to decrypt the encrypted private key corresponding to the second terminal; and
sending, by the IKMS entity, the second half session key parameter corresponding to the second terminal, the identifier of the second terminal, and the encrypted private key corresponding to the second terminal to the first terminal.

7. The method according to claim 6, wherein
generating, by the IKMS entity, the second half session key parameter corresponding to the second terminal, and generating the encrypted private key corresponding to the second terminal based on the identifier of the second terminal, the first half session key parameter corresponding to the second terminal, and the second half session key parameter corresponding to the second terminal comprises:
generating, by the IKMS entity, a private key corresponding to the second terminal based on the identifier of the second terminal;
generating, by the IKMS entity, the second half session key parameter corresponding to the second terminal, and generating a symmetric key corresponding to the second terminal based on the first half session key parameter corresponding to the second terminal and the second half session key parameter corresponding to the second terminal; and
encrypting, by the IKMS entity, the private key corresponding to the second terminal based on the symmetric key corresponding to the second terminal, to generate the encrypted private key corresponding to the second terminal.

8. The method according to claim 7, wherein
receiving, by the IKMS entity from the first terminal, the first half session key parameter corresponding to the second terminal and the identifier of the second terminal comprises:
receiving, by the IKMS entity, a first message sent by the first terminal, wherein the first message comprises the first half session key parameter corresponding to the second terminal, the identifier of the second terminal, and a first message authentication code, and the first message authentication code is used to authenticate that the first message is sent by the first terminal and perform authentication on integrity of the first message; and
generating, by the IKMS entity, the private key corresponding to the second terminal based on the identifier of the second terminal comprises:
performing, by the IKMS entity, authentication on the first message authentication code based on a first shared key, wherein the first shared key is a key negotiated between the first terminal and the IKMS entity; and
after determining that authentication on the first message authentication code succeeds, generating, by the IKMS entity, the private key corresponding to the second terminal based on the identifier of the second terminal.

9. The method according to claim 8, wherein the first shared key comprises a third key for generating the message authentication code and a fourth key for data encryption.

10. The method according to claim 8, wherein
sending, by the IKMS entity, the second half session key parameter corresponding to the second terminal, the identifier of the second terminal, and the encrypted private key corresponding to the second terminal to the first terminal comprises:
generating, by the IKMS entity, a second message authentication code based on the first shared key, wherein the first shared key is the key negotiated between the first terminal and the IKMS entity; and
sending, by the IKMS entity, a second message to the first terminal, wherein the second message comprises the second half session key parameter corresponding to the second terminal, the identifier of the second terminal, the encrypted private key corresponding to the second terminal, and the second message authentication code, and the second message authentication code is used to authenticate that the second message is sent by the IKMS entity and perform authentication on integrity of the second message.

11. The method according to claim 6, wherein
sending, by the IKMS entity, the second half session key parameter corresponding to the second terminal, the identifier of the second terminal, and the encrypted private key corresponding to the second terminal to the first terminal comprises:
generating, by the IKMS entity, signature information corresponding to the second terminal based on a private key of the IKMS entity, wherein the signature information corresponding to the second terminal is used to authenticate that the encrypted private key corresponding to the second terminal is generated by the IKMS entity; and
sending, by the IKMS entity, a third message to the first terminal, wherein the third message comprises the second half session key parameter corresponding to the second terminal, the identifier of the second terminal, the encrypted private key corresponding to the second terminal, and the signature information corresponding to the second terminal.

12. A terminal device, comprising:
a processor;
a transmitter coupled to the processor; and
a memory coupled to the processor to store computer executable program codes, which when executed by the processor, cause the processor to perform operations, the operations including:
receiving a first half session key parameter corresponding to the second terminal and an identifier of the second terminal, wherein the first half session key parameter corresponding to the second terminal and the identifier of the second terminal are used to generate an encrypted private key corresponding to the second terminal;
sending the first half session key parameter corresponding to the second terminal and the identifier of the second terminal to an identity-based key management system (IKMS) entity;
receiving a second half session key parameter corresponding to the second terminal, the identifier of the second terminal, and the encrypted private key corresponding to the second terminal, wherein the second half session key parameter corresponding to the second terminal is used to decrypt the encrypted private key corresponding to the second terminal; and
sending the second half session key parameter corresponding to the second terminal and the encrypted private key corresponding to the second terminal to the second terminal based on the identifier of the second terminal.

13. The terminal device according to claim 12, wherein the operations further include:
generating a first message authentication code based on a first shared key, wherein the first shared key is a key negotiated between the terminal device and the IKMS entity; and
wherein sending the first half session key parameter corresponding to the second terminal and the identifier of the second terminal to the IKMS entity comprises:
sending a first message to the IKMS entity, wherein the first message comprises the first half session key parameter corresponding to the second terminal, the identifier of the second terminal, and the first message authentication code, and the first message authentication code is used to authenticate that the first message is sent by the terminal device and perform authentication on integrity of the first message.

14. The terminal device according to claim 13, wherein the first shared key comprises a first key for generating the message authentication code and a second key for data encryption.

15. The terminal device according to claim 13, wherein receiving the second half session key parameter corresponding to the second terminal, the identifier of the second terminal, and the encrypted private key corresponding to the second terminal comprises:
receiving a second message sent by the IKMS entity, wherein the second message comprises the second half session key parameter corresponding to the second terminal, the identifier of the second terminal, the encrypted private key corresponding to the second terminal, and a second message authentication code that is used to authenticate that the second message is sent by the IKMS entity and perform authentication on integrity of the second message; and
sending the second half session key parameter corresponding to the second terminal and the encrypted private key corresponding to the second terminal to the second terminal based on the identifier of the second terminal comprises:
performing authentication on the second message authentication code based on the first shared key, wherein the first shared key is the key negotiated between the terminal device and the IKMS entity, and
after determining that the authentication on the second message authentication code succeeds, sending the second half session key parameter corresponding to the second terminal and the encrypted private key corresponding to the second terminal to the second terminal based on the identifier of the second terminal.

16. The terminal device according to claim 12, wherein receiving the second half session key parameter corresponding to the second terminal, the identifier of the second terminal, and the encrypted private key corresponding to the second terminal comprises:
receiving a third message sent by the IKMS entity, wherein the third message comprises the second half session key parameter corresponding to the second terminal, the identifier of the second terminal, the encrypted private key corresponding to the second terminal, and signature information corresponding to the second terminal, and the signature information corresponding to the second terminal is used to authenticate that the encrypted private key corresponding to the second terminal is generated by the IKMS entity; and
sending the second half session key parameter corresponding to the second terminal and the encrypted private key corresponding to the second terminal to the second terminal based on the identifier of the second terminal comprises:
performing authentication on the signature information corresponding to the second terminal based on a public key of the IKMS entity, and
after it is determined that authentication on the signature information corresponding to the second terminal succeeds, sending the second half session key parameter corresponding to the second terminal, the encrypted private key corresponding to the second terminal, and the signature information corresponding to the second terminal to the second terminal based on the identifier of the second terminal.

17. An identity-based key management system (IKMS) entity, comprising:
a processor;
a communications interface coupled to the processor; and
a memory coupled to the processor to store computer executable program codes, which when executed by the processor, cause the processor to perform operations, the operations including:
receiving from a first terminal, a first half session key parameter corresponding to a second terminal and an identifier of the second terminal, wherein the first half session key parameter corresponding to the second terminal and the identifier of the second terminal are used to generate an encrypted private key corresponding to the second terminal;
generating a second half session key parameter corresponding to the second terminal, and generating the encrypted private key corresponding to the second terminal based on the identifier of the second terminal, the first half session key parameter corresponding to the second terminal, and the second half session key parameter corresponding to the second terminal, wherein the second half session key parameter corresponding to the second terminal is used to decrypt the encrypted private key corresponding to the second terminal; and
sending the second half session key parameter corresponding to the second terminal, the identifier of the second terminal, and the encrypted private key corresponding to the second terminal to the first terminal.

18. The IKMS entity according to claim 17, wherein generating the second half session key parameter corresponding to the second terminal, and generating the encrypted private key corresponding to the second terminal based on the identifier of the second terminal, the first half session key parameter corresponding to the second terminal, and the second half session key parameter corresponding to the second terminal comprises:
generating a private key corresponding to the second terminal based on the identifier of the second terminal;
generating the second half session key parameter corresponding to the second terminal, and generating a symmetric key corresponding to the second terminal based on the first half session key parameter corresponding to the second terminal and the second half session key parameter corresponding to the second terminal; and
encrypting the private key corresponding to the second terminal based on the symmetric key corresponding to the second terminal, to generate the encrypted private key corresponding to the second terminal.

19. The IKMS entity according to claim 18, wherein receiving from the first terminal, the first half session key parameter corresponding to the second terminal and the identifier of the second terminal comprises:
receiving a first message sent by the first terminal, wherein the first message comprises the first half session key parameter corresponding to the second terminal, the identifier of the second terminal, and a first message authentication code that is used to authenticate that the first message is sent by the first terminal and perform authentication on integrity of the first message; and
generating the private key corresponding to the second terminal based on the identifier of the second terminal comprises:
performing authentication on the first message authentication code based on a first shared key, wherein the first shared key is a key negotiated between the first terminal and the IKMS entity, and
after determining that the authentication on the first message authentication code succeeds, generating the private key corresponding to the second terminal based on the identifier of the second terminal.

20. The IKMS entity according to claim 19, wherein the first shared key comprises a third key for generating the message authentication code and a fourth key for data encryption.

21. The IKMS entity according to claim 19, wherein sending the second half session key parameter corresponding to the second terminal, the identifier of the second terminal, and the encrypted private key corresponding to the second terminal to the first terminal comprises:
generating a second message authentication code based on the first shared key, wherein the first shared key is the key negotiated between the first terminal and the IKMS entity, and
sending a second message to the first terminal, wherein the second message comprises the second half session key parameter corresponding to the second terminal, the identifier of the second terminal, the encrypted private key corresponding to the second terminal, and the second message authentication code, and the second message authentication code is used to authenticate that the second message is sent by the IKMS entity and perform authentication on integrity of the second message.

22. The IKMS entity according to claim 17, wherein the sending the second half session key parameter corresponding to the second terminal, the identifier of the second terminal, and the encrypted private key corresponding to the second terminal to the first terminal comprises:
generating signature information corresponding to the second terminal based on a private key of the IKMS entity, wherein the signature information corresponding to the second terminal is used to authenticate that the encrypted private key corresponding to the second terminal is generated by the IKMS entity, and
sending a third message to the first terminal, wherein the third message comprises the second half session key parameter corresponding to the second terminal, the identifier of the second terminal, the encrypted private key corresponding to the second terminal, and the signature information corresponding to the second terminal.
